(19) United States
(12) Patent Application Publication
(10) Pub. No.: US 2018/0051778 A1
(43) Pub. Date: Feb. 22, 2018

(54) SPEED CHANGE DEVICE

(71) Applicant: AISIN AW CO., LTD., Anjo-shi, Aichi-ken (JP)

(72) Inventors: Takayoshi KATO, Handa (JP); Toshihiko AOKI, Anjo (JP)

(73) Assignee: AISIN AW CO., LTD., Anjo-shi, Aichi-ken (JP)

(21) Appl. No.: 15/556,506

(22) PCT Filed: Apr. 28, 2016
(86) PCT No.: PCT/JP2016/063372

§ 371 Date: Sep. 7, 2017

(30) Foreign Application Priority Data
Apr. 30, 2015 (JP) 2015-092939

(51) Int. Cl. F16H 3/66; F16H 61/70

(52) U.S. Cl. CPC F16H 3/663; F16H 61/70; F16H 2200/0069; F16H 2200/2046; F16H 2200/2023

(57) ABSTRACT

An automatic transmission includes: a first gear train that includes a first drive gear always coupled to a first ring gear of a Ravigneaux type planetary gear mechanism and a first driven gear which is always coupled to an output gear and to which power is transferred from the first drive gear; a second gear train that includes a second drive gear always coupled to a first carrier of the Ravigneaux type planetary gear mechanism and a second driven gear which is rotated in the same direction as the first driven gear by power from the second drive gear, the second gear train having a gear ratio that is different from that of the first gear train; and a clutch that connects and disconnects the second driven gear and the output gear to and from each other.

### TECHNICAL FIELD

The present disclosure relates to a speed change device that transfers power, which has been transferred to an input member, to an output member with the speed of the power changed.

### BACKGROUND ART

There has hitherto been known a speed change device to be mounted on a vehicle, the speed change device including a double-pinion type first planetary gear mechanism, a Ravigneaux type second planetary gear mechanism, and four clutches C1, C2, C3, and C4, two brakes B1 and B2, and a one-way clutch F 1 that change a power transfer path from the input side to the output side (see Patent Document 1, for example). With the speed change device, first to eighth forward speeds and first and second reverse speeds can be established by selectively engaging two of the clutches C1 to C4 and the brakes B1 and B2. In addition, there has hitherto been known a device that includes a single-pinion type first planetary gear mechanism, a Ravigneaux type second planetary gear mechanism, and three clutches C1, C2, and C3, two brakes B1 and B2, and a one-way clutch F 1 that change a power transfer path from the input side to the output side (see Patent Document 2, for example). With the speed change device, first to sixth forward speeds and a reverse speed can be established by selectively engaging two of the clutches C1 to C3 and the brakes B1 and B2. Furthermore, there has hitherto been known a speed change device that is lightweight and compact, the speed change device including a Ravigneaux type planetary gear mechanism, and three clutches C1, C2, and C3, two brakes B1 and B3, and a one-way clutch F 1 that change a power transfer path from the input side to the output side (see Patent Document 3, for example). With the speed change device, first to fourth forward speeds and a reverse speed can be established by selectively engaging two of the clutches C1 to C3 and the brakes B1 and B3.

### RELATED-ART DOCUMENTS

### Patent Documents

[Patent Document 1] Japanese Patent Application Publication No. 2013-204754 (JP 2013-204754 A)

[Patent Document 2] Japanese Patent Application Publication No. 2010-038168 (JP 2010-038168 A)

[Patent Document 3] Japanese Patent Application Publication No. 2010-216568 (JP 2010-216568 A)

### SUMMARY

Although the speed change device described in Patent Document 1 mentioned above can provide first to eighth forward speeds, it is desirable to provide a larger number of shift speeds in order to further improve the fuel efficiency and the drivability of a vehicle. Similarly, in the speed change devices described in Patent Documents 2 and 3, it is possible to improve the fuel efficiency and the drivability of a vehicle by increasing the number of shift speeds.

In view of the foregoing, it is a main object according to the present disclosure to provide a speed change device that is capable of improving the fuel efficiency and the drivability of a vehicle.

The present disclosure provides a speed change device that includes an input member, an output member, a composite planetary gear mechanism that has at least four rotary elements including an output element, and at least five engagement elements that each connect and disconnect one of the rotary elements of the composite planetary gear mechanism and a different one of rotary elements including the input member or a stationary member to and from each other, the speed change device transferring power, which has been transferred to the input member, to the output member with a speed of the power changed. The speed change device includes: a first gear train that includes a first drive gear always coupled to the output element of the composite planetary gear mechanism and a first driven gear which is always coupled to the output member and to which power is transferred from the first drive gear; a second gear train that includes a second drive gear always coupled to one of the rotary elements, not the output element, of the composite planetary gear mechanism and a second driven gear that is rotated in the same direction as the first driven gear by power from the second drive gear, the second gear train having a gear ratio that is different from that of the first gear train; and an output-side engagement element that connects and disconnects the second driven gear and the output member to and from each other.

In such a speed change device, when the output member is rotated with the output-side engagement element engaged, one of the rotary elements that is coupled via the second drive gear to the second driven gear which is rotated together with the output member is rotated with respect to the output member at a rotational speed that matches the gear ratio of the second gear train. When the output member is rotated with the output-side engagement element engaged, in addition, the output element of the composite planetary gear mechanism is rotated with respect to the output member at a rotational speed that matches the gear ratio of the first gear train. Thus, a rotational speed difference that matches the gear ratios of the first and second gear trains can be caused between the output element of the composite planetary gear mechanism and one of the rotary elements by engaging one of the at least five engagement elements and the output-side engagement element. Consequently, with the speed change device according to the present disclosure, it is possible to establish shift speeds other than those obtained by selectively engaging at least two of the at least five engagement elements. For example, in the case where power from the input member side is selectively transferred to a rotary element, not the output element, of the composite planetary gear mechanism, at least three shift speeds can be added to the speed change device to which the first and second gear trains and the output-side engagement element have not been added. As a result, with the speed change device according to the present disclosure, it is possible to further improve the fuel efficiency and the drivability of a vehicle by increasing the number of shift speeds.

### BRIEF DESCRIPTION OF THE DRAWINGS

FIG. 1 is a diagram illustrating a schematic configuration of a power transfer device that includes a speed change device according to a first embodiment of the present disclosure.

FIG. 2 is a velocity diagram illustrating the ratio of the rotational speed of each rotary element to an input rotational speed of the speed change device of FIG. 1.

FIG. 3 is an operation table illustrating the relationship between each shift speed of the speed change device of FIG. 1 and the respective operating states of clutches and brakes.

FIG. 4 is another operation table illustrating the relationship between each shift speed of the speed change device according to the first embodiment and the respective operating states of clutches and brakes.

FIG. 5 is still another operation table illustrating the relationship between each shift speed of the speed change device according to the first embodiment and the respective operating states of clutches and brakes.

FIG. 6 is another operation table illustrating the relationship between each shift speed of the speed change device according to the first embodiment and the respective operating states of clutches and brakes.

FIG. 7 is a diagram illustrating a schematic configuration of a power transfer device that includes a speed change device according to a modified aspect of the first embodiment.

FIG. 8 is a diagram illustrating a schematic configuration of a power transfer device that includes a speed change device according to another modified aspect of the first embodiment.

FIG. 9 is a diagram illustrating a schematic configuration of a power transfer device that includes a speed change device according to still another modified aspect of the first embodiment.

FIG. 10 is a velocity diagram illustrating the ratio of the rotational speed of each rotary element to an input rotational speed of the speed change device of FIG. 9.

FIG. 11 is a diagram illustrating a schematic configuration of a power transfer device that includes a speed change device according to another modified aspect of the first embodiment.

FIG. 12 is a diagram illustrating a schematic configuration of a power transfer device that includes a speed change device according to still another modified aspect of the first embodiment.

FIG. 13 is a diagram illustrating a schematic configuration of a power transfer device that includes a speed change device according to a second embodiment of the present disclosure.

FIG. 14 is a velocity diagram illustrating the ratio of the rotational speed of each rotary element to an input rotational speed of the speed change device of FIG. 13.

FIG. 15 is an operation table illustrating the relationship between each shift speed of the speed change device of FIG. 13 and the respective operating states of clutches and brakes.

FIG. 16 is a diagram illustrating a schematic configuration of a power transfer device that includes a speed change device according to a modified aspect of the second embodiment.

FIG. 17 is a diagram illustrating a schematic configuration of a power transfer device that includes a speed change device according to another modified aspect of the second embodiment.

FIG. 18 is a diagram illustrating a schematic configuration of a power transfer device that includes a speed change device according to still another modified aspect of the second embodiment.

FIG. 19 is a velocity diagram illustrating the ratio of the rotational speed of each rotary element to an input rotational speed of the speed change device of

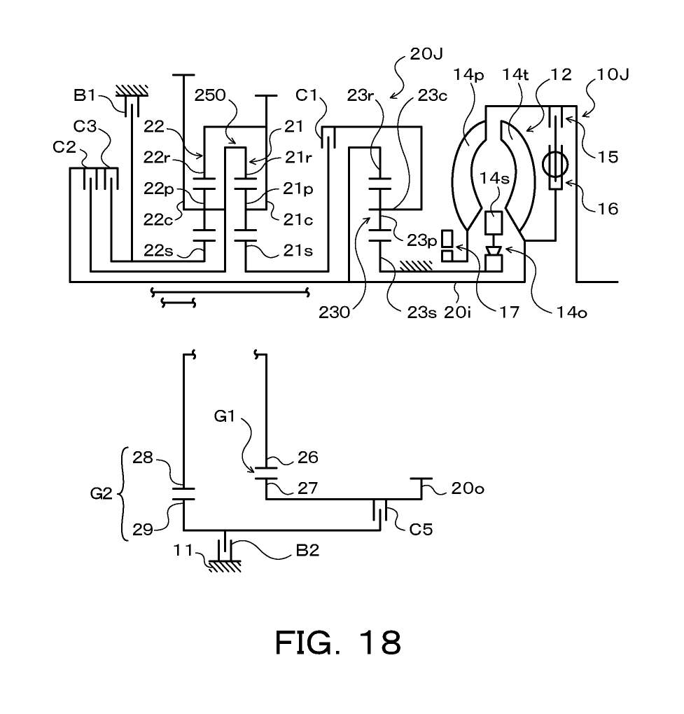

FIG. 18.

FIG. 20 is an operation table illustrating the relationship between each shift speed of the speed change device of FIG. 18 and the respective operating states of clutches and brakes.

FIG. 21 is a diagram illustrating a schematic configuration of a power transfer device that includes a speed change device according to another modified aspect of the second embodiment.

FIG. 22 is a diagram illustrating a schematic configuration of a power transfer device that includes a speed change device according to still another modified aspect of the second embodiment.

FIG. 23 is a diagram illustrating a schematic configuration of a power transfer device that includes a speed change device according to another modified aspect of the second embodiment.

FIG. 24 is a velocity diagram illustrating the ratio of the rotational speed of each rotary element to an input rotational speed of the speed change device of

FIG. 23.

FIG. 25 is an operation table illustrating the relationship between each shift speed of the speed change device of FIG. 23 and the respective operating states of clutches and brakes.

FIG. 26 is a diagram illustrating a schematic configuration of a power transfer device that includes a speed change device according to still another modified aspect of the second embodiment.

FIG. 27 is a diagram illustrating a schematic configuration of a power transfer device that includes a speed change device according to another modified aspect of the second embodiment.

FIG. 28 is a velocity diagram illustrating the ratio of the rotational speed of each rotary element to an input rotational speed of the speed change device of FIG. 27.

FIG. 29 is a diagram illustrating a schematic configuration of a power transfer device that includes a speed change device according to still another modified aspect of the second embodiment.

FIG. 30 is a diagram illustrating a schematic configuration of a power transfer device that includes a speed change device according to another modified aspect of the second embodiment.

FIG. 31 is a diagram illustrating a schematic configuration of a power transfer device that includes a speed change device according to a third embodiment of the present disclosure.

FIG. 32 is a velocity diagram illustrating the ratio of the rotational speed of each rotary element to an input rotational speed of the speed change device of

FIG. 31.

FIG. 33 is an operation table illustrating the relationship between each shift speed of the speed change device of FIG. 31 and the respective operating states of clutches and brakes.

FIG. 34 is a diagram illustrating a schematic configuration of a power transfer device that includes a speed change device according to a modified aspect of the third embodiment.

FIG. 35 is a diagram illustrating a schematic configuration of a power transfer device that includes a speed change device according to another modified aspect of the third embodiment.

FIG. 36 is a diagram illustrating a schematic configuration of a power transfer device that includes a speed change device according to still another modified aspect of the third embodiment.

FIG. 37 is a diagram illustrating a schematic configuration of a power transfer device that includes a speed change device according to another modified aspect of the third embodiment.

FIG. 38 is a diagram illustrating a schematic configuration of a power transfer device that includes a speed change device according to a modified aspect of the first embodiment.

### DETAILED DESCRIPTION OF THE PREFERRED EMBODIMENTS

Now, an embodiment according to the present disclosure will be described with reference to the drawings.

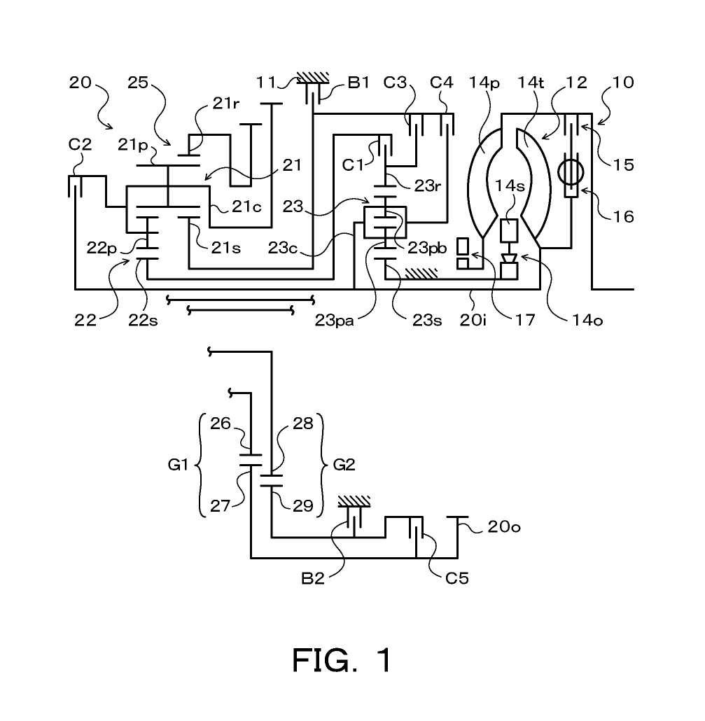

FIG. 1 is a diagram illustrating a schematic configuration of a power transfer device 10 that includes an automatic transmission 20 which is a speed change device according to a first embodiment of the present disclosure. The power transfer device 10 illustrated in the drawing is connected to a crankshaft of an engine (internal combustion engine; not illustrated) and/or a rotor of an electric motor that serve as a drive source transversely mounted in the front portion of a front-wheel drive vehicle, and can transfer power (torque) from the engine or the like to left and right front wheels (drive wheels; not illustrated). As illustrated in the drawing, the power transfer device 10 includes a transmission case (stationary member) 11, a starting device (fluid transmission apparatus) 12, an oil pump 17, and so forth in addition to the automatic transmission 20 which transfers power, which has been transferred from the engine or the like to an input shaft (input member) 20i, to the front wheels of the vehicle with the speed of the power changed.

The starting device 12 includes a torque converter that has: a pump impeller 14p coupled to the drive source discussed above; a turbine runner 14t coupled to the input shaft 20i of the automatic transmission 20; a stator 14s disposed on the inner side of the pump impeller 14p and the turbine runner 14t to adjust a flow of working oil from the turbine runner 14t to the pump impeller 14p; a one-way clutch 14o that is supported by a stator shaft (not illustrated) and that restricts the rotational direction of the stator 14s to one direction; and so forth. The starting device 12 further includes: a lock-up clutch 15 that connects and disconnects a front cover coupled to the crankshaft of the engine or the like and the input shaft 20i of the automatic transmission 20 to and from each other; and a damper mechanism 16 that damps vibration between the front cover and the input shaft 20i of the automatic transmission 20. The starting device 12 may include a fluid coupling that does not have the stator 14s.

The oil pump 17 is constituted as a gear pump that has: a pump assembly that includes a pump body and a pump cover; an externally toothed gear (inner rotor) coupled to the pump impeller 14p of the starting device 12; an internally toothed gear (outer rotor) meshed with the externally toothed gear; and so forth. The oil pump 17 is driven by power from the engine or the like to suction working oil (ATF) reserved in an oil pan (not illustrated) and pump the working oil to a hydraulic control device (not illustrated). The externally toothed gear of the oil pump 17 may be coupled to the pump impeller 14p via a chain or a gear train.

The automatic transmission 20 is constituted as an 11-speed transmission. As illustrated in FIG. 1, the automatic transmission 20 includes, in addition to the input shaft 20i: an output gear (output member) 20o disposed on a separate shaft (second shaft) that extends in parallel with the input shaft (first shaft) 20i; a Ravigneaux type planetary gear mechanism 25 that serves as a composite planetary gear mechanism constituted by combining a single-pinion type first planetary gear 21 and a double-pinion type second planetary gear 22 with each other; and a double-pinion type third planetary gear 23. In the embodiment, the output gear 20o is an externally toothed gear, and is coupled to the left and right front wheels via a drive pinion gear meshed with the output gear 20o, a differential gear that includes a differential ring gear meshed with the drive pinion gear, and a drive shaft (none of which is illustrated). In the embodiment, in addition, the first and second planetary gears 21 and 22, which constitute the Ravigneaux type planetary gear mechanism 25, and the third planetary gear 23 are disposed in the transmission case 11 so as to be arranged in the order of the third planetary gear 23, the first planetary gear 21, and the second planetary gear 22 from the starting device 12 side, that is, the engine side (the right side in FIG. 1).

The Ravigneaux type planetary gear mechanism 25 has: a first sun gear 21s and a second sun gear 22s which are each an externally toothed gear; a first ring gear 21r which is an internally toothed gear disposed concentrically with the first sun gear 21s; a plurality of first pinion gears (long pinion gears) 21p meshed with the first sun gear 21s and the first ring gear 21r; a plurality of second pinion gears (short pinion gears) 22p meshed with the second sun gear 22s and the plurality of first pinion gears 21p; and a first carrier 21c that rotatably and revolvably holds the plurality of first pinion gears 21p and the plurality of second pinion gears 22p.

The first sun gear 21s, the first carrier 21c, the first pinion gears 21p, and the first ring gear 21r of the Ravigneaux type planetary gear mechanism 25 constitute the single-pinion type first planetary gear 21. Meanwhile, the second sun gear 22s, the first carrier 21c, the first and second pinion gears 21p and 22p, and the first ring gear 21r of the Ravigneaux type planetary gear mechanism 25 constitute the double-pinion type second planetary gear 22. In the embodiment, the Ravigneaux type planetary gear mechanism 25 is configured such that a gear ratio λ1 of the single-pinion type first planetary gear 21 (the number of teeth of the first sun gear 21s/the number of teeth of the first ring gear 21r) is determined as λ1=0.458, for example, and a gear ratio λ2 of the double-pinion type second planetary gear 22 (the number of teeth of the second sun gear 22s/the number of teeth of the first ring gear 21r) is determined as λ2=0.375, for example.

Furthermore, a first drive gear 26 which is an externally toothed gear is always coupled coaxially with the first ring gear 21r of the Ravigneaux type planetary gear mechanism 25. The first ring gear 21r and the first drive gear 26 are always rotated and stopped together with each other. A first driven gear 27 which is an externally toothed gear is always coupled coaxially with the output gear 20o of the automatic transmission 20. The first driven gear 27 is meshed with the first drive gear 26, and always rotated and stopped together with the output gear 20o. The first drive gear 26 and the first driven gear 27 to which power is transferred from the first drive gear 26 constitute a first gear train G1. The first ring gear 21r functions as an output element of the Ravigneaux type planetary gear mechanism 25.

Additionally, a second drive gear 28 which is an externally toothed gear is always coupled coaxially with the first carrier 21c of the Ravigneaux type planetary gear mechanism 25. The first carrier 21c and the second drive gear 28 are always rotated and stopped together with each other. The second drive gear 28 constitutes a second gear train G2 together with a second driven gear (externally toothed gear) 29 meshed with the second drive gear 28. The second gear train G2 is configured such that a gear ratio gr2 thereof (the number of teeth of the second driven gear 29/the number of teeth of the second drive gear 28) is different from a gear ratio gr1 of the first gear train G1 (the number of teeth of the first driven gear 27/the number of teeth of the first drive gear 26). In the embodiment, the gear ratio gr1 of the first gear train G1 is determined as gr1=1.00. Meanwhile, the gear ratio gr2 of the second gear train G2 is determined to be lower than the gear ratio gr1 of the first gear train G1. In the embodiment, the gear ratio gr2 is determined as gr2=0.870.

The third planetary gear 23 has: a third sun gear (stationary element) 23s which is an externally toothed gear; a third ring gear (output element) 23r which is an internally toothed gear disposed concentrically with the third sun gear 23s; and a third carrier 23c (input element) that rotatably and revolvably holds a plurality of sets of two pinion gears 23pa and 23pb meshed with each other. One of the pinion gears 23pa and 23pb is meshed with the third sun gear 23s and the other is meshed with the third ring gear 23r. As illustrated in the drawing, the third sun gear 23s of the third planetary gear 23 is connected to (made stationary with respect to) the transmission case 11 via a support member (front support; not illustrated) so as to be non-rotatable. In addition, the third carrier 23c of the third planetary gear 23 is always coupled to the input shaft 20i, and always rotated and stopped together with the input shaft 20i. Consequently, the third planetary gear 23 functions as a so-called speed reduction gear, reduces the speed of power transferred to the third carrier 23c serving as an input element, and outputs the resultant power from the third ring gear 23r serving as an output element. In the embodiment, a gear ratio λ3 of the third planetary gear 23 (the number of teeth of the third sun gear 23s/the number of teeth of the third ring gear 23r) is determined as λ3=0.487, for example.

Furthermore, the automatic transmission 20 includes a clutch C1 (third engagement element), a clutch C2 (fourth engagement element), a clutch C3 (fifth engagement element), a clutch C4 (sixth engagement element), a brake B1 (first engagement element), a brake B2 (second engagement element), and a clutch C5 (output-side engagement element), all of which are used to change a power transfer path from the input shaft 20i to the output gear 20o.

The clutch C1 connects and disconnects the third ring gear 23r of the third planetary gear 23 and the second sun gear 22s of the Ravigneaux type planetary gear mechanism 25 to and from each other. The clutch C2 connects and disconnects the input shaft 20i and the first carrier 21c of the Ravigneaux type planetary gear mechanism 25 to and from each other. The clutch C3 connects and disconnects the third ring gear 23r of the third planetary gear 23 and the first sun gear 21s of the Ravigneaux type planetary gear mechanism 25 to and from each other. The clutch C4 connects and disconnects the third carrier 23c of the third planetary gear 23, that is, the input shaft 20i, and the first sun gear 21s of the Ravigneaux type planetary gear mechanism 25 to and from each other.

The brake B1 makes the first sun gear 21s (first securable element) of the Ravigneaux type planetary gear mechanism 25 stationary with respect to (connects the first sun gear 21s to) the transmission case 11 so as to be non-rotatable, and makes the first sun gear 21s non-stationary with respect to the transmission case 11. The brake B2 makes the second driven gear 29 of the second gear train G2 stationary with respect to (connects the second driven gear 29 to) the transmission case 11 so as to be non-rotatable, and makes the second driven gear 29 non-stationary with respect to the transmission case 11. When the second driven gear 29 of the second gear train G2 is made stationary with respect to the transmission case 11 so as to be non-rotatable, the first carrier 21c (second securable element) of the Ravigneaux type planetary gear mechanism 25 which is coupled to the second driven gear 29 via the second drive gear 28 is connected to the transmission case 11 so as to be non-rotatable. The clutch C5 connects and disconnects the second driven gear 29 of the second gear train G2 and the output gear 20o (first driven gear 27) to and from each other.

In the embodiment, a multi-plate friction-type hydraulic clutch (friction engagement element) is adopted as the clutches C1, C2, C3, C4, and C5. The multi-plate friction-type hydraulic clutch has a piston, a plurality of friction engagement plates (friction plates and separator plates), and a hydraulic servo constituted of an engagement oil chamber, a centrifugal hydraulic pressure cancellation chamber, etc. to which working oil is supplied. Meanwhile, a multi-plate friction-type hydraulic brake (friction engagement element) is adopted as the brakes B1 and B2. The multi-plate friction-type hydraulic brake has a piston, a plurality of friction engagement plates (friction plates and separator plates), and a hydraulic servo constituted of an engagement oil chamber etc. to which working oil is supplied. The clutches C1 to C5 and the brakes B1 and B2 operate with working oil supplied thereto and discharged therefrom by the hydraulic control device.

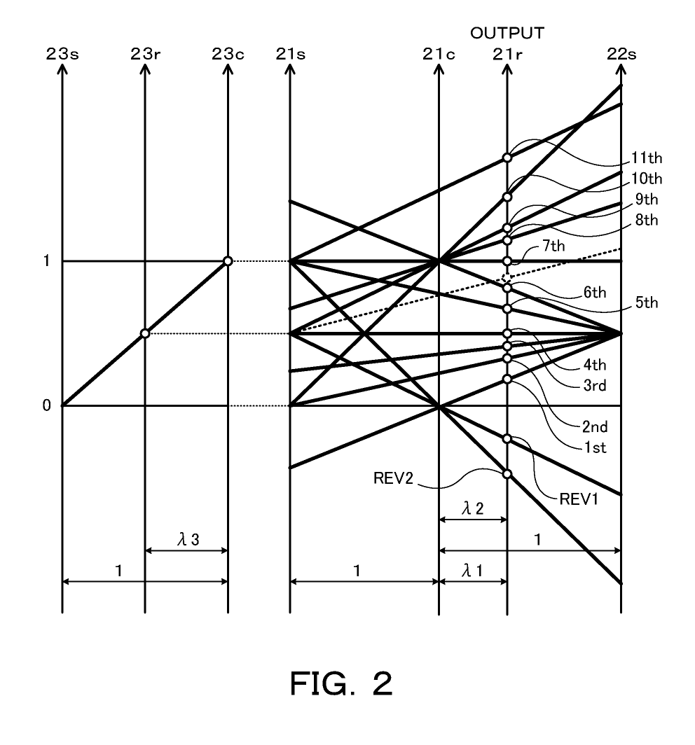

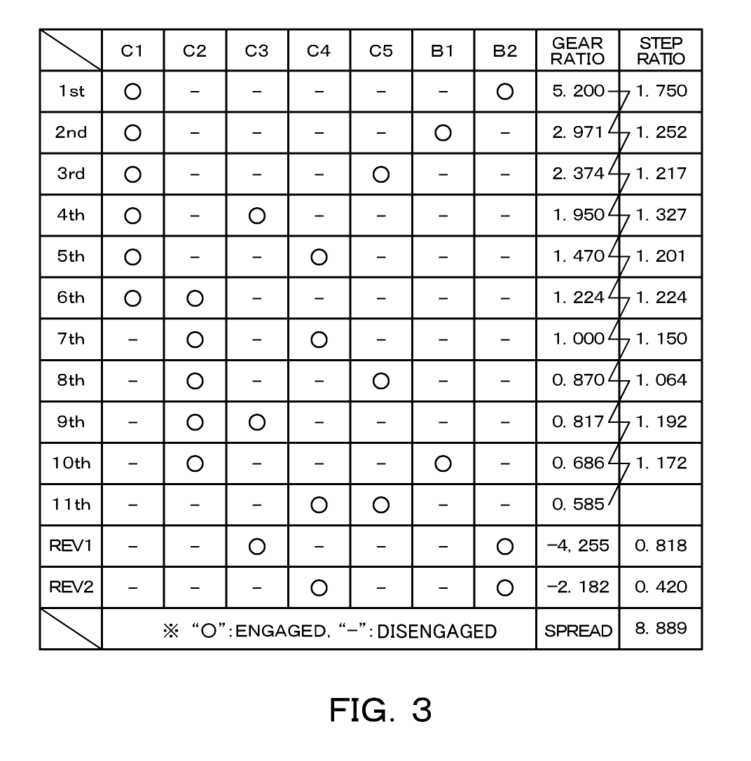

FIG. 2 is a velocity diagram illustrating the ratio of the rotational speed of each rotary element to the rotational speed of the input shaft 20i (input rotational speed) of the automatic transmission 20 (note that the rotational speed of the input shaft 20i, that is, the third carrier 23c, is defined as a value of 1). In addition, FIG. 3 is an operation table illustrating the relationship between each shift speed of the automatic transmission 20 and the respective operating states of the clutches C1 to C5 and the brakes B1 and B2.

As illustrated in FIG. 2, the four rotary elements which constitute the Ravigneaux type planetary gear mechanism 25, that is, the first sun gear 21s which serves as the first securable element, the first carrier 21c which serves as the second securable element, the first ring gear 21r which serves as the output element, and the second sun gear 22s, are arranged, on the velocity diagram for the Ravigneaux type planetary gear mechanism 25 (the velocity diagram on the right side in FIG. 2), in the order of the first sun gear 21s, the first carrier 21c, the first ring gear 21r, and the second sun gear 22s from the left side of the drawing at intervals that match the gear ratio λ1 of the single-pinion type first planetary gear 21 and the gear ratio λ2 of the double-pinion type second planetary gear 22. Here, according to the order of arrangement on the velocity diagram, the first sun gear 21s is defined as a first rotary element of the automatic transmission 20, the first carrier 21c is defined as a second rotary element of the automatic transmission 20, the first ring gear 21r is defined as a third rotary element of the automatic transmission 20, and the second sun gear 22s is defined as a fourth rotary element of the automatic transmission 20. Thus, the Ravigneaux type planetary gear mechanism 25 has the first rotary element, the second rotary element, the third rotary element, and the fourth rotary element of the automatic transmission 20 which are arranged sequentially at intervals that match the gear ratios λ1 and λ2 on the velocity diagram.

In addition, the three rotary elements which constitute the double-pinion type third planetary gear 23, that is, the third sun gear (stationary element) 23s, the third ring gear (output element) 23r, and the third carrier 23c (input element), are arranged, on the velocity diagram for the third planetary gear 23 (the velocity diagram on the left side in FIG. 2), in the order of the third sun gear 23s, the third ring gear 23r, and the third carrier 23c from the left side of the drawing at intervals that match the gear ratio λ3. Here, according to the order of arrangement on the velocity diagram, the third sun gear 23s is defined as a fifth rotary element of the automatic transmission 20, the third ring gear 23r is defined as a sixth rotary element of the automatic transmission 20, and the third carrier 23c is defined as a seventh rotary element of the automatic transmission 20. Thus, the third planetary gear 23 has the fifth rotary element, the sixth rotary element, and the seventh rotary element of the automatic transmission 20 which are arranged sequentially at intervals that match the gear ratio λ3 on the velocity diagram.

In the automatic transmission 20, the clutches C1 to C5 and the brakes B1 and B2 are engaged and disengaged as illustrated in FIG. 3 to change the relationship of connection of the first to seventh rotary elements discussed above, which allows establishing eleven power transfer paths in the forward rotational direction and two power transfer paths in the reverse rotational direction from the input shaft 20i to the output gear 20o, that is, first to eleventh forward speeds and first and second reverse speeds.

Specifically, the first forward speed is established by engaging the clutch C1 and the brake B2 and disengaging the remaining clutches C2 to C5 and brake B1. That is, to establish the first forward speed, the third ring gear 23r (sixth rotary element) of the third planetary gear 23 and the second sun gear 22s (fourth rotary element) of the Ravigneaux type planetary gear mechanism 25 are connected to each other by the clutch C1. Furthermore, the second driven gear 29 of the second gear train G2, that is, the first carrier 21c (second rotary element) which is coupled to the second driven gear 29 via the second drive gear 28, is made stationary with respect to the transmission case 11 by the brake B2 so as to be non-rotatable. In the embodiment (in the case where the gear ratios of the first to third planetary gears are determined as λ1=0.458, λ2=0.375, and λ3=0.487 and the gear ratios gr1 and gr2 of the first and second gear trains G1 and G2 are determined as gr1=1.00 and gr2=0.870; the same applies hereinafter), a gear ratio γ1 of the first forward speed (the rotational speed of the input shaft 20i/the rotational speed of the output gear 20o) is determined as γ1=5.200.

The second forward speed is established by engaging the clutch C1 and the brake B1 and disengaging the remaining clutches C2 to C5 and brake B2. That is, to establish the second forward speed, the third ring gear 23r of the third planetary gear 23 and the second sun gear 22s of the Ravigneaux type planetary gear mechanism 25 are connected to each other by the clutch C1. Furthermore, the first sun gear 21s (first rotary element) of the Ravigneaux type planetary gear mechanism 25 is made stationary with respect to the transmission case 11 by the brake B1 so as to be non-rotatable. In the embodiment, a gear ratio γ2 of the second forward speed is determined as γ2=2.971. In addition, the step ratio between the first forward speed and the second forward speed is determined as γ1/γ2=1.750.

The third forward speed is established by engaging the clutches C1 and C5 and disengaging the remaining clutches C2 to C4 and brakes B1 and B2. That is, to establish the third forward speed, the third ring gear 23r of the third planetary gear 23 and the second sun gear 22s of the Ravigneaux type planetary gear mechanism 25 are connected to each other by the clutch C1. Furthermore, the second driven gear 29 of the second gear train G2 and the output gear 20o (first driven gear 27) are connected to each other by the clutch C5. In the embodiment, a gear ratio γ3 of the third forward speed is determined as γ3=2.374. In addition, the step ratio between the second forward speed and the third forward speed is determined as γ2/γ3=1.252.

The fourth forward speed is established by engaging the clutches C1 and C3 and disengaging the remaining clutches C2, C4, and C5 and brakes B1 and B2. That is, to establish the fourth forward speed, the third ring gear 23r of the third planetary gear 23 and the second sun gear 22s of the Ravigneaux type planetary gear mechanism 25 are connected to each other by the clutch C1. Furthermore, the third ring gear 23r (sixth rotary element) of the third planetary gear 23 and the first sun gear 21s (first rotary element) of the Ravigneaux type planetary gear mechanism 25 are connected to each other by the clutch C3. In the embodiment, a gear ratio γ4 of the fourth forward speed is determined as γ4=1.950. In addition, the step ratio between the third forward speed and the fourth forward speed is determined as γ3/γ4=1.217.

The fifth forward speed is established by engaging the clutches C1 and C4 and disengaging the remaining clutches C2, C3, and C5 and brakes B1 and B2. That is, to establish the fifth forward speed, the third ring gear 23r of the third planetary gear 23 and the second sun gear 22s of the Ravigneaux type planetary gear mechanism 25 are connected to each other by the clutch C1. Furthermore, the input shaft 20i (the third carrier 23c of the third planetary gear 23) and the first sun gear 21s (first rotary element) of the Ravigneaux type planetary gear mechanism 25 are connected to each other by the clutch C4. In the embodiment, a gear ratio γ5 of the fifth forward speed is determined as γ5=1.470. In addition, the step ratio between the fourth forward speed and the fifth forward speed is determined as γ4/γ5=1.327.

The sixth forward speed is established by engaging the clutches C1 and C2 and disengaging the remaining clutches C3, C4, and C5 and brakes B1 and B2. That is, to establish the sixth forward speed, the third ring gear 23r of the third planetary gear 23 and the second sun gear 22s of the Ravigneaux type planetary gear mechanism 25 are connected to each other by the clutch C1. Furthermore, the input shaft 20i and the first carrier 21c (second rotary element) of the Ravigneaux type planetary gear mechanism 25 are connected to each other by the clutch C2. In the embodiment, a gear ratio γ6 of the sixth forward speed is determined as γ6=1.224. In addition, the step ratio between the fifth forward speed and the sixth forward speed is determined as γ5/γ6=1.201.

The seventh forward speed is established by engaging the clutches C2 and C4 and disengaging the remaining clutches C1, C3, and C5 and brakes B1 and B2. That is, to establish the seventh forward speed, the input shaft 20i and the first carrier 21c of the Ravigneaux type planetary gear mechanism 25 are connected to each other by the clutch C2. Furthermore, the input shaft 20i (the third carrier 23c of the third planetary gear 23) and the first sun gear 21s of the Ravigneaux type planetary gear mechanism 25 are connected to each other by the clutch C4. In the embodiment, a gear ratio γ′7 of the seventh forward speed is determined as γ7=1.000. In addition, the step ratio between the sixth forward speed and the seventh forward speed is determined as γ6/γ7=1.224.

The eighth forward speed is established by engaging the clutches C2 and C5 and disengaging the remaining clutches C1, C3, and C4 and brakes B1 and B2. That is, to establish the eighth forward speed, the input shaft 20i and the first carrier 21c of the Ravigneaux type planetary gear mechanism 25 are connected to each other by the clutch C2. Furthermore, the second driven gear 29 of the second gear train G2 and the output gear 20o (first driven gear 27) are connected to each other by the clutch C5. In the embodiment, a gear ratio γ8 of the eighth forward speed is determined as γ8=0.870. In addition, the step ratio between the seventh forward speed and the eighth forward speed is determined as γ7/γ8=1.150.

The ninth forward speed is established by engaging the clutches C2 and C3 and disengaging the remaining clutches C1, C4, and C5 and brakes B1 and B2. That is, to establish the ninth forward speed, the input shaft 20i and the first carrier 21c of the Ravigneaux type planetary gear mechanism 25 are connected to each other by the clutch C2. Furthermore, the third ring gear 23r of the third planetary gear 23 and the first sun gear 21s of the Ravigneaux type planetary gear mechanism 25 are connected to each other by the clutch C3. In the embodiment, a gear ratio γ9 of the ninth forward speed is determined as γ9=0.817. In addition, the step ratio between the eighth forward speed and the ninth forward speed is determined as γ8/γ9=1.064.

The tenth forward speed is established by engaging the clutch C2 and the brake B1 and disengaging the remaining clutches C1, C3, C4, and C5 and brake B2. That is, to establish the tenth forward speed, the input shaft 20i and the first carrier 21c of the Ravigneaux type planetary gear mechanism 25 are connected to each other by the clutch C2. Furthermore, the first sun gear 21s of the Ravigneaux type planetary gear mechanism 25 is made stationary with respect to the transmission case 11 by the brake B1 so as to be non-rotatable. In the embodiment, a gear ratio γ10 of the tenth forward speed is determined as γ10=0.686. In addition, the step ratio between the ninth forward speed and the tenth forward speed is determined as γ9/γ10=1.192.

The eleventh forward speed is established by engaging the clutches C4 and C5 and disengaging the remaining clutches C1, C2, and C3 and brakes B1 and B2. That is, to establish the eleventh forward speed, the input shaft 20i (the third carrier 23c of the third planetary gear 23) and the first sun gear 21s of the Ravigneaux type planetary gear mechanism 25 are connected to each other by the clutch C4. Furthermore, the second driven gear 29 of the second gear train G2 and the output gear 20o (first driven gear 27) are connected to each other by the clutch C5. In the embodiment, a gear ratio γ11 of the eleventh forward speed is determined as γ11=0.585. In addition, the step ratio between the tenth forward speed and the eleventh forward speed is determined as γ10/γ11=1.172. Furthermore, the spread (gear ratio width=the gear ratio γ1 of the first forward speed as the lowest shift speed/the gear ratio γ11 of the eleventh forward speed as the highest shift speed) of the automatic transmission 20 is determined as γ1/γ11=8.889.

The first reverse speed is established by engaging the clutch C3 and the brake B2 and disengaging the remaining clutches C1, C2, C4, and C5 and brake B1. That is, to establish the first reverse speed, the third ring gear 23r of the third planetary gear 23 and the first sun gear 21s of the Ravigneaux type planetary gear mechanism 25 are connected to each other by the clutch C3. Furthermore, the second driven gear 29 of the second gear train G2, that is, the first carrier 21c which is coupled to the second driven gear 29 via the second drive gear 28, is made stationary with respect to the transmission case 11 by the brake B2 so as to be non-rotatable. A gear ratio γrev1 of the first reverse speed is determined as γrev1=−4.255. In addition, the step ratio between the first forward speed and the first reverse speed is determined as |γrev1/γ1|=0.818.

The second reverse speed is established by engaging the clutch C4 and the brake B2 and disengaging the remaining clutches C1, C2, C3, and C5 and brake B1. That is, to establish the second reverse speed, the input shaft 20i (the third carrier 23c of the third planetary gear 23) and the first sun gear 21s of the Ravigneaux type planetary gear mechanism 25 are connected to each other by the clutch C4. Furthermore, the second driven gear 29 of the second gear train G2, that is, the first carrier 21c which is coupled to the second driven gear 29 via the second drive gear 28, is made stationary with respect to the transmission case 11 by the brake B2 so as to be non-rotatable. A gear ratio γrev2 of the second reverse speed is determined as γrev2=−2.182. In addition, the step ratio between the first forward speed and the second reverse speed is determined as |γrev2/γ1|=0.420.

As discussed above, with the automatic transmission 20, the first to eleventh forward speeds and the first and second reverse speeds can be established by engaging and disengaging the clutches C1 to C5 and the brakes B1 and B2. With the automatic transmission 20, one of the clutches C1, C2, and C4 and the clutch C5 are engaged to establish the third, eighth, and eleventh forward speeds. When the output gear 20o is rotated with the clutch C5 engaged in this way, the first carrier 21c (one of the rotary elements), which is coupled via the second drive gear 28 to the second driven gear 29 which is rotated together with and in the same direction as the output gear 20o and the first driven gear 27, is rotated with respect to the output gear 20o at a rotational speed that matches the gear ratio gr2 of the second gear train G2. When the output gear 20o is rotated with the clutch C5 engaged, in addition, the first ring gear 21r which is the output element of the Ravigneaux type planetary gear mechanism 25 is rotated with respect to the output gear 20o at a rotational speed that matches the gear ratio gr1 of the first gear train G1. Thus, by engaging one of the clutches C1, C2, and C4 and the clutch C5, a rotational speed difference that matches the gear ratios gr1 and gr2 of the first and second gear trains G1 and G2 can be caused between the first ring gear 21r and the first carrier 21c of the Ravigneaux type planetary gear mechanism 25. Consequently, with the automatic transmission 20, it is possible to establish shift speeds other than those obtained by selectively engaging two of the clutches C1 to C4 and the brakes B1 and B2.

That is, when the clutch C5 is engaged with torque from the input shaft 20i transferred to the second sun gear 22s (fourth rotary element) of the Ravigneaux type planetary gear mechanism 25 via the third ring gear 23r of the third planetary gear 23 through engagement of the clutch C1, the second driven gear 29 is rotated together with and in the same direction as the output gear 20o and the first driven gear 27, so that the speed of the first carrier 21c of the Ravigneaux type planetary gear mechanism 25 can be increased compared to the time when the second forward speed is established and the speed of the first ring gear 21r can be reduced compared to the time when the fourth forward speed is established as illustrated in FIG. 2. Consequently, it is possible to establish the third forward speed with the gear ratio γ3 which is lower than the gear ratio γ2 of the second forward speed and higher than the gear ratio γ4 of the fourth forward speed.

When the clutch C5 is engaged with torque directly transferred from the input shaft 20i to the first carrier 21c (second rotary element) of the Ravigneaux type planetary gear mechanism 25 through engagement of the clutch C2, meanwhile, the second driven gear 29 is rotated together with and in the same direction as the output gear 20o and the first driven gear 27, so that the speed of the first ring gear 21r of the Ravigneaux type planetary gear mechanism 25 can be increased compared to the time when the seventh forward speed is established and the speed of the first ring gear 21r can be reduced compared to the time when the ninth forward speed is established as illustrated in FIG. 2. Consequently, it is possible to establish the eighth forward speed with the gear ratio γ8 which is lower than the gear ratio γ7 of the seventh forward speed and higher than the gear ratio γ9 of the ninth forward speed.

When the clutch C5 is engaged with torque from the input shaft 20i transferred to the first sun gear 21s (first rotary element) of the Ravigneaux type planetary gear mechanism 25 via the third ring gear 23r of the third planetary gear 23 through engagement of the clutch C4, further, the second driven gear 29 is rotated together with and in the same direction as the output gear 20o and the first driven gear 27, so that the speed of the first ring gear 21r of the Ravigneaux type planetary gear mechanism 25 can be increased compared to the time when the tenth forward speed is established as illustrated in FIG. 2. Consequently, it is possible to establish the eleventh forward speed with the gear ratio γ11 which is lower than the gear ratio γ10 of the tenth forward speed.

As discussed above, with the automatic transmission 20 in which torque from the input shaft 20i side is selectively (sequentially) transferred to the second sun gear 22s, the first carrier 21c, and the first sun gear 21s, not the first ring gear 21r (output element), of the Ravigneaux type planetary gear mechanism 25, three shift speeds (third, eighth, and eleventh forward speeds) can be added to the speed change device (see JP 2013-204754 A) to which the first and second gear trains G1 and G2 and the clutch C5 have not been added. As a result, with the automatic transmission 20, the spread can be further increased (in the embodiment, to 8.889) by the addition of the eleventh forward speed as the highest shift speed to improve the fuel efficiency of the vehicle at a high vehicle speed, in particular. By the addition of intermediate shift speeds (third and eighth forward speeds), further, the step ratios can be optimized (an increase in the step ratios can be suppressed) to improve the shifting feeling. Thus, with the automatic transmission 20, it is possible to improve both the fuel efficiency and the drivability of the vehicle well.

In addition, the number of shift speeds can be increased, while suppressing an increase in the size of the entire device or the number of components, by combining the Ravigneaux type planetary gear mechanism 25, which is a composite planetary gear mechanism with four elements, the first and second gear trains G1 and G2, and the clutch C5 with each other as in the automatic transmission 20. With the automatic transmission 20, further, as illustrated in FIG. 1, the brake B2 can be disposed around the axis (second shaft) of the output gear 20o. Thus, it is possible to suppress an increase in the physical size around the Ravigneaux type planetary gear mechanism 25 (in an end portion remote from the engine).

In the automatic transmission 20, the gear ratio gr2 of the second gear train G2 may be determined as gr2=1.00, and the gear ratio gr1 of the first gear train G1 may be lower than the gear ratio gr2 (for example, gr1=1.15). In this case, the gear ratios γ1 to γ11 of the first to eleventh forward speeds and the gear ratios γrev1 and γrev2 of the first and second reverse speeds may have the following values: γ1=5.980, γ2=3.417, γ3=2.730, γ4=2.243, γ5=1.690, γ6=1.407, γ7=1.150, γ8=1.000, γ9=0.940, γ10=0.789, γ11=0.673, γrev1=−4.893, and γrev2=−2.509.

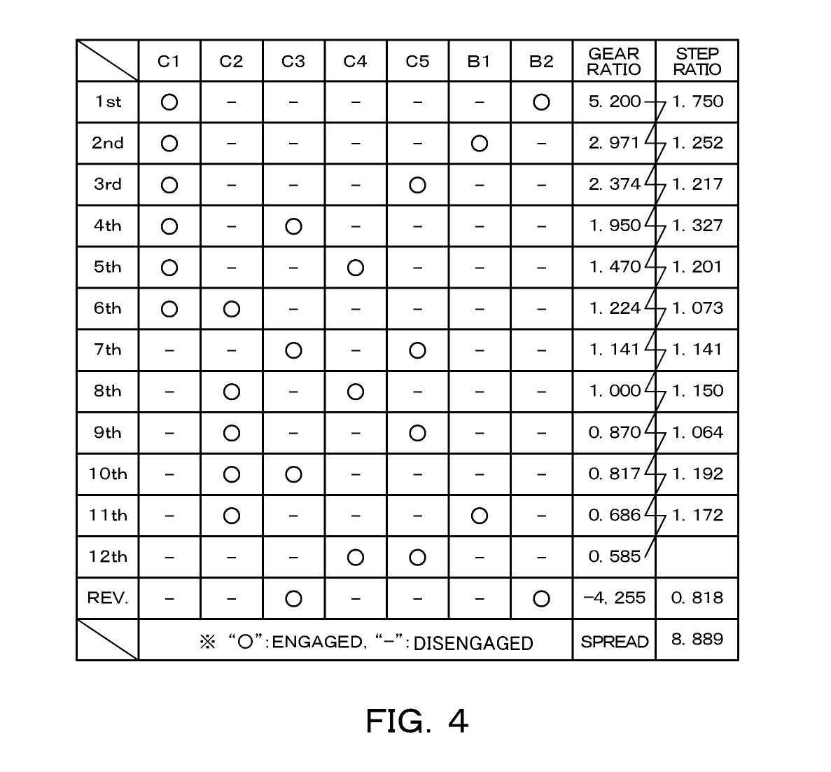

With the automatic transmission 20, in addition, it is possible to establish a shift speed with a gear ratio that is lower than the gear ratio γ6 of the sixth forward speed and higher than the gear ratio γ7 of the seventh forward speed, as indicated by the dotted line in FIG. 2, by engaging the clutch C3 and the clutch C5 and the disengaging the remaining clutches C1, C2, and C4 and brakes B1 and B2. Thus, with the automatic transmission 20, as illustrated in FIG. 4, the shift speed which is established by engaging the clutch C3 and the clutch C5 can be determined as a seventh forward speed, and the seventh to eleventh forward speeds in FIGS. 2 and 3 can be used as eighth to twelfth forward speeds. Consequently, with the number of shift speeds further increased, it is possible to improve both the fuel efficiency and the drivability of the vehicle significantly well.

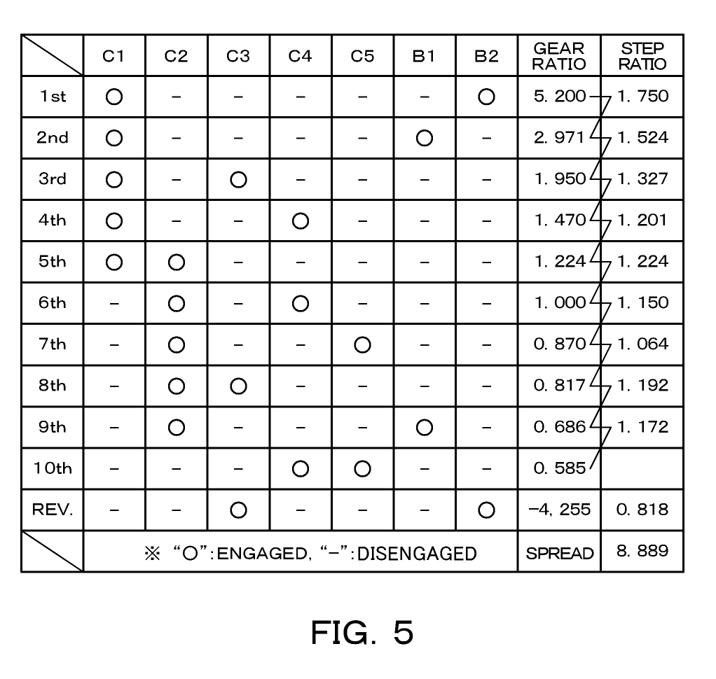

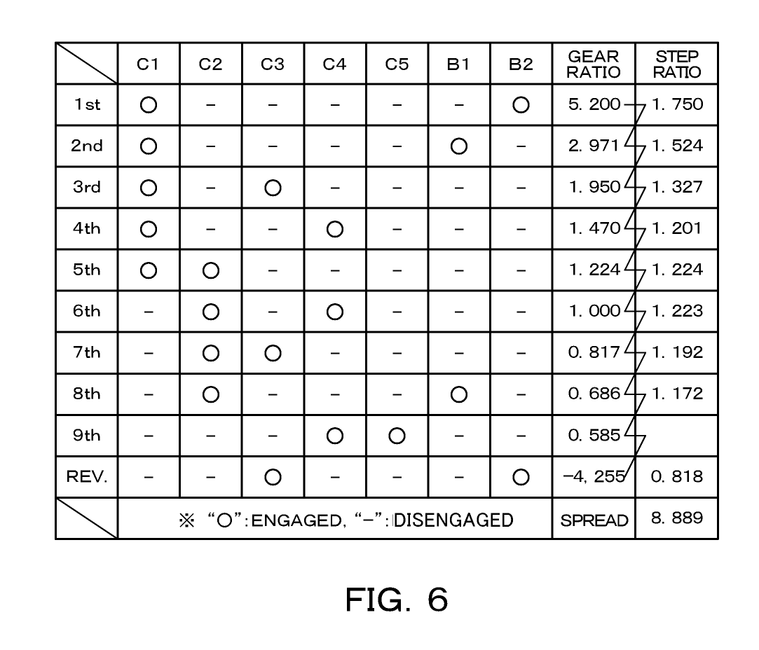

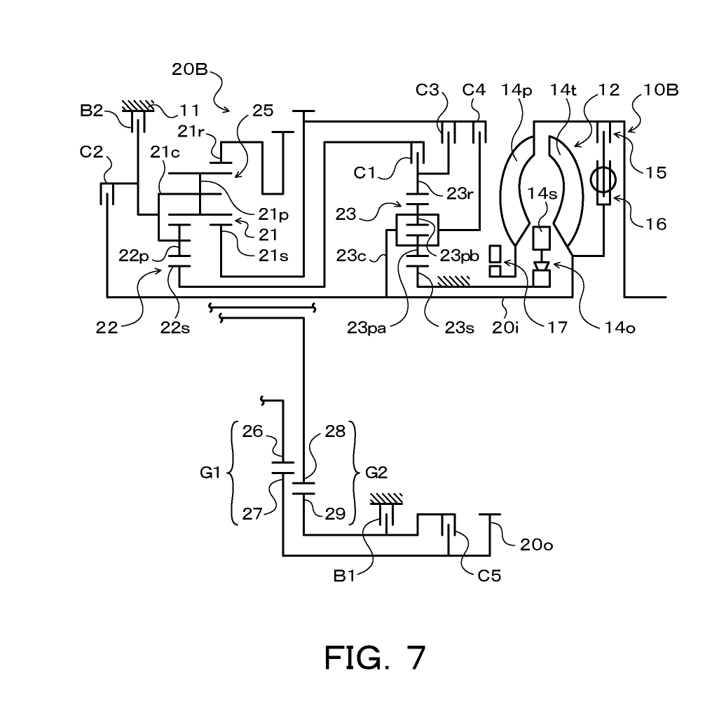

In the automatic transmission 20, further, the establishment of the third forward speed in FIGS. 2 and 3 may be omitted, and the fourth to eleventh forward speeds in FIGS. 2 and 3 may be used as third to tenth forward speeds (see FIG. 5). In the automatic transmission 20, in addition, the establishment of the third and eighth forward speeds in FIGS. 2 and 3 may be omitted, and the fourth to seventh forward speeds in FIGS. 2 and 3 may be used as third to sixth forward speeds, and the ninth to eleventh forward speeds in FIGS. 2 and 3 may be used as seventh to ninth forward speeds (see FIG. 6). In such cases as well, the spread can be further increased by the addition of the tenth or ninth forward speed as the highest shift speed to improve the fuel efficiency of the vehicle at a high vehicle speed, in particular.

FIG. 7 is a diagram illustrating a schematic configuration of a power transfer device 10B that includes an automatic transmission 20B according to a modified aspect of the first embodiment of the present disclosure. Constituent elements of the automatic transmission 20B that are identical to the elements of the automatic transmission 20 discussed above are given the same numerals to omit redundant descriptions (the same applies hereinafter for the first embodiment).

In the automatic transmission 20B illustrated in FIG. 7, the second drive gear 28 which constitutes the second gear train G2 is always coupled coaxially with the first sun gear 21s of the Ravigneaux type planetary gear mechanism 25 which is a first rotary element of the automatic transmission 20B. In the automatic transmission 20B, in addition, the brake B1 makes the first sun gear 21s (first securable element) of the Ravigneaux type planetary gear mechanism 25 stationary with respect to the transmission case 11 so as to be non-rotatable by connecting the second driven gear 29 of the second gear train G2 to the transmission case 11. In the automatic transmission 20B, further, the brake B2 is configured to connect the first carrier 21c (second securable element) of the Ravigneaux type planetary gear mechanism 25 to the transmission case 11, and disposed around the Ravigneaux type planetary gear mechanism 25. The thus configured automatic transmission 20B also allows obtaining functions and effects that are similar to those of the automatic transmission 20 discussed above.

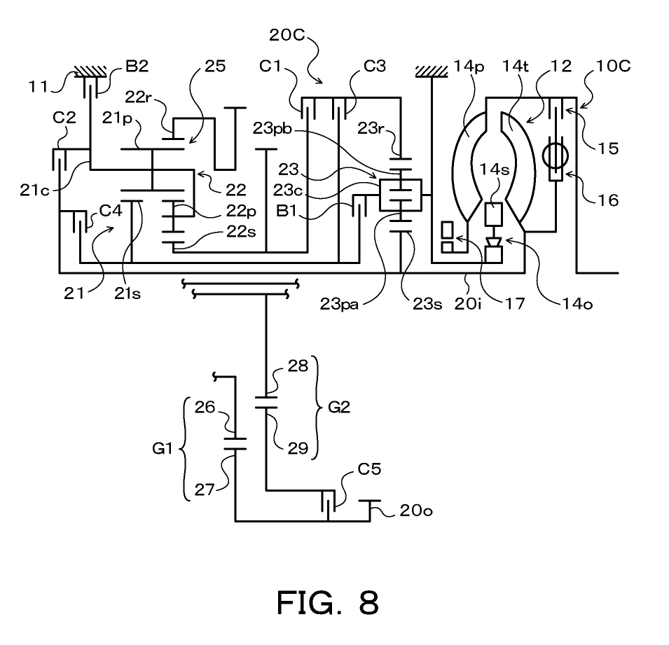

FIG. 8 is a diagram illustrating a schematic configuration of a power transfer device 10C that includes an automatic transmission 20C according to another modified aspect of the first embodiment of the present disclosure. In the automatic transmission 20C illustrated in the drawing, the first and second planetary gears 21 and 22, which constitute the Ravigneaux type planetary gear mechanism 25, and the third planetary gear 23 are disposed in the transmission case 11 so as to be arranged in the order of the third planetary gear 23, the second planetary gear 22, and the first planetary gear 21 from the starting device 12 side, that is, the engine side (the right side in FIG. 8). In addition, the third carrier 23c of the third planetary gear 23 is connected to (made stationary with respect to) the transmission case 11 via a support member (front support) so as to be non-rotatable. Furthermore, the third sun gear 23s of the third planetary gear 23 is always coupled to the input shaft 20i, and always rotated and stopped together with the input shaft 20i.

In the automatic transmission 20C, in addition, the second drive gear 28 which constitutes the second gear train G2 is always coupled coaxially with the second sun gear 22s of the Ravigneaux type planetary gear mechanism 25 which is a fourth rotary element of the automatic transmission 20C. In the example illustrated in FIG. 8, the gear ratio gr2 of the second gear train G2 is determined to be higher than the gear ratio gr1 of the first gear train G1. In the automatic transmission 20C, further, the brake B1 makes the first sun gear 21s (first securable element) of the Ravigneaux type planetary gear mechanism 25 stationary with respect to the transmission case 11 so as to be non-rotatable by connecting the third carrier 23c of the third planetary gear 23 and the first sun gear 21s to each other. In addition, the brake B2 is configured to connect the first carrier 21c (second securable element) of the Ravigneaux type planetary gear mechanism 25 to the transmission case 11, and disposed around the Ravigneaux type planetary gear mechanism 25. Furthermore, the clutch C4 is configured to connect and disconnect the first sun gear 21s (first rotary element) of the Ravigneaux type planetary gear mechanism 25 and the input shaft 20i to and from each other, and disposed in an end portion of the automatic transmission 20C that is remote from the engine as with the clutch C2. The thus configured automatic transmission 20C also allows obtaining functions and effects that are similar to those of the automatic transmission 20 discussed above.

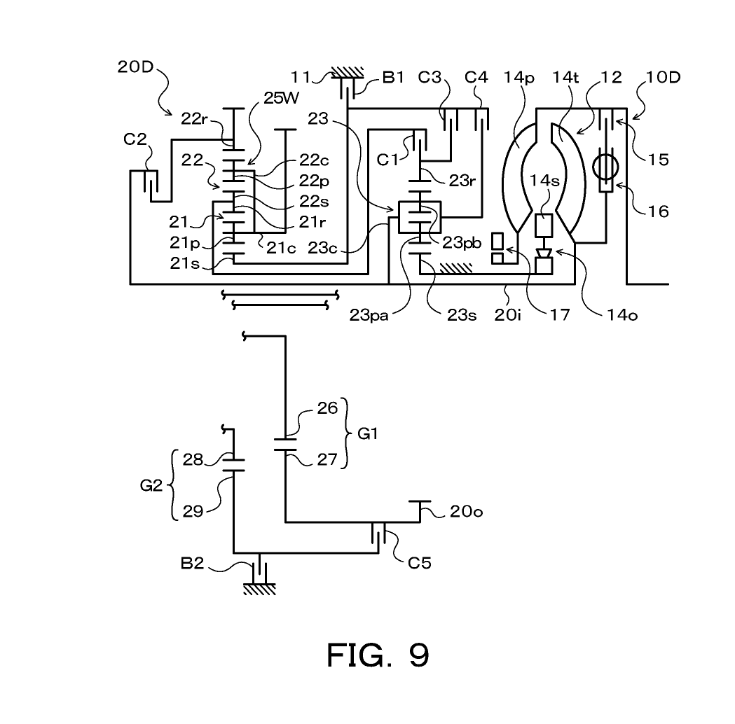

FIG. 9 is a diagram illustrating a schematic configuration of a power transfer device 10D that includes an automatic transmission 20D according to still another modified aspect of the first embodiment of the present disclosure. The automatic transmission 20D illustrated in the drawing corresponds to the automatic transmission 20 described above, and in the automatic transmission 20D the Ravigneaux type planetary gear mechanism 25 has been replaced with a composite planetary gear mechanism 25W constituted by combining the single-pinion type first and second planetary gears 21 and 22 with each other. The first planetary gear 21 of the composite planetary gear mechanism 25W has a first sun gear 21s, a first ring gear 21r, and a first carrier 21c that rotatably and revolvably holds a plurality of first pinion gears 21p meshed with the first sun gear 21s and the first ring gear 21r. In addition, the second planetary gear 22 has a second sun gear 22s, a second ring gear 22r, and a second carrier 22c that rotatably and revolvably holds a plurality of second pinion gears 22p meshed with the second sun gear 22s and the second ring gear 22r.

In the composite planetary gear mechanism 25W, as illustrated in the drawing, the first ring gear 21r of the first planetary gear 21 and the second sun gear 22s of the second planetary gear 22 are always coupled to each other. In the example illustrated in FIG. 9, the second sun gear 22s is shaped integrally (integrated) with the first ring gear 21r so as to surround the inner teeth of the first ring gear 21r. In addition, the first carrier 21c of the first planetary gear 21 and the second carrier 22c of the second planetary gear 22 are always coupled to each other. Furthermore, the composite planetary gear mechanism 25W is disposed such that the second planetary gear 22 surrounds the first planetary gear 21, and such that the first pinion gears 21p of the first planetary gear 21 and the second pinion gears 22p of the second planetary gear 22 at least partially overlap each other in the axial direction as seen in the radial direction.

In addition, the clutch C1 of the automatic transmission 20D connects and disconnects the third ring gear 23r (sixth rotary element) of the third planetary gear 23 and the first ring gear 21r and the second sun gear 22s (fourth rotary element), which are always coupled to (integrated with) each other, of the composite planetary gear mechanism 25W to and from each other. The clutch C2 connects and disconnects the input shaft 20i and the second ring gear 22r (second rotary element) of the composite planetary gear mechanism 25W to and from each other. The clutch C3 connects and disconnects the third ring gear 23r (sixth rotary element) of the third planetary gear 23 and the first sun gear 21s (first rotary element) of the composite planetary gear mechanism 25W to and from each other. The clutch C4 connects and disconnects the third carrier 23c of the third planetary gear 23, that is, the input shaft 20i, and the first sun gear 21s (first rotary element) of the composite planetary gear mechanism 25W to and from each other.

The brake B1 makes the first sun gear 21s (first securable element) of the composite planetary gear mechanism 25W stationary with respect to (connects the first sun gear 21s to) the transmission case 11 so as to be non-rotatable, and makes the first sun gear 21s non-stationary with respect to the transmission case 11. The brake B2 makes the second ring gear 22r of the composite planetary gear mechanism 25W stationary with respect to the transmission case 11 so as to be non-rotatable by connecting the second driven gear 29 of the second gear train G2 to the transmission case 11. The clutch C5 connects and disconnects the second driven gear 29 of the second gear train G2 and the output gear 20o (first driven gear 27) to and from each other.

Furthermore, the first drive gear (externally toothed gear) 26 of the first gear train G1 is always coupled coaxially with the first and second carriers 21c and 22c of the composite planetary gear mechanism 25W. The first and second carriers 21c and 22c function as an output element of the composite planetary gear mechanism 25W. In addition, the second drive gear (externally toothed gear) 28 of the second gear train G2 is always coupled coaxially with the second ring gear 22r (second rotary element) of the composite planetary gear mechanism 25W. In the example illustrated in FIG. 9, the gear ratio gr2 of the second gear train G2 is determined to be lower than the gear ratio gr1 of the first gear train G1.

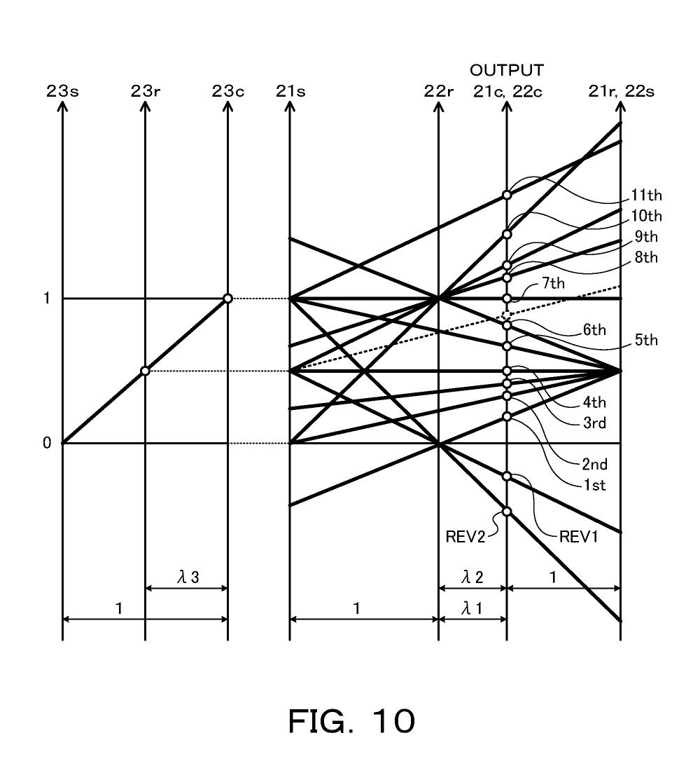

FIG. 10 is a velocity diagram illustrating the ratio of the rotational speed of each rotary element to the rotational speed of the input shaft 20i (input rotational speed) of the automatic transmission 20D (note that the rotational speed of the input shaft 20i, that is, the third carrier 23c, is defined as a value of 1). As illustrated in the drawing, the four rotary elements which constitute the composite planetary gear mechanism 25W, that is, the first sun gear 21s which serves as the first securable element, the second ring gear 22r which serves as the second securable element, the first and second carriers 21c and 22c which are always coupled to each other and which serve as the output element, and the first ring gear 21r and the second sun gear 22s which are always coupled to each other, are arranged, on the velocity diagram for the composite planetary gear mechanism 25W (the velocity diagram on the right side in FIG. 10), in the order of the first sun gear 21s, the second ring gear 22r, the first and second carriers 21c and 22c, and the first ring gear 21r and the second sun gear 22s from the left side of the drawing at intervals that match the gear ratio λ1 of the first planetary gear 21 and the gear ratio λ2 of the second planetary gear 22. Here, according to the order of arrangement on the velocity diagram, the first sun gear 21s is defined as a first rotary element of the automatic transmission 20D, the second ring gear 22r is defined as a second rotary element of the automatic transmission 20D, the first and second carriers 21c and 22c are defined as a third rotary element of the automatic transmission 20D, and the first ring gear 21r and the second sun gear 22s are defined as a fourth rotary element of the automatic transmission 20D. Thus, the composite planetary gear mechanism 25W has the first rotary element, the second rotary element, the third rotary element, and the fourth rotary element of the automatic transmission 20D which are arranged sequentially at intervals that match the gear ratios λ1 and λ2 on the velocity diagram.

The automatic transmission 20D configured as discussed above also allows obtaining functions and effects that are similar to those of the automatic transmission 20 described above. By adopting the composite planetary gear mechanism 25W which is constituted by combining the single-pinion type first and second planetary gears 21 and 22 with each other, it is possible to further improve the assemblability while suppressing an increase in the weight of the automatic transmission 20D by reducing the number of components. With the composite planetary gear mechanism 25W illustrated in FIG. 9, further, the second planetary gear 22 can be disposed so as to surround the first planetary gear 21. Thus, it is possible to further shorten the axial length of the automatic transmission 20D.

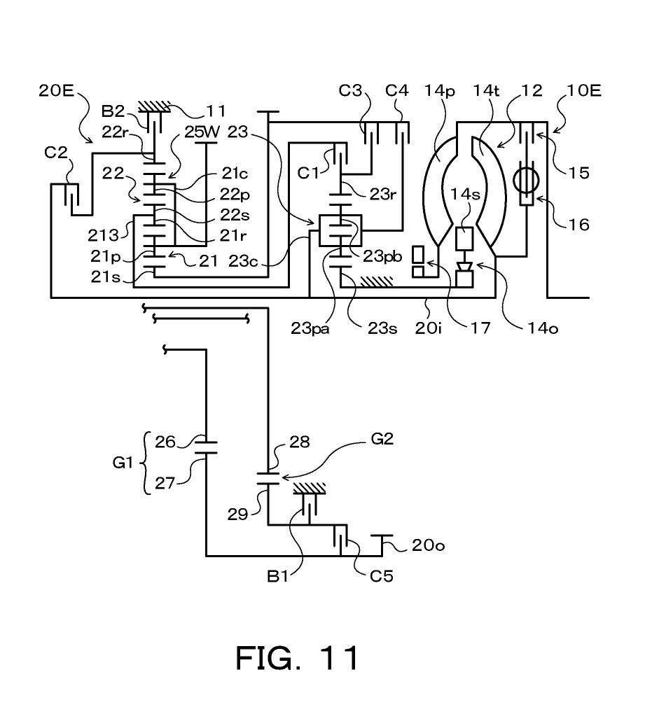

FIG. 11 is a diagram illustrating a schematic configuration of a power transfer device 10E that includes an automatic transmission 20E according to another modified aspect of the first embodiment of the present disclosure. The automatic transmission 20E illustrated in the drawing corresponds to the automatic transmission 20B described above, and in the automatic transmission 20E the Ravigneaux type planetary gear mechanism 25 has been replaced with the composite planetary gear mechanism 25W. That is, in the automatic transmission 20E, the second drive gear 28 which constitutes the second gear train G2 is always coupled coaxially with the first sun gear 21s of the composite planetary gear mechanism 25W which is a first rotary element of the automatic transmission 20E. In the example illustrated in FIG. 11, the gear ratio gr2 of the second gear train G2 is determined to be lower than the gear ratio gr1 of the first gear train G1. In the automatic transmission 20E, in addition, the brake B1 makes the first sun gear 21s (first securable element) of the composite planetary gear mechanism 25W stationary with respect to the transmission case 11 so as to be non-rotatable by connecting the second driven gear 29 of the second gear train G2 to the transmission case 11. Furthermore, the brake B2 is configured to connect the second ring gear 22r (second securable element) of the composite planetary gear mechanism 25W to the transmission case 11, and disposed around the composite planetary gear mechanism 25W. The thus configured automatic transmission 20E also allows obtaining functions and effects that are similar to those of the automatic transmission 20 etc. discussed above.

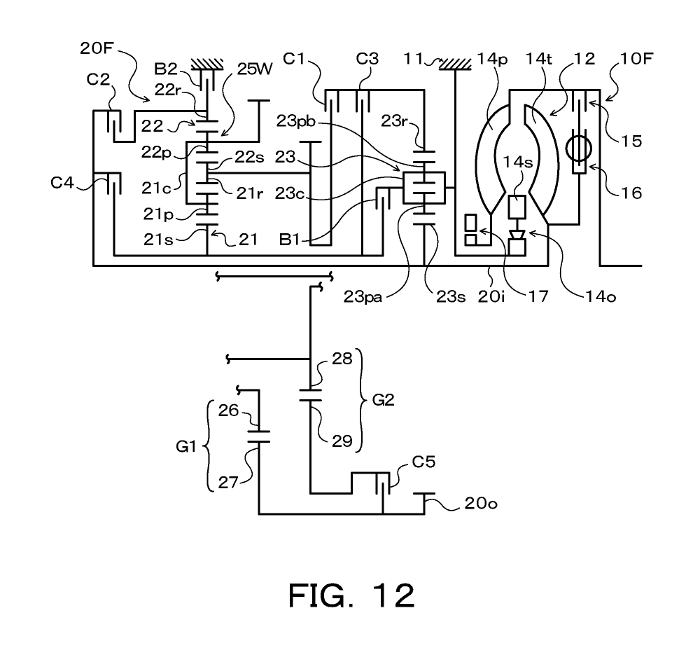

FIG. 12 is a diagram illustrating a schematic configuration of a power transfer device 10F that includes an automatic transmission 20F according to another modified aspect of the first embodiment of the present disclosure. The automatic transmission 20F illustrated in the drawing corresponds to the automatic transmission 20C described above, and in the automatic transmission 20F the Ravigneaux type planetary gear mechanism 25 has been replaced with the composite planetary gear mechanism 25W. That is, in the automatic transmission 20F, the second drive gear 28 which constitutes the second gear train G2 is always coupled coaxially with the first ring gear 21r and the second sun gear 22s of the composite planetary gear mechanism 25W which is a fourth rotary element of the automatic transmission 20F. In the example illustrated in FIG. 12, the gear ratio gr2 of the second gear train G2 is determined to be higher than the gear ratio gr1 of the first gear train G1. The thus configured automatic transmission 20F also allows obtaining functions and effects that are similar to those of the automatic transmission 20 etc. discussed above.

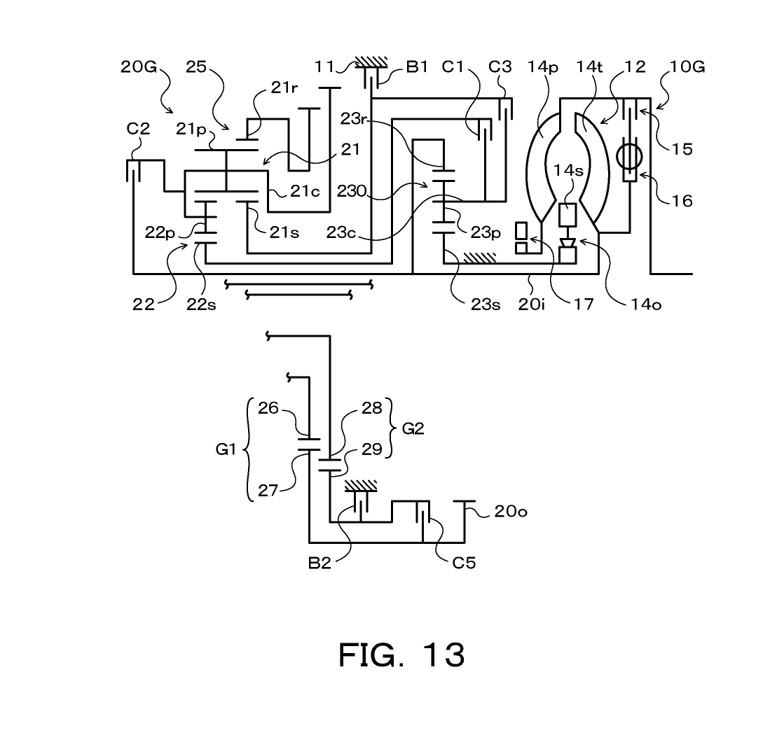

FIG. 13 is a diagram illustrating a schematic configuration of a power transfer device 10G that includes an automatic transmission 20G according to a second embodiment of the present disclosure. Constituent elements of the automatic transmission 20G that are identical to the elements of the automatic transmission 20 etc. discussed above are given the same numerals to omit redundant descriptions.

The automatic transmission 20G illustrated in FIG. 13 corresponds to the automatic transmission 20 discussed above, and in the automatic transmission 20G the double-pinion type third planetary gear 23 has been replaced with a single-pinion type third planetary gear 230 and the clutch C4 has been omitted. The third planetary gear 230 has a third sun gear 23s, a third ring gear 23r, and a third carrier 23c that rotatably and revolvably holds a plurality of third pinion gears 23p meshed with the third sun gear 23s and the third ring gear 23r. As illustrated in the drawing, the third sun gear 23s of the third planetary gear 230 is connected to (made stationary with respect to) the transmission case 11 via a support member (front support; not illustrated) so as to be non-rotatable. In addition, the third ring gear 23r of the third planetary gear 23 is always coupled to the input shaft 20i, and always rotated and stopped together with the input shaft 20i. Consequently, the third planetary gear 230 functions as a so-called speed reduction gear, reduces the speed of power transferred to the third ring gear 23r serving as an input element, and outputs the resultant power from the third carrier 23c serving as an output element.

In addition, the clutch C1 of the automatic transmission 20G connects and disconnects the third carrier 23c of the third planetary gear 23 and the second sun gear 22s of the Ravigneaux type planetary gear mechanism 25 to and from each other. The clutch C2 connects and disconnects the input shaft 20i and the first carrier 21c of the Ravigneaux type planetary gear mechanism 25 to and from each other. The clutch C3 connects and disconnects the third carrier 23c of the third planetary gear 23 and the first sun gear 21s of the Ravigneaux type planetary gear mechanism 25 to and from each other.

The brake B1 makes the first sun gear 21s (first securable element) of the Ravigneaux type planetary gear mechanism 25 stationary with respect to (connects the first sun gear 21s to) the transmission case 11 so as to be non-rotatable, and makes the first sun gear 21s non-stationary with respect to the transmission case 11. The brake B2 makes the first carrier 21c (second securable element) of the Ravigneaux type planetary gear mechanism 25 stationary with respect to the transmission case 11 so as to be non-rotatable by making the second driven gear 29 of the second gear train G2 stationary with respect to (connecting the second driven gear 29 to) the transmission case 11 so as to be non-rotatable. The clutch C5 connects and disconnects the second driven gear 29 of the second gear train G2 and the output gear 20o (first driven gear 27) to and from each other.

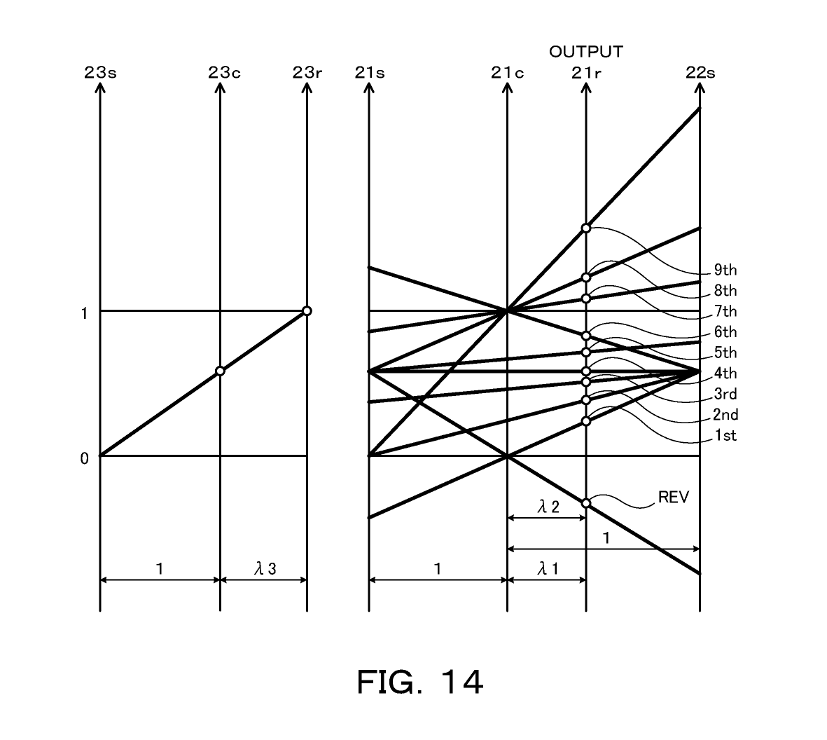

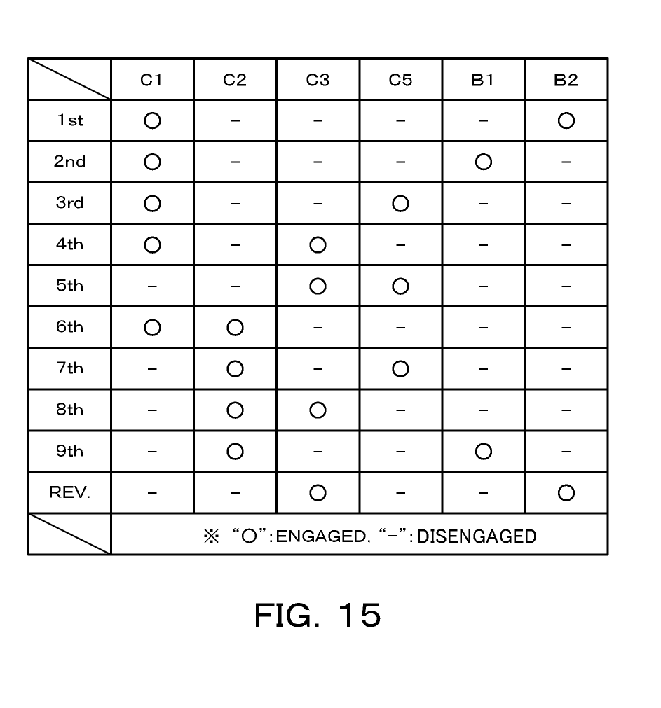

FIG. 14 is a velocity diagram illustrating the ratio of the rotational speed of each rotary element to the rotational speed of the input shaft 20i (input rotational speed) of the automatic transmission 20G (note that the rotational speed of the input shaft 20i, that is, the third ring gear 23r, is defined as a value of 1). In addition, FIG. 15 is an operation table illustrating the relationship between each shift speed of the automatic transmission 20G and the respective operating states of the clutches C1 to C3 and C5 and the brakes B1 and B2.

In the automatic transmission 20G, according to the order of arrangement on the velocity diagram illustrated in FIG. 14, the first sun gear 21s of the Ravigneaux type planetary gear mechanism 25 is defined as a first rotary element of the automatic transmission 20G, the first carrier 21c is defined as a second rotary element of the automatic transmission 20G; the first ring gear 21r is defined as a third rotary element of the automatic transmission 20G and the second sun gear 22s is defined as a fourth rotary element of the automatic transmission 20G In addition, the three rotary elements which constitute the single-pinion type third planetary gear 230, that is, the third sun gear (stationary element) 23s, the third ring gear 23r (output element), and the third carrier 23c (input element), are arranged, on the velocity diagram for the third planetary gear 230 (the velocity diagram on the left side in FIG. 14), in the order of the third sun gear 23s, the third carrier 23c, and the third ring gear 23r from the left side of the drawing at intervals that match the gear ratio. Here, according to the order of arrangement on the velocity diagram, the third sun gear 23s is defined as a fifth rotary element of the automatic transmission 20G, the third carrier 23c is defined as a sixth rotary element of the automatic transmission 20G, and the third ring gear 23r is defined as a seventh rotary element of the automatic transmission 20G.

In the automatic transmission 20G the clutches C1 to C3 and C5 and the brakes B1 and B2 are engaged and disengaged as illustrated in FIG. 15 to change the relationship of connection of the first to seventh rotary elements discussed above, which allows establishing nine power transfer paths in the forward rotational direction and one power transfer path in the reverse rotational direction from the input shaft 20i to the output gear 20o, that is, first to ninth forward speeds and a reverse speed.

Specifically, the first forward speed of the automatic transmission 20G is established by engaging the clutch C1 and the brake B2 and disengaging the remaining clutches C2, C3, and C5 and brake B1. That is, to establish the first forward speed, the third carrier 23c (sixth rotary element) of the third planetary gear 230 and the second sun gear 22s (fourth rotary element) of the Ravigneaux type planetary gear mechanism 25 are connected to each other by the clutch C1. Furthermore, the first carrier 21c (second rotary element) of the Ravigneaux type planetary gear mechanism 25 is made stationary with respect to the transmission case 11 by the brake B2 so as to be non-rotatable. The second forward speed is established by engaging the clutch C1 and the brake B1 and disengaging the remaining clutches C2, C3, and C5 and brake B2. That is, to establish the second forward speed, the third carrier 23c of the third planetary gear 230 and the second sun gear 22s of the Ravigneaux type planetary gear mechanism 25 are connected to each other by the clutch C1. Furthermore, the first sun gear 21s (first rotary element) of the Ravigneaux type planetary gear mechanism 25 is made stationary with respect to the transmission case 11 by the brake B1 so as to be non-rotatable.

The third forward speed is established by engaging the clutches C1 and C5 and disengaging the remaining clutches C2 and C3 and brakes B1 and B2. That is, to establish the third forward speed, the third carrier 23c of the third planetary gear 230 and the second sun gear 22s of the Ravigneaux type planetary gear mechanism 25 are connected to each other by the clutch C1. Furthermore, the second driven gear 29 of the second gear train G2 and the output gear 20o (first driven gear 27) are connected to each other by the clutch C5. The fourth forward speed is established by engaging the clutches C1 and C3 and disengaging the remaining clutches C2 and C5 and brakes B1 and B2. That is, to establish the fourth forward speed, the third carrier 23c of the third planetary gear 230 and the second sun gear 22s of the Ravigneaux type planetary gear mechanism 25 are connected to each other by the clutch C1. Furthermore, the third carrier 23c (sixth rotary element) of the third planetary gear 230 and the first sun gear 21s (first rotary element) of the Ravigneaux type planetary gear mechanism 25 are connected to each other by the clutch C3.

The fifth forward speed is established by engaging the clutches C3 and C5 and disengaging the remaining clutches C1 and C2 and brakes B1 and B2. That is, to establish the fifth forward speed, the third carrier 23c of the third planetary gear 230 and the first sun gear 21s of the Ravigneaux type planetary gear mechanism 25 are connected to each other by the clutch C3. Furthermore, the second driven gear 29 of the second gear train G2 and the output gear 20o (first driven gear 27) are connected to each other by the clutch C5. The sixth forward speed is established by engaging the clutches C1 and C2 and disengaging the remaining clutches C3 and C5 and brakes B1 and B2. That is, to establish the sixth forward speed, the third carrier 23c of the third planetary gear 230 and the second sun gear 22s of the Ravigneaux type planetary gear mechanism 25 are connected to each other by the clutch C1. Furthermore, the input shaft 20i and the first carrier 21c (second rotary element) of the Ravigneaux type planetary gear mechanism 25 are connected to each other by the clutch C2.

The seventh forward speed is established by engaging the clutches C2 and C5 and disengaging the remaining clutches C1 and C3 and brakes B1 and B2. That is, to establish the seventh forward speed, the input shaft 20i and the first carrier 21c of the Ravigneaux type planetary gear mechanism 25 are connected to each other by the clutch C2. Furthermore, the second driven gear 29 of the second gear train G2 and the output gear 20o (first driven gear 27) are connected to each other by the clutch C5. The eighth forward speed is established by engaging the clutches C2 and C3 and disengaging the remaining clutches C1 and C5 and brakes B1 and B2. That is, to establish the eighth forward speed, the input shaft 20i and the first carrier 21c of the Ravigneaux type planetary gear mechanism 25 are connected to each other by the clutch C2. Furthermore, the third carrier 23c of the third planetary gear 230 and the first sun gear 21s of the Ravigneaux type planetary gear mechanism 25 are connected to each other by the clutch C3.

The ninth forward speed is established by engaging the clutch C2 and the brake B1 and disengaging the remaining clutches C1, C3, and C5 and brake B2. That is, to establish the ninth forward speed, the input shaft 20i and the first carrier 21c of the Ravigneaux type planetary gear mechanism 25 are connected to each other by the clutch C2. Furthermore, the first sun gear 21s of the Ravigneaux type planetary gear mechanism 25 is made stationary with respect to the transmission case 11 by the brake B1 so as to be non-rotatable. The reverse speed is established by engaging the clutch C3 and the brake B2 and disengaging the remaining clutches C1, C2, and C5 and brake B1. That is, to establish the reverse speed, the third carrier 23c of the third planetary gear 230 and the first sun gear 21s of the Ravigneaux type planetary gear mechanism 25 are connected to each other by the clutch C3. Furthermore, the second driven gear 29 of the second gear train G2, that is, the first carrier 21c which is coupled to the second driven gear 29 via the second drive gear 28, is made stationary with respect to the transmission case 11 by the brake B2 so as to be non-rotatable.

As discussed above, with the automatic transmission 20G the first to ninth forward speeds and the reverse speed can be established by engaging and disengaging the clutches C1 to C3 and C5 and the brakes B1 and B2. With the automatic transmission 20G one of the clutches C1 to C3 and the clutch C5 are engaged to establish the third, fifth, and seventh forward speeds. When the output gear 20o is rotated with the clutch C5 engaged in this way, the first carrier 21c (one of the rotary elements), which is coupled via the second drive gear 28 to the second driven gear 29 which is rotated together with and in the same direction as the output gear 20o and the first driven gear 27, is rotated with respect to the output gear 20o at a rotational speed that matches the gear ratio gr2 of the second gear train G2 in the same direction as the output gear 20o and the first drive gear 26. When the output gear 20o is rotated with the clutch C5 engaged, in addition, the first ring gear 21r which is the output element of the Ravigneaux type planetary gear mechanism 25 is rotated with respect to the output gear 20o at a rotational speed that matches the gear ratio gr1 of the first gear train G1. Thus, by engaging one of the clutches C1 to C3 and the clutch C5, a rotational speed difference that matches the gear ratios gr1 and gr2 of the first and second gear trains G1 and G2 can be caused between the first ring gear 21r and the first carrier 21c of the Ravigneaux type planetary gear mechanism 25. Consequently, with the automatic transmission 20G it is possible to establish shift speeds other than those obtained by selectively engaging two of the clutches C1 to C3 and the brakes B1 and B2.

That is, when the clutch C5 is engaged with torque from the input shaft 20i transferred to the second sun gear 22s (fourth rotary element) of the Ravigneaux type planetary gear mechanism 25 via the third carrier 23c of the third planetary gear 23 through engagement of the clutch C1, the second driven gear 29 is rotated together with and in the same direction as the output gear 20o and the first driven gear 27, so that the speed of the first carrier 21c of the Ravigneaux type planetary gear mechanism 25 can be increased compared to the time when the second forward speed is established and the speed of the first ring gear 21r can be reduced compared to the time when the fourth forward speed is established as illustrated in FIG. 14. Consequently, it is possible to establish the third forward speed with the gear ratio γ3 which is lower than the gear ratio γ2 of the second forward speed and higher than the gear ratio γ4 of the fourth forward speed.

When the clutch C5 is engaged with torque from the input shaft 20i transferred to the first sun gear 21s (first rotary element) of the Ravigneaux type planetary gear mechanism 25 via the third carrier 23c of the third planetary gear 230 through engagement of the clutch C3, meanwhile, the second driven gear 29 is rotated together with and in the same direction as the output gear 20o and the first driven gear 27, so that the speed of the first ring gear 21r of the Ravigneaux type planetary gear mechanism 25 can be increased compared to the time when the fourth forward speed is established as illustrated in FIG. 14. Consequently, it is possible to establish the fifth forward speed with the gear ratio γ5 which is lower than the gear ratio γ4 of the fourth forward speed and higher than the gear ratio γ6 of the sixth forward speed.

When the clutch C5 is engaged with torque directly transferred from the input shaft 20i to the first carrier 21c (second rotary element) of the Ravigneaux type planetary gear mechanism 25 through engagement of the clutch C2, further, the second driven gear 29 is rotated together with and in the same direction as the output gear 20o and the first driven gear 27, so that the speed of the first ring gear 21r of the Ravigneaux type planetary gear mechanism 25 can be reduced compared to the time when the eighth forward speed is established as illustrated in FIG. 14. Consequently, it is possible to establish the seventh forward speed with the gear ratio γ7 which is lower than the gear ratio γ6 of the sixth forward speed and higher than the gear ratio γ8 of the eighth forward speed.

As discussed above, with the automatic transmission 20G in which torque from the input shaft 20i side is selectively (sequentially) transferred to the second sun gear 22s, the first sun gear 21s, and the first carrier 21c, not the first ring gear 21r (output element), of the Ravigneaux type planetary gear mechanism 25, three shift speeds (third, fifth, and seventh forward speeds) can be added to the speed change device (see JP 2010-038168 A) to which the first and second gear trains G1 and G2 and the clutch C5 have not been added. As a result, with the automatic transmission 20G, by the addition of intermediate shift speeds (third, fifth, and seventh forward speeds), it is possible to optimize the step ratios (suppress an increase in the step ratios), which improves the acceleration performance at each shift speed and the shifting feeling. Thus, with the automatic transmission 20G, it is possible to improve the drivability well along with improving the fuel efficiency of the vehicle by increasing the number of shift speeds.

With the automatic transmission 20G, in addition, it is possible to increase the number of shift speeds, while suppressing an increase in the size of the entire device or the number of components, by combining the Ravigneaux type planetary gear mechanism 25, which is a composite planetary gear mechanism with four elements, the first and second gear trains G1 and G2, and the clutch C5 with each other. With the automatic transmission 20G, further, as illustrated in FIG. 13, the brake B2 can be disposed around the axis (second shaft) of the output gear 20o. Thus, it is possible to suppress an increase in the physical size around the Ravigneaux type planetary gear mechanism 25 (in an end portion remote from the engine).

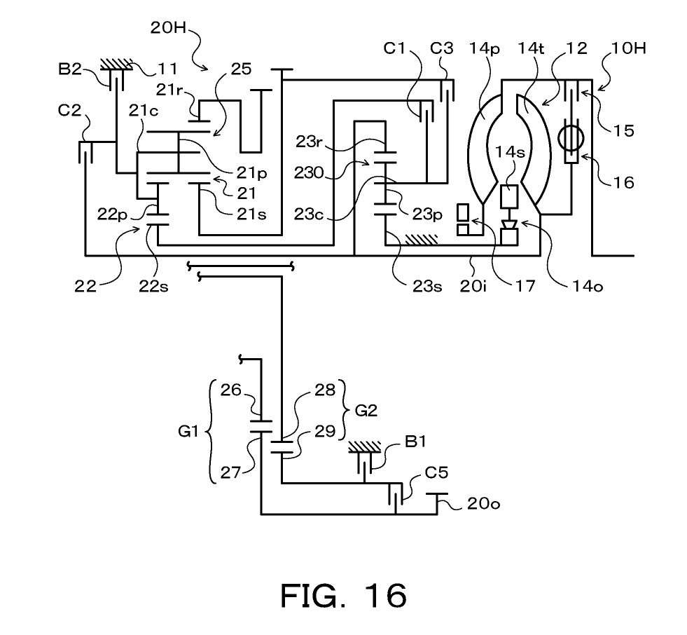

FIG. 16 is a diagram illustrating a schematic configuration of a power transfer device 10H that includes an automatic transmission 20H according to a modified aspect of the second embodiment of the present disclosure. The automatic transmission 20H illustrated in the drawing corresponds to the automatic transmission 20G discussed above, and in the automatic transmission 20H the second drive gear 28 which constitutes the second gear train G2 is always coupled coaxially with the first sun gear 21s (first rotary element) in place of the first carrier 21c (second rotary element) of the Ravigneaux type planetary gear mechanism 25. In the automatic transmission 20H, in addition, the brake B1 makes the first sun gear 21s (first securable element) of the Ravigneaux type planetary gear mechanism 25 stationary with respect to the transmission case 11 so as to be non-rotatable by connecting the second driven gear 29 of the second gear train G2 to the transmission case 11. In the automatic transmission 20H, further, the brake B2 is configured to connect the first carrier 21c (second securable element) of the Ravigneaux type planetary gear mechanism 25 to the transmission case 11, and disposed around the Ravigneaux type planetary gear mechanism 25. The thus configured automatic transmission 20H also allows obtaining functions and effects that are similar to those of the automatic transmission 20G discussed above.

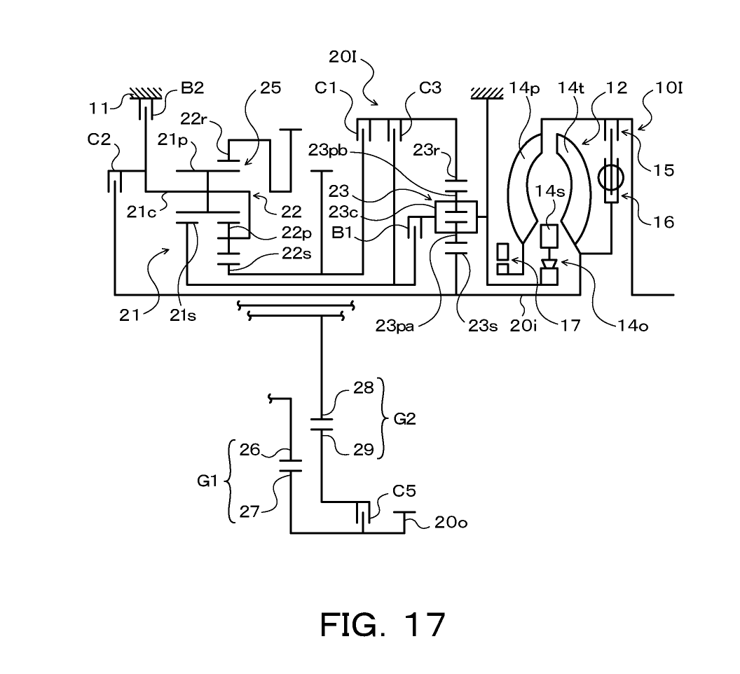

FIG. 17 is a diagram illustrating a schematic configuration of a power transfer device 10I that includes an automatic transmission 20I according to another modified aspect of the second embodiment of the present disclosure. The automatic transmission 20I illustrated in the drawing corresponds to the automatic transmission 20C discussed above (see FIG. 8), and in the automatic transmission 20I the clutch C4 has been omitted. The thus configured automatic transmission 20I also allows obtaining functions and effects that are similar to those of the automatic transmission 20G discussed above.

FIG. 18 is a diagram illustrating a schematic configuration of a power transfer device 10J that includes an automatic transmission 20J according to still another modified aspect of the second embodiment of the present disclosure. The automatic transmission 20J illustrated in the drawing corresponds to the automatic transmission 20G described above, and in the automatic transmission 20J the Ravigneaux type planetary gear mechanism 25 has been replaced with a so-called CR-CR type composite planetary gear mechanism 250 constituted by combining the single-pinion type first and second planetary gears 21 and 22 with each other. In the composite planetary gear mechanism 250, as illustrated in the drawing, the first carrier 21c of the first planetary gear 21 and the second ring gear 22r of the second planetary gear 22 are always coupled to each other, and the first ring gear 21r of the first planetary gear 21 and the second carrier 22c of the second planetary gear 22 are always coupled to each other.

Furthermore, the first drive gear (externally toothed gear) 26 of the first gear train G1 is always coupled coaxially with the first carrier 21c and the second ring gear 22r of the composite planetary gear mechanism 250. The first carrier 21c and the second ring gear 22r function as an output element of the composite planetary gear mechanism 250. In addition, the second drive gear (externally toothed gear) 28 of the second gear train G2 is always coupled coaxially with the first ring gear 21r and the second carrier 22c (second rotary element) of the composite planetary gear mechanism 250. In the example illustrated in FIG. 18, the gear ratio gr2 of the second gear train G2 is determined to be lower than the gear ratio gr1 of the first gear train G1.

In addition, the clutch C1 of the automatic transmission 20J connects and disconnects the third carrier 23c of the third planetary gear 230 and the first sun gear 21s of the composite planetary gear mechanism 250 to and from each other. The clutch C2 connects and disconnects the third ring gear 23r of the third planetary gear 230, that is, the input shaft 20i, and the first ring gear 21r and the second carrier 22c of the composite planetary gear mechanism 250 to and from each other. The clutch C3 connects and disconnects the third ring gear 23r of the third planetary gear 230, that is, the input shaft 20i, and the second sun gear 22s of the composite planetary gear mechanism 250 to and from each other. The brake B1 makes the second sun gear 22s (first securable element) of the composite planetary gear mechanism 250 stationary with respect to (connects the second sun gear 22s to) the transmission case 11 so as to be non-rotatable, and makes the second sun gear 22s non-stationary with respect to the transmission case 11. The brake B2 makes the first ring gear 21r and the second carrier 22c (second securable element) of the composite planetary gear mechanism 250 stationary with respect to the transmission case 11 so as to be non-rotatable by connecting the second driven gear 29 of the second gear train G2 to the transmission case 11. The clutch C5 connects and disconnects the second driven gear 29 of the second gear train G2 and the output gear 20o (first driven gear 27) to and from each other.

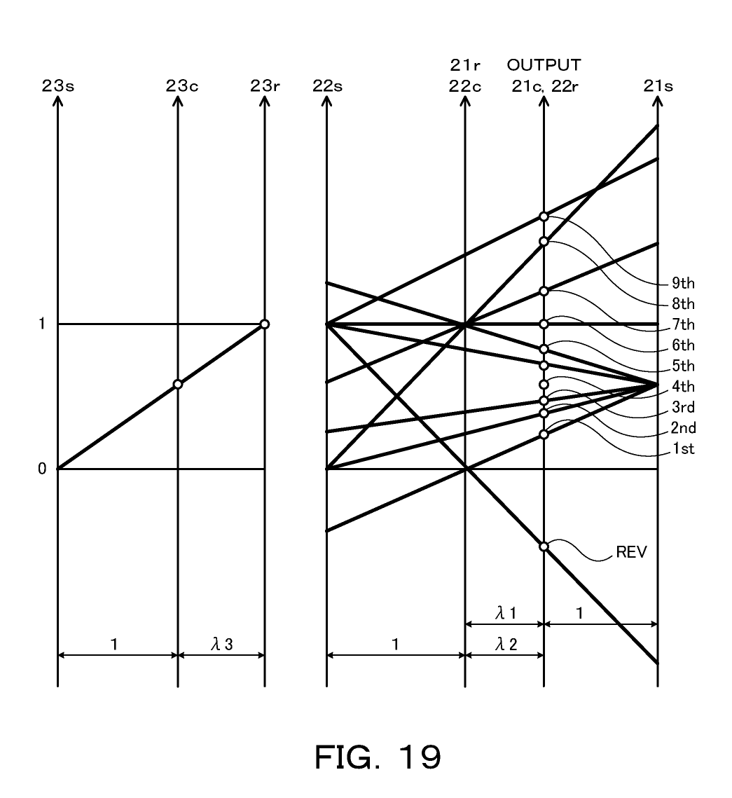

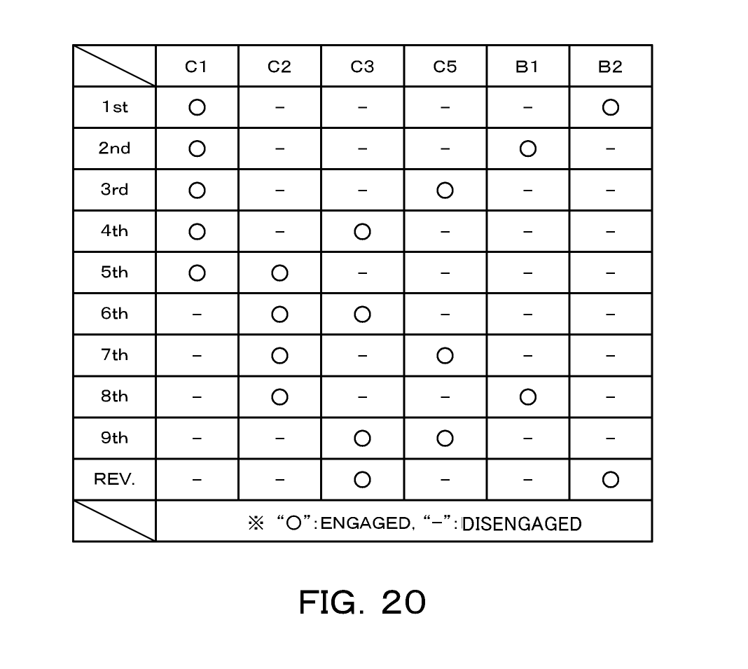

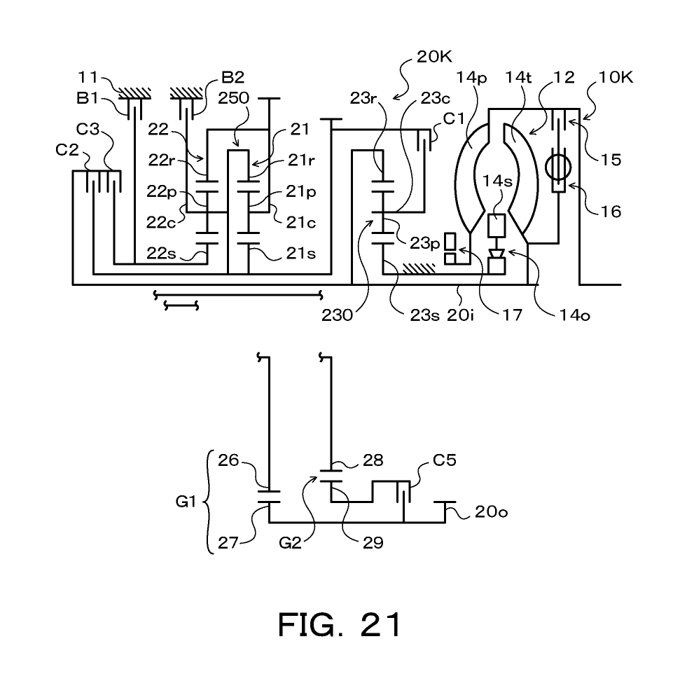

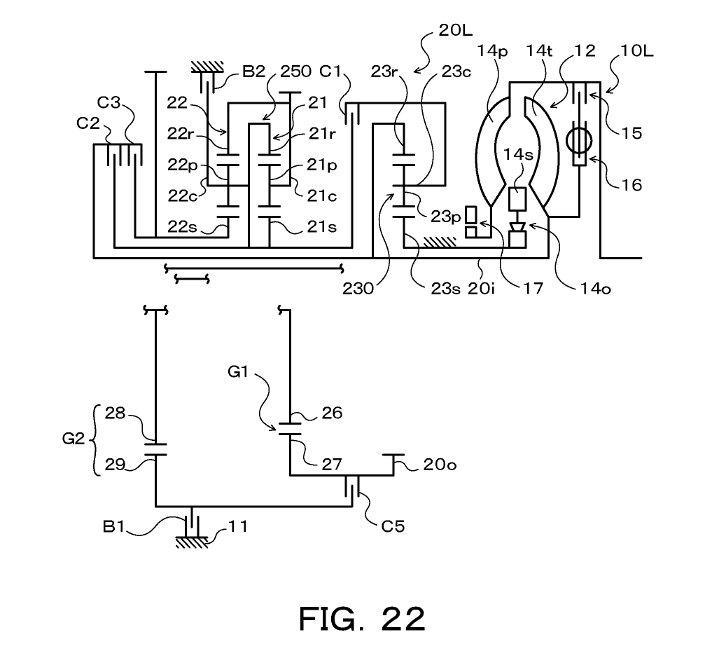

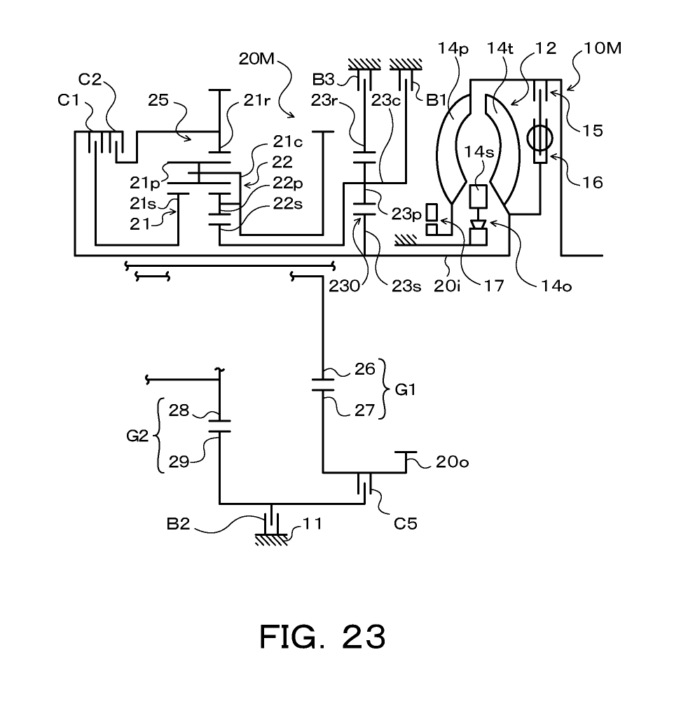

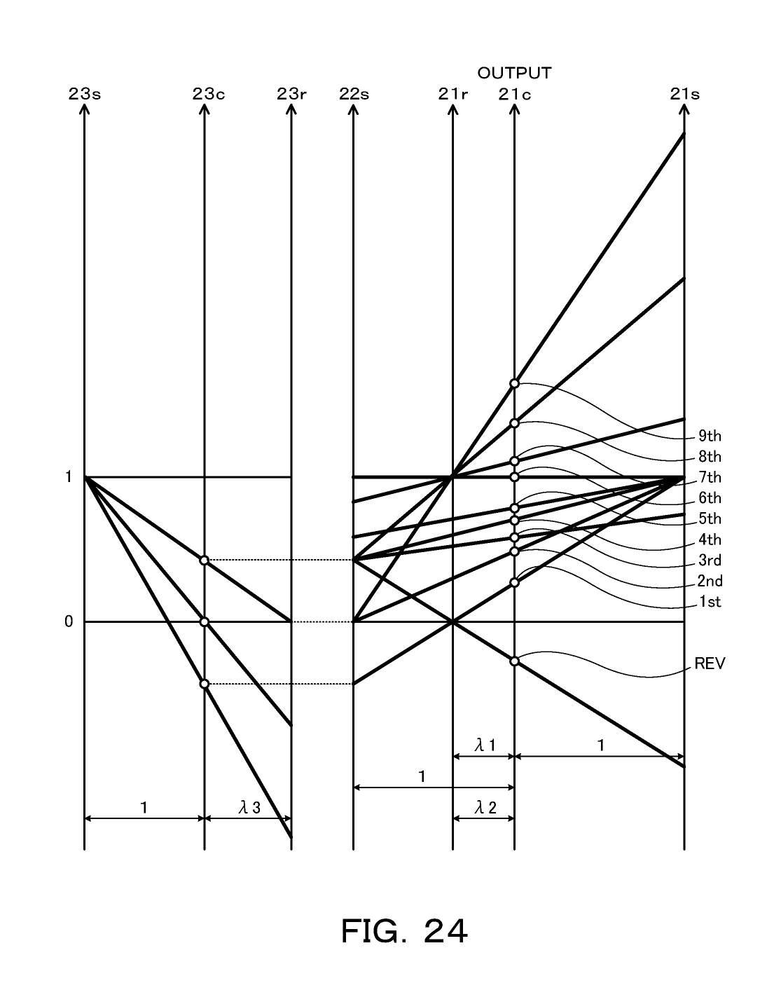

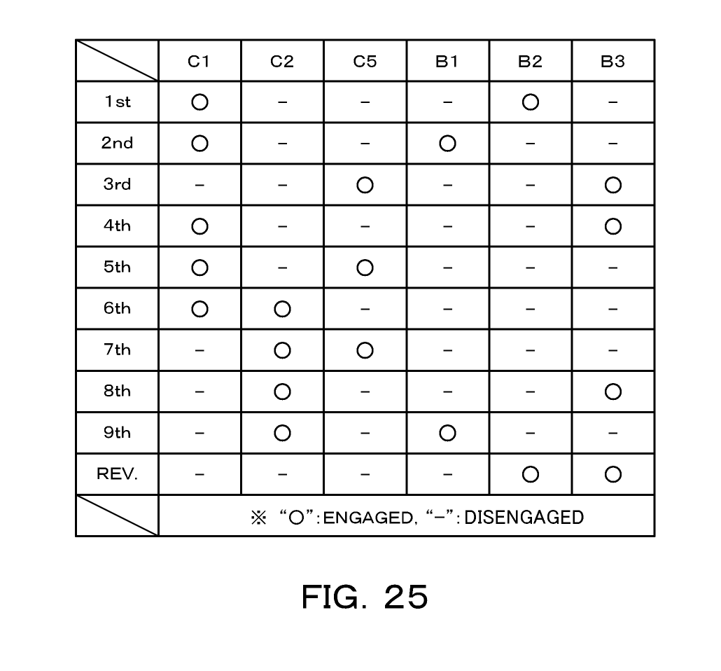

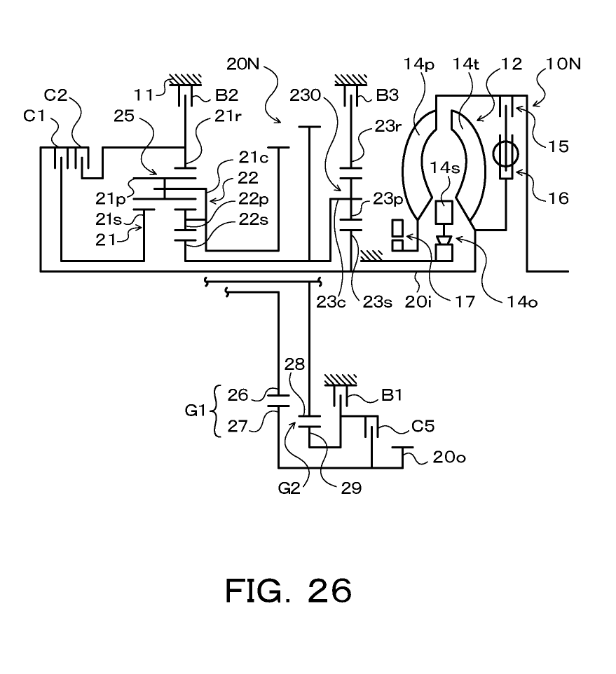

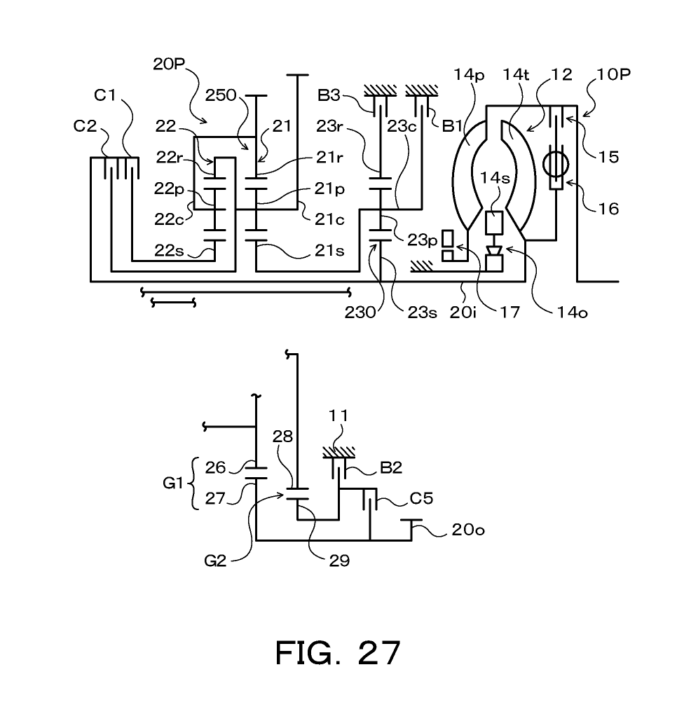

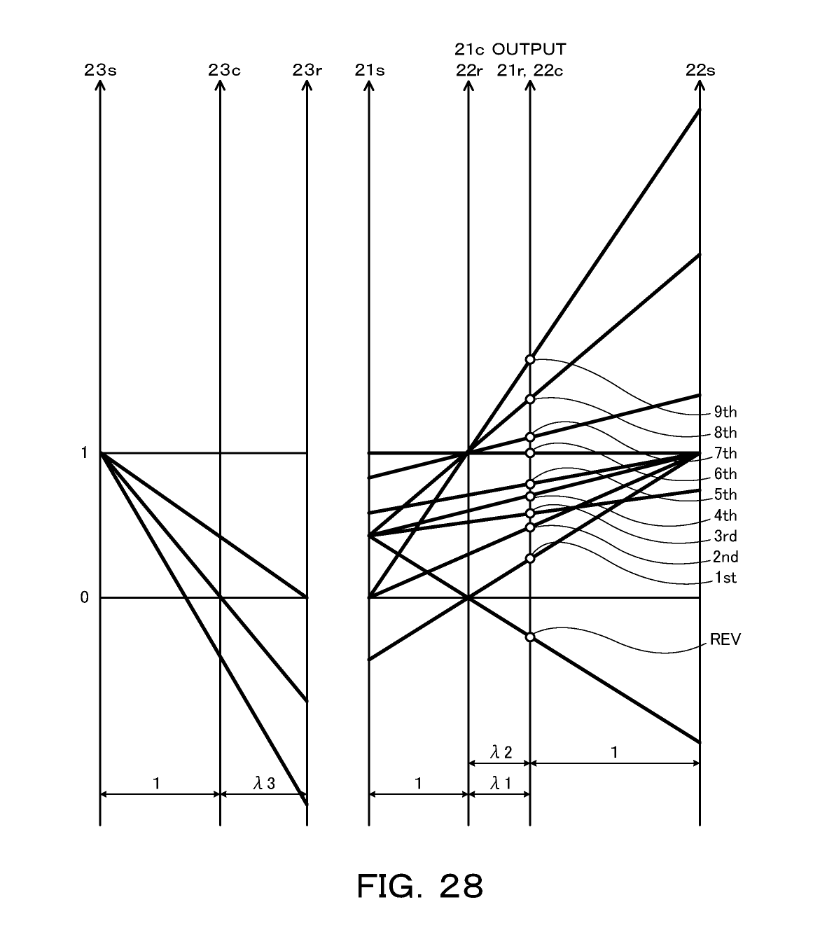

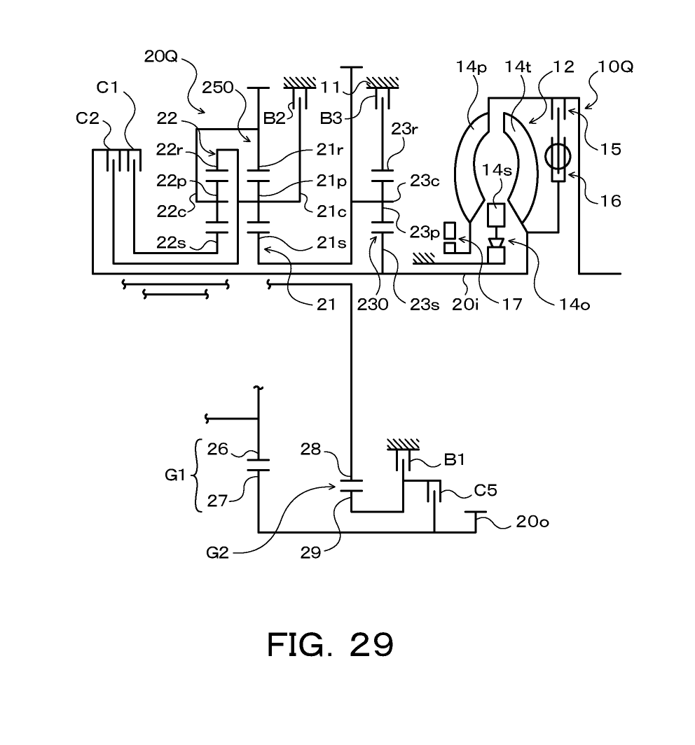

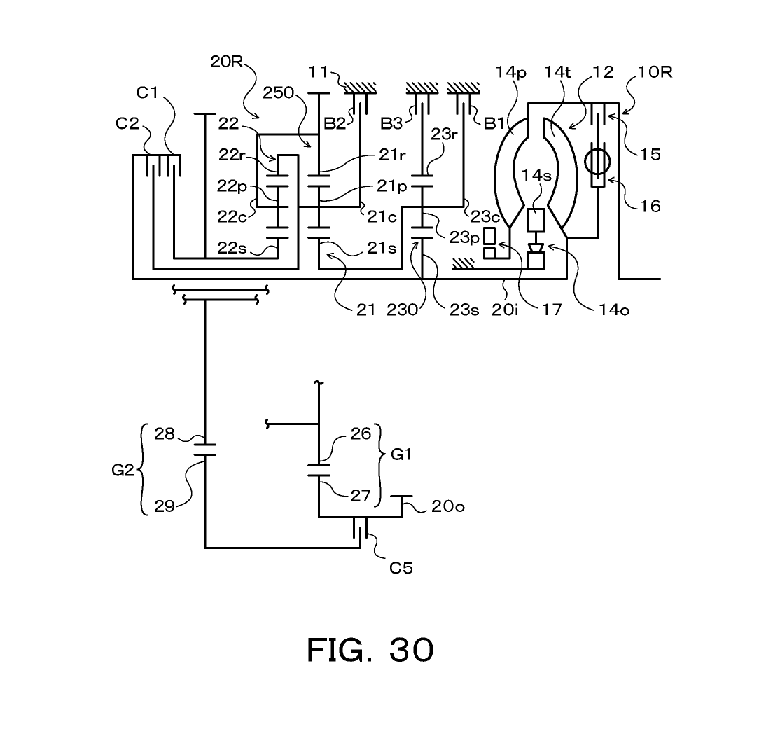

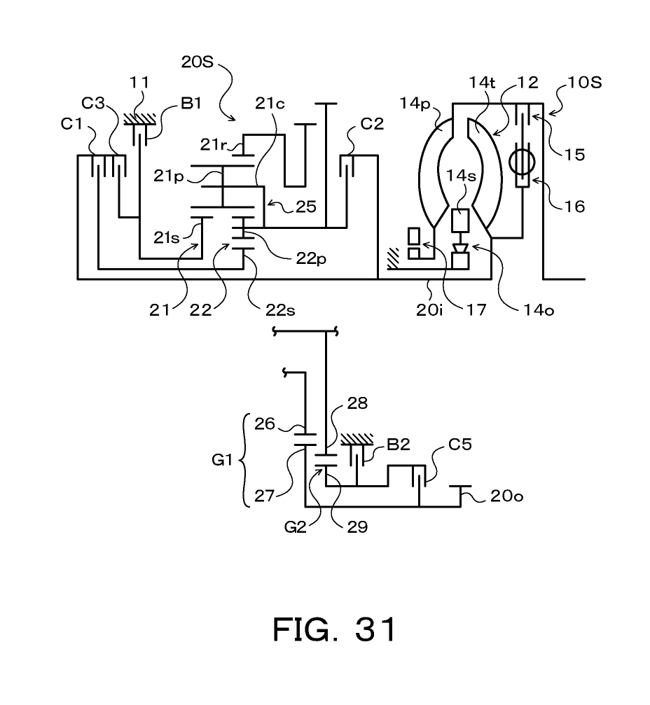

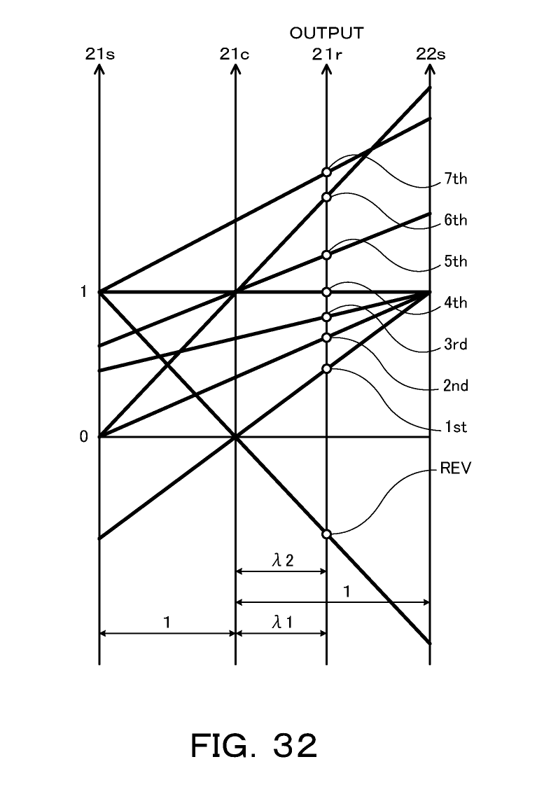

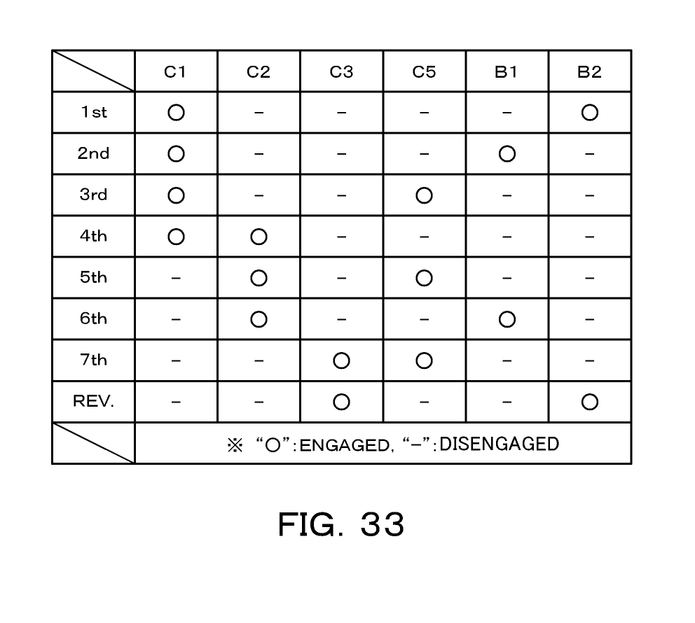

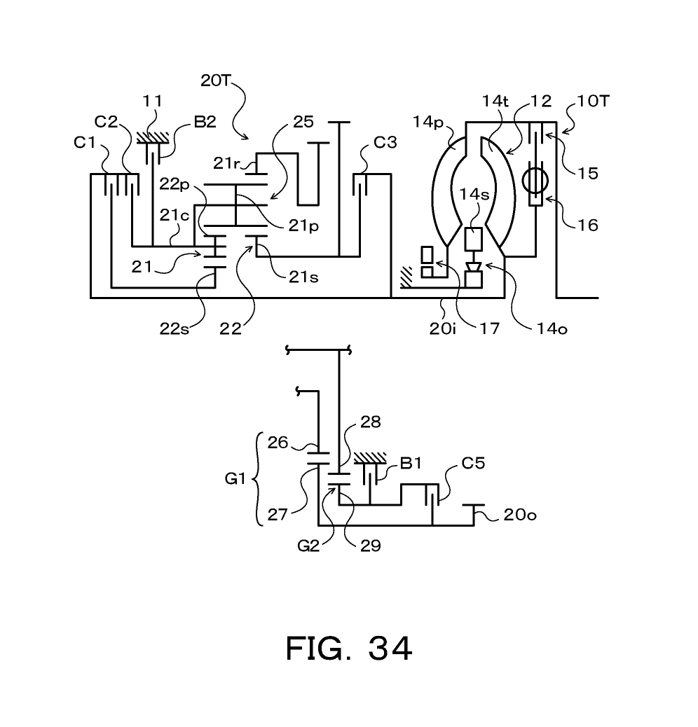

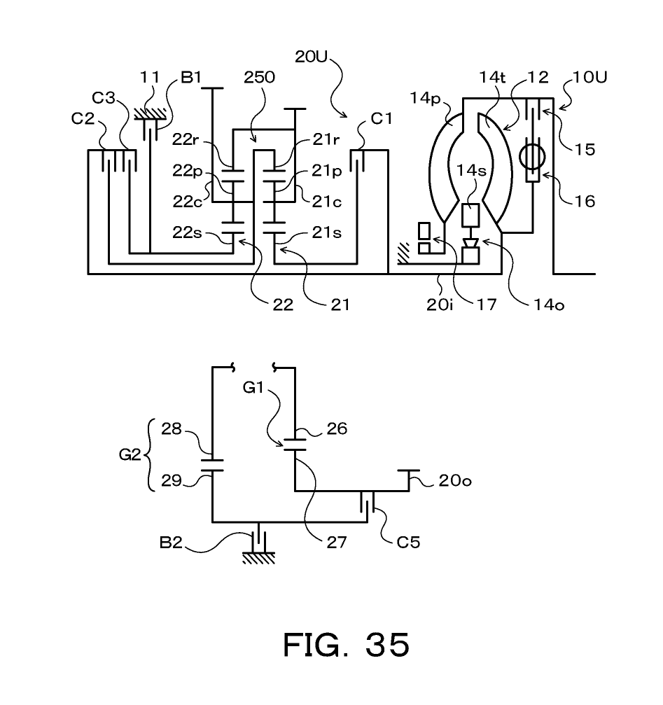

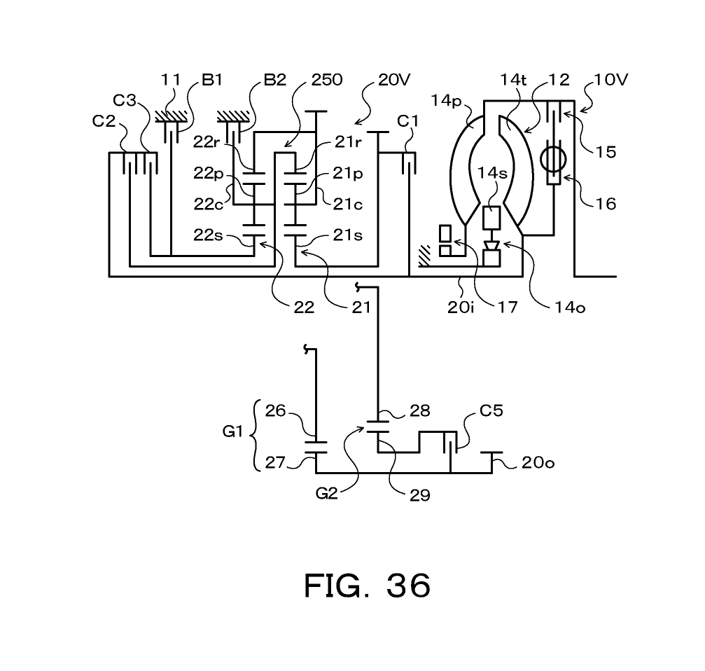

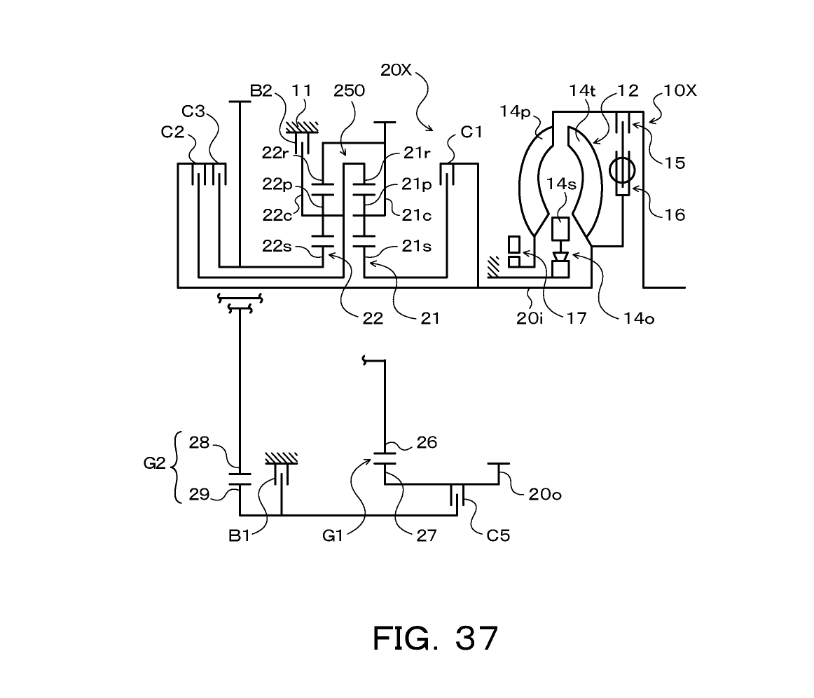

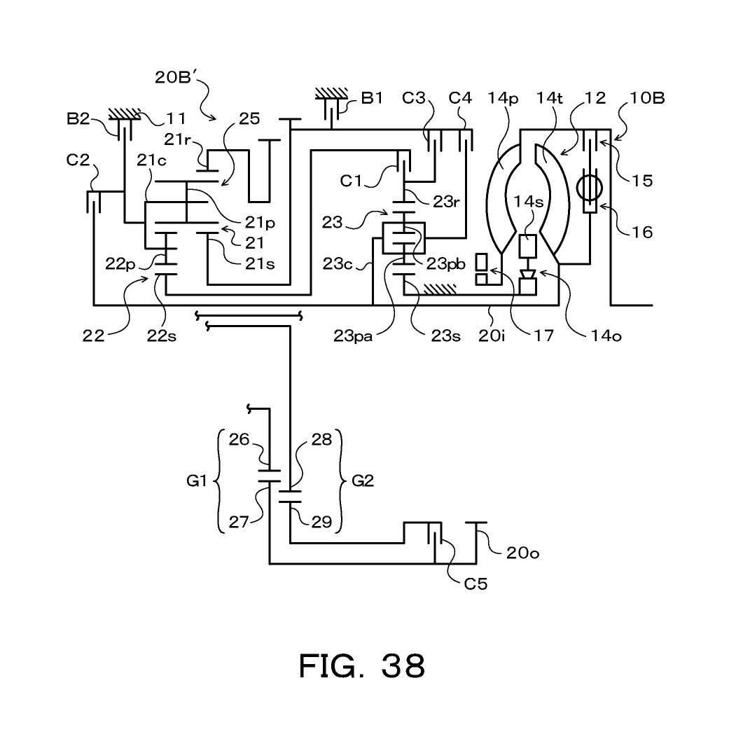

FIG. 19 is a velocity diagram illustrating the ratio of the rotational speed of each rotary element to the rotational speed of the input shaft 20i (input rotational speed) of the automatic transmission 20J (note that the rotational speed of the input shaft 20i, that is, the third ring gear 23r, is defined as a value of 1). As illustrated in the drawing, the four rotary elements which constitute the composite planetary gear mechanism 250, that is, the second sun gear 22s which serves as the first securable element, the first ring gear 21r and the second carrier 22c which are always coupled to each other and which serve as the second securable element, the first carrier 21c and the second ring gear 22r which are always coupled to each other and which serve as the output element, and the first sun gear 21s, are arranged, on the velocity diagram for the composite planetary gear mechanism 250 (the velocity diagram on the right side in FIG. 19), in the order of the second sun gear 22s, the first ring gear 21r and the second carrier 22c, the first carrier 21c and the second ring gear 22r, and the first sun gear 21s from the left side of the drawing at intervals that match the gear ratio λ1 of the first planetary gear 21 and the gear ratio λ2 of the second planetary gear 22. Here, according to the order of arrangement on the velocity diagram, the second sun gear 22s is defined as a first rotary element of the automatic transmission 20J, the first ring gear 21r and the second carrier 22c are defined as a second rotary element of the automatic transmission 20J, the first carrier 21c and the second ring gear 22r are defined as a third rotary element of the automatic transmission 20J, and the first sun gear 21s is defined as a fourth rotary element of the automatic transmission 20J. Thus, the composite planetary gear mechanism 250 has the first rotary element, the second rotary element, the third rotary element, and the fourth rotary element of the automatic transmission 20J which are arranged sequentially at intervals that match the gear ratios λ1 and λ2 on the velocity diagram.

In the automatic transmission 20J, the clutches C1 to C3 and C5 and the brakes B1 and B2 are engaged and disengaged as illustrated in FIG. 20 to change the relationship of connection of the first to seventh rotary elements discussed above, which allows establishing nine power transfer paths in the forward rotational direction and one power transfer path in the reverse rotational direction from the input shaft 20i to the output gear 20o, that is, first to ninth forward speeds and a reverse speed.

Specifically, the first forward speed of the automatic transmission 20J is established by engaging the clutch C1 and the brake B2 and disengaging the remaining clutches C2, C3, and C5 and brake B1. That is, to establish the first forward speed, the third carrier 23c (sixth rotary element) of the third planetary gear 230 and the first sun gear 21s (fourth rotary element) of the composite planetary gear mechanism 250 are connected to each other by the clutch C1. Furthermore, the first ring gear 21r and the second carrier 22c (second rotary element) of the composite planetary gear mechanism 250 are made stationary with respect to the transmission case 11 by the brake B2 so as to be non-rotatable. The second forward speed is established by engaging the clutch C1 and the brake B1 and disengaging the remaining clutches C2, C3, and C5 and brake B2. That is, to establish the second forward speed, the third carrier 23c of the third planetary gear 230 and the first sun gear 21s of the composite planetary gear mechanism 250 are connected to each other by the clutch C1. Furthermore, the second sun gear 22s (first rotary element) of the composite planetary gear mechanism 250 is made stationary with respect to the transmission case 11 by the brake B1 so as to be non-rotatable.

The third forward speed is established by engaging the clutches C1 and C5 and disengaging the remaining clutches C2 and C3 and brakes B1 and B2. That is, to establish the third forward speed, the third carrier 23c of the third planetary gear 230 and the first sun gear 21s of the composite planetary gear mechanism 250 are connected to each other by the clutch C1. Furthermore, the second driven gear 29 of the second gear train G2 and the output gear 20o (first driven gear 27) are connected to each other by the clutch C5. The fourth forward speed is established by engaging the clutches C1 and C3 and disengaging the remaining clutches C2 and C5 and brakes B1 and B2. That is, to establish the fourth forward speed, the third carrier 23c of the third planetary gear 230 and the first sun gear 21s of the composite planetary gear mechanism 250 are connected to each other by the clutch C1. Furthermore, the input shaft 20i (the third ring gear 23r of the third planetary gear 230) and the second sun gear 22s (first rotary element) of the composite planetary gear mechanism 250 are connected to each other by the clutch C3.

The fifth forward speed is established by engaging the clutches C1 and C2 and disengaging the remaining clutches C3 and C5 and brakes B1 and B2. That is, to establish the fifth forward speed, the third carrier 23c of the third planetary gear 230 and the first sun gear 21s of the composite planetary gear mechanism 250 are connected to each other by the clutch C1. Furthermore, the input shaft 20i (third ring gear 23r) and the first ring gear 21r and the second carrier 22c (second rotary element) of the composite planetary gear mechanism 250 are connected to each other by the clutch C2. The sixth forward speed is established by engaging the clutches C2 and C3 and disengaging the remaining clutches C1 and C5 and brakes B1 and B2. That is, to establish the sixth forward speed, the input shaft 20i (third ring gear 23r) and the first ring gear 21r and the second carrier 22c of the composite planetary gear mechanism 250 are connected to each other by the clutch C2. Furthermore, the input shaft 20i (third ring gear 23r)) and the second sun gear 22s (first rotary element) of the composite planetary gear mechanism 250 are connected to each other by the clutch C3.

The seventh forward speed is established by engaging the clutches C2 and C5 and disengaging the remaining clutches C1 and C3 and brakes B1 and B2. That is, to establish the seventh forward speed, the input shaft 20i (third ring gear 23r) and the first ring gear 21r and the second carrier 22c of the composite planetary gear mechanism 250 are connected to each other by the clutch C2. Furthermore, the second driven gear 29 of the second gear train G2 and the output gear 20o (first driven gear 27) are connected to each other by the clutch C5. The eighth forward speed is established by engaging the clutch C2 and the brake B1 and disengaging the remaining clutches C1, C3, and C5 and brake B2. That is, to establish the eighth forward speed, the input shaft 20i (third ring gear 23r) and the first ring gear 21r and the second carrier 22c of the composite planetary gear mechanism 250 are connected to each other by the clutch C2. Furthermore, the second sun gear 22s of the composite planetary gear mechanism 250 is made stationary with respect to the transmission case 11 by the brake B1 so as to be non-rotatable.

The ninth forward speed is established by engaging the clutches C3 and C5 and disengaging the remaining clutches C1 and C2 and brakes B1 and B2. That is, to establish the ninth forward speed, the input shaft 20i (third ring gear 23r) and the second sun gear 22s of the composite planetary gear mechanism 250 are connected to each other by the clutch C3. Furthermore, the second driven gear 29 of the second gear train G2 and the output gear 20o (first driven gear 27) are connected to each other by the clutch C5. The reverse speed is established by engaging the clutch C3 and the brake B2 and disengaging the remaining clutches C1, C2, and C5 and brake B1. That is, to establish the reverse speed, the input shaft 20i (third ring gear 23r) and the second sun gear 22s of the composite planetary gear mechanism 250 are connected to each other by the clutch C3. Furthermore, the first ring gear 21r and the second carrier 22c of the composite planetary gear mechanism 250 are made stationary with respect to the transmission case 11 by the brake B2 so as to be non-rotatable.

As discussed above, also with the automatic transmission 20J, the first to ninth forward speeds and the reverse speed can be established by engaging and disengaging the clutches C1 to C3 and C5 and the brakes B1 and B2. That is, also with the automatic transmission 20J, three shift speeds (third, seventh, and ninth forward speeds) can be added to the speed change device (see JP 2010-038168 A) to which the first and second gear trains G1 and G2 and the clutch C5 have not been added. As a result, with the automatic transmission 20J, the spread can be further increased by the addition of the ninth forward speed as the highest shift speed to improve the fuel efficiency of the vehicle at a high vehicle speed and the acceleration performance at each shift speed, in particular. By the addition of intermediate shift speeds (third and seventh forward speeds), further, the step ratios can be optimized (an increase in the step ratios can be suppressed) to improve the shifting feeling. Thus, also with the automatic transmission 20J, it is possible to improve both the fuel efficiency and the drivability of the vehicle well. In addition, by adopting the CR-CR type composite planetary gear mechanism 250 which is constituted by combining the single-pinion type first and second planetary gears 21 and 22 with each other, it is possible to further improve the power transfer efficiency of the automatic transmission 20J by reducing a meshing loss between the rotary elements of the composite planetary gear mechanism 250, and to improve the assemblability while suppressing an increase in the weight of the entire device by reducing the number of components.

FIG. 21 is a diagram illustrating a schematic configuration of a power transfer device 10K that includes an automatic transmission 20K according to another modified aspect of the second embodiment of the present disclosure. In the automatic transmission 20K illustrated in the drawing, the second drive gear 28 which constitutes the second gear train G2 is always coupled coaxially with the first sun gear 21s of the composite planetary gear mechanism 250 which is a fourth rotary element of the automatic transmission 20K. In the example illustrated in FIG. 21, the gear ratio gr2 of the second gear train G2 is determined to be higher than the gear ratio gr1 of the first gear train G1. In the automatic transmission 20K, in addition, the brake B2 is configured to connect the first ring gear 21r and the second carrier 22c (second securable element) of the composite planetary gear mechanism 250 to the transmission case 11, and disposed around the composite planetary gear mechanism 250. The thus configured automatic transmission 20K also allows obtaining functions and effects that are similar to those of the automatic transmission 20J discussed above.

FIG. 22 is a diagram illustrating a schematic configuration of a power transfer device 10L that includes an automatic transmission 20L according to still another modified aspect of the second embodiment of the present disclosure. In the automatic transmission 20L illustrated in the drawing, the second drive gear 28 which constitutes the second gear train G2 is always coupled coaxially with the second sun gear 22s of the composite planetary gear mechanism 250 which is a first rotary element of the automatic transmission 20L. In the example illustrated in FIG. 22, the gear ratio gr2 of the second gear train G2 is determined to be lower than the gear ratio gr1 of the first gear train G1. In the automatic transmission 20L, in addition, the brake B1 makes the second sun gear 22s (first securable element) of the composite planetary gear mechanism 250 stationary with respect to the transmission case 11 so as to be non-rotatable by connecting the second driven gear 29 of the second gear train G2 to the transmission case 11. Furthermore, the brake B2 is configured to connect the first ring gear 21r and the second carrier 22c (second securable element) of the composite planetary gear mechanism 250 to the transmission case 11, and disposed around the composite planetary gear mechanism 250. The thus configured automatic transmission 20L also allows obtaining functions and effects that are similar to those of the automatic transmission 20J discussed above.

FIG. 23 is a diagram illustrating a schematic configuration of a power transfer device 10M that includes an automatic transmission 20M according to another modified aspect of the second embodiment of the present disclosure. The automatic transmission 20M illustrated in the drawing includes a Ravigneaux type planetary gear mechanism 25 which serves as a composite planetary gear mechanism constituted by combining a single-pinion type first planetary gear 21 and a double-pinion type second planetary gear 22 with each other, and a single-pinion type third planetary gear 230. In the example illustrated in FIG. 23, the first and second planetary gears 21 and 22, which constitute the Ravigneaux type planetary gear mechanism 25, and the third planetary gear 23 are disposed in the transmission case 11 so as to be arranged in the order of the third planetary gear 23, the second planetary gear 22, and the first planetary gear 21 from the starting device 12 side, that is, the engine side (the right side in FIG. 1).

As illustrated in the drawing, the first drive gear (externally toothed gear) 26 of the first gear train G1 is always coupled coaxially with the first carrier 21c of the Ravigneaux type planetary gear mechanism 25. The first carrier 21c functions as an output element of the Ravigneaux type planetary gear mechanism 25. Furthermore, the second drive gear (externally toothed gear) 28 of the second gear train G2 is always coupled coaxially with the first ring gear 21r (second rotary element) of the Ravigneaux type planetary gear mechanism 25. In the example illustrated in FIG. 23, the gear ratio gr2 of the second gear train G2 is determined to be lower than the gear ratio gr1 of the first gear train G1. In addition, the third sun gear 23s of the third planetary gear 230 is always coupled to the input shaft 20i, and always rotated and stopped together with the input shaft 20i.

Furthermore, the automatic transmission 20M includes a clutch C1 (third engagement element), a clutch C2 (fourth engagement element), a brake B1 (first engagement element), a brake B2 (second engagement element), a brake B3 (fifth engagement element), and a clutch C5 (output-side engagement element), all of which are used to change a power transfer path from the input shaft 20i to the output gear 20o.

The clutch C1 connects and disconnects the input shaft 20i (third sun gear 23s) and the first sun gear 21s of the Ravigneaux type planetary gear mechanism 25 to and from each other. The clutch C2 connects and disconnects the input shaft 20i (third sun gear 23s) and the first ring gear 21r of the Ravigneaux type planetary gear mechanism 25 to and from each other. The brake B1 makes the third carrier 23c of the third planetary gear 230 and the second sun gear 22s (first securable element) of the Ravigneaux type planetary gear mechanism 25 stationary with respect to (connects the third carrier 23c and the second sun gear 22s to) the transmission case 11 so as to be non-rotatable, and makes the third carrier 23c and the second sun gear 22s non-stationary with respect to the transmission case 11. The brake B2 makes the first ring gear 21r (second securable element) of the Ravigneaux type planetary gear mechanism 25 stationary with respect to the transmission case 11 by connecting the second driven gear 29 of the second gear train G2 to the transmission case 11. The brake B3 makes the third ring gear 23r of the third planetary gear 230 stationary with respect to (connects the third ring gear 23r to) the transmission case 11 so as to be non-rotatable, and makes the third ring gear 23r non-stationary with respect to the transmission case 11. The clutch C5 connects and disconnects the second driven gear 29 of the second gear train G2 and the output gear 20o (first driven gear 27) to and from each other.

In the automatic transmission 20M, according to the order of arrangement on the velocity diagram illustrated in FIG. 24, the second sun gear 22s of the Ravigneaux type planetary gear mechanism 25 is defined as a first rotary element of the automatic transmission 20M, the first ring gear 21r is defined as a second rotary element of the automatic transmission 20M, the first carrier 21c is defined as a third rotary element of the automatic transmission 20M, and the first sun gear 21s is defined as a fourth rotary element of the automatic transmission 20M. In addition, the third sun gear 23s is defined as a fifth rotary element of the automatic transmission 20M, the third carrier 23c is defined as a sixth rotary element of the automatic transmission 20M, and the third ring gear 23r is defined as a seventh rotary element of the automatic transmission 20M.

In the automatic transmission 20M, the clutches C1, C2, and C5 and the brakes B1, B2, and B3 are engaged and disengaged as illustrated in FIG. 25 to change the relationship of connection of the first to seventh rotary elements discussed above, which allows establishing nine power transfer paths in the forward rotational direction and one power transfer path in the reverse rotational direction from the input shaft 20i to the output gear 20o, that is, first to ninth forward speeds and a reverse speed.

Specifically, the first forward speed of the automatic transmission 20M is established by engaging the clutch C1 and the brake B2 and disengaging the remaining clutches C2, and C5 and brakes B1 and B3. That is, to establish the first forward speed, the input shaft 20i (third sun gear 23s) and the first sun gear 21s (fourth rotary element) of the Ravigneaux type planetary gear mechanism 25 are connected to each other by the clutch C1. Furthermore, the first ring gear 21r (second rotary element) of the Ravigneaux type planetary gear mechanism 25 is made stationary with respect to the transmission case 11 by the brake B2 so as to be non-rotatable. The second forward speed is established by engaging the clutch C1 and the brake B1 and disengaging the remaining clutches C2, and C5 and brakes B2 and B3. That is, to establish the second forward speed, the input shaft 20i (third sun gear 23s) and the first sun gear 21s of the Ravigneaux type planetary gear mechanism 25 are connected to each other by the clutch C1. Furthermore, the third carrier 23c of the third planetary gear 230 and the second sun gear 22s of the Ravigneaux type planetary gear mechanism 25 (first and sixth rotary elements) are made stationary with respect to the transmission case 11 by the brake B1 so as to be non-rotatable.

The third forward speed is established by engaging the clutch C5 and the brake B3 and disengaging the remaining clutches C1 and C2 and brakes B1 and B2. That is, to establish the third forward speed, the second driven gear 29 of the second gear train G2 and the output gear 20o (first driven gear 27) are connected to each other by the clutch C5. Furthermore, the third ring gear 23r (seventh rotary element) of the third planetary gear 230 is made stationary with respect to the transmission case 11 by the brake B3 so as to be non-rotatable. The fourth forward speed is established by engaging the clutch C1 and the brake B3 and disengaging the remaining clutches C2 and C5 and brakes B1 and B2. That is, to establish the fourth forward speed, the input shaft 20i (third sun gear 23s) and the first sun gear 21s of the Ravigneaux type planetary gear mechanism 25 are connected to each other by the clutch C1. Furthermore, the third ring gear 23r of the third planetary gear 230 is made stationary with respect to the transmission case 11 by the brake B3 so as to be non-rotatable.

The fifth forward speed is established by engaging the clutches C1 and C5 and disengaging the remaining clutch C2 and brakes B1, B2, and B3. That is, to establish the fifth forward speed, the input shaft 20i (third sun gear 23s) and the first sun gear 21s of the Ravigneaux type planetary gear mechanism 25 are connected to each other by the clutch C1. Furthermore, the second driven gear 29 of the second gear train G2 and the output gear 20o (first driven gear 27) are connected to each other by the clutch C5. The sixth forward speed is established by engaging the clutches C1 and C2 and disengaging the remaining clutch C5 and brakes B1, B2, and B3. That is, to establish the sixth forward speed, the input shaft 20i (third sun gear 23s) and the first sun gear 21s of the Ravigneaux type planetary gear mechanism 25 are connected to each other by the clutch C1. Furthermore, the input shaft 20i (third sun gear 23s) and the first ring gear 21r (second rotary element) of the Ravigneaux type planetary gear mechanism 25 are connected to each other by the clutch C2.

The seventh forward speed is established by engaging the clutches C2 and C5 and disengaging the remaining clutch C1 and brakes B1, B2, and B3. The input shaft 20i (third sun gear 23s) and the first ring gear 21r of the Ravigneaux type planetary gear mechanism 25 are connected to each other by the clutch C2. Furthermore, the second driven gear 29 of the second gear train G2 and the output gear 20o (first driven gear 27) are connected to each other by the clutch C5. The eighth forward speed is established by engaging the clutch C2 and the brake B3 and disengaging the remaining clutches C1 and C5 and brakes B1 and B2. That is, to establish the eighth forward speed, the input shaft 20i (third sun gear 23s) and the first ring gear 21r of the Ravigneaux type planetary gear mechanism 25 are connected to each other by the clutch C2. Furthermore, the third ring gear 23r of the third planetary gear 230 is made stationary with respect to the transmission case 11 by the brake B3 so as to be non-rotatable.

The ninth forward speed is established by engaging the clutch C2 and the brake B1 and disengaging the remaining clutches C1 and C5 and brakes B2 and B3. That is, to establish the ninth forward speed, the input shaft 20i (third sun gear 23s) and the first ring gear 21r of the Ravigneaux type planetary gear mechanism 25 are connected to each other by the clutch C2. Furthermore, the third carrier 23c of the third planetary gear 230 and the second sun gear 22s of the Ravigneaux type planetary gear mechanism 25 are made stationary with respect to the transmission case 11 by the brake B1 so as to be non-rotatable. The reverse speed is established by engaging the brakes B2 and B3 and disengaging the remaining clutches C1, C2, and C5 and brake B1. That is, to establish the reverse speed, the first ring gear 21r of the Ravigneaux type planetary gear mechanism 25 is made stationary with respect to the transmission case 11 by the brake B2 so as to be non-rotatable. Furthermore, the third ring gear 23r of the third planetary gear 230 is made stationary with respect to the transmission case 11 by the brake B3 so as to be non-rotatable.

As discussed above, with the automatic transmission 20M, the first to ninth forward speeds and the reverse speed can be established by engaging and disengaging the clutches C1, C2, and C5 and the brakes B1, B2, and B3. With the automatic transmission 20M, one of the clutch C1, the clutch C2, and the brake B3 and the clutch C5 are engaged to establish the third, fifth, and seventh forward speeds. When the output gear 20o is rotated with the clutch C5 engaged in this way, the first ring gear 21r (one of the rotary elements), which is coupled via the second drive gear 28 to the second driven gear 29 which is rotated together with and in the same direction as the output gear 20o and the first driven gear 27, is rotated with respect to the output gear 20o at a rotational speed that matches the gear ratio gr2 of the second gear train G2. When the output gear 20o is rotated with the clutch C5 engaged, in addition, the first carrier 21c which is the output element of the Ravigneaux type planetary gear mechanism 25 is rotated with respect to the output gear 20o at a rotational speed that matches the gear ratio gr1 of the first gear train G1. Thus, by engaging one of the clutch C1, the clutch C2, and the brake B3 and the clutch C5, a rotational speed difference that matches the gear ratios gr1 and gr2 of the first and second gear trains G1 and G2 can be caused between the first ring gear 21r and the first carrier 21c of the Ravigneaux type planetary gear mechanism 25. Consequently, also with the automatic transmission 20M, it is possible to establish shift speeds other than those obtained by selectively engaging two of the clutches C1 and C2 and the brakes B1, B2, and B3.

That is, when the clutch C5 is engaged with torque from the input shaft 20i transferred to the second sun gear 22s (first rotary element) of the Ravigneaux type planetary gear mechanism 25 via the third carrier 23c (sixth rotary element) of the third planetary gear 230 through engagement of the brake B3, the second driven gear 29 is rotated together with and in the same direction as the output gear 20o and the first driven gear 27 so that the speed of the first carrier 21c of the Ravigneaux type planetary gear mechanism 25 can be reduced compared to the time when the fourth forward speed is established as illustrated in FIG. 24. Consequently, it is possible to establish the third forward speed with the gear ratio γ3 which is lower than the gear ratio γ2 of the second forward speed and higher than the gear ratio γ4 of the fourth forward speed.

When the clutch C5 is engaged with torque from the input shaft 20i directly transferred from the input shaft 20i to the first sun gear 21s (fourth rotary element) of the Ravigneaux type planetary gear mechanism 25 through engagement of the clutch C1, meanwhile, the second driven gear 29 is rotated together with and in the same direction as the output gear 20o and the first driven gear 27 so that the speed of the first ring gear 21r of the Ravigneaux type planetary gear mechanism 25 can be increased compared to the time when the fourth forward speed is established and the speed of the first carrier 21c can be reduced compared to the time when the sixth forward speed is established as illustrated in FIG. 24. Consequently, it is possible to establish the fifth forward speed with the gear ratio γ5 which is lower than the gear ratio γ4 of the fourth forward speed and higher than the gear ratio γ6 of the sixth forward speed.

When the clutch C5 is engaged with torque directly transferred from the input shaft 20i to the first ring gear 21r (second rotary element) of the Ravigneaux type planetary gear mechanism 25 through engagement of the clutch C2, further, the second driven gear 29 is rotated together with and in the same direction as the output gear 20o and the first driven gear 27 so that the speed of the first carrier 21c of the Ravigneaux type planetary gear mechanism 25 can be reduced compared to the time when the eighth forward speed is established as illustrated in FIG. 24. Consequently, it is possible to establish the seventh forward speed with the gear ratio γ7 which is lower than the gear ratio γ6 of the sixth forward speed and higher than the gear ratio γ8 of the eighth forward speed.

As discussed above, with the automatic transmission 20M in which torque from the input shaft 20i side is selectively (sequentially) transferred to the second sun gear 22s, the first sun gear 21s, and the first ring gear 21r, not the first carrier 21c (output element), of the Ravigneaux type planetary gear mechanism 25, three shift speeds (third, fifth, and seventh forward speeds) can be added to the speed change device to which the first and second gear trains G1 and G2 and the clutch C5 have not been added. As a result, with the automatic transmission 20M, by the addition of intermediate shift speeds (third, fifth, and seventh forward speeds), it is possible to optimize the step ratios (suppress an increase in the step ratios), which improves the acceleration performance at each shift speed and the shifting feeling. Thus, also with the automatic transmission 20M, it is possible to improve the drivability well along with improving the fuel efficiency of the vehicle by increasing the number of shift speeds.

The automatic transmission 20M also allows increasing the number of shift speeds, while suppressing an increase in the size of the entire device or the number of components, by combining the Ravigneaux type planetary gear mechanism 25, which is a composite planetary gear mechanism with four elements, the first and second gear trains G1 and G2, and the clutch C5 with each other. Also with the automatic transmission 20M, further, as illustrated in FIG. 23, the brake B2 can be disposed around the axis (second shaft) of the output gear 20o. Thus, it is possible to suppress an increase in the physical size around the Ravigneaux type planetary gear mechanism 25 (in an end portion remote from the engine).

FIG. 26 is a diagram illustrating a schematic configuration of a power transfer device 10N that includes an automatic transmission 20N according to still another modified aspect of the second embodiment of the present disclosure. The automatic transmission 20N illustrated in the drawing corresponds to the automatic transmission 20M discussed above, and in the automatic transmission 20N the second drive gear 28 which constitutes the second gear train G2 is always coupled coaxially with the second sun gear 22s (first rotary element) in place of the first ring gear 21r (second rotary element) of the Ravigneaux type planetary gear mechanism 25. In the automatic transmission 20N, in addition, the brake B1 makes the second sun gear 22s (first securable element) of the Ravigneaux type planetary gear mechanism 25 stationary with respect to the transmission case 11 so as to be non-rotatable by connecting the second driven gear 29 of the second gear train G2 to the transmission case 11. Furthermore, the brake B2 is configured to connect the first ring gear 21r (second securable element) of the Ravigneaux type planetary gear mechanism 25 to the transmission case 11, and disposed around the Ravigneaux type planetary gear mechanism 25. The thus configured automatic transmission 20N also allows obtaining functions and effects that are similar to those of the automatic transmission 20M discussed above.

FIG. 27 is a diagram illustrating a schematic configuration of a power transfer device 10P that includes an automatic transmission 20P according to another modified aspect of the second embodiment of the present disclosure. The automatic transmission 20P illustrated in the drawing corresponds to the automatic transmission 20M described above, and in the automatic transmission 20P the Ravigneaux type planetary gear mechanism 25 has been replaced with a CR-CR type composite planetary gear mechanism 250 constituted by combining the single-pinion type first and second planetary gears 21 and 22 with each other. As illustrated in the drawing, the first drive gear (externally toothed gear) 26 of the first gear train G1 is always coupled coaxially with the first ring gear 21r and the second carrier 22c of the composite planetary gear mechanism 250. The first ring gear 21r and the second carrier 22c function as an output element of the composite planetary gear mechanism 250. In addition, the second drive gear (externally toothed gear) 28 of the second gear train G2 is always coupled coaxially with the first carrier 21c and the second ring gear 22r (second rotary element) of the composite planetary gear mechanism 250. In the example illustrated in FIG. 27, the gear ratio gr2 of the second gear train G2 is determined to be lower than the gear ratio gr1 of the first gear train G1.

In addition, the clutch C1 of the automatic transmission 20P connects and disconnects the input shaft 20i (third sun gear 23s) and the second sun gear 22s (fourth rotary element) of the composite planetary gear mechanism 250 to and from each other. The clutch C2 connects and disconnects the input shaft 20i (third sun gear 23s) and the first carrier 21c and the second ring gear 22r (second rotary element) of the composite planetary gear mechanism 250 to and from each other. The brake B1 makes the third carrier 23c of the third planetary gear 230 and the first sun gear 21s (first securable element) of the composite planetary gear mechanism 250 stationary with respect to (connects the third carrier 23c and the first sun gear 21s to) the transmission case 11 so as to be non-rotatable, and makes the third carrier 23c and the first sun gear 21s non-stationary with respect to the transmission case 11. The brake B2 makes the first carrier 21c and the second ring gear 22r (second securable element) of the composite planetary gear mechanism 250 stationary with respect to the transmission case 11 by connecting the second driven gear 29 of the second gear train G2 to the transmission case 11. The brake B3 makes the third ring gear 23r of the third planetary gear 230 stationary with respect to (connects the third ring gear 23r to) the transmission case 11 so as to be non-rotatable, and makes the third ring gear 23r non-stationary with respect to the transmission case 11. The clutch C5 connects and disconnects the second driven gear 29 of the second gear train G2 and the output gear 20o (first driven gear 27) to and from each other.

In the automatic transmission 20P, according to the order of arrangement on the velocity diagram illustrated in FIG. 28, the first sun gear 21s of the composite planetary gear mechanism 250 is defined as a first rotary element of the automatic transmission 20P, the first carrier 21c and the second ring gear 22r are defined as a second rotary element of the automatic transmission 20P, the first ring gear 21r and the second carrier 22c are defined as a third rotary element of the automatic transmission 20P, and the second sun gear 22s is defined as a fourth rotary element of the automatic transmission 20P. In addition, the third sun gear 23s is defined as a fifth rotary element of the automatic transmission 20P, the third carrier 23c is defined as a sixth rotary element of the automatic transmission 20P, and the third ring gear 23r is defined as a seventh rotary element of the automatic transmission 20P.

With the automatic transmission 20P configured as discussed above, the first to ninth forward speeds and the reverse speed can be established by engaging and disengaging the clutches C1, C2, and C5 and the brakes B1, B2, and B3. That is, also with the automatic transmission 20P, three shift speeds (third, fifth, and seventh forward speeds) can be added to the speed change device to which the first and second gear trains G1 and G2 and the clutch C5 have not been added. As a result, with the automatic transmission 20P, by the addition of intermediate shift speeds (third, fifth, and seventh forward speeds), the step ratios can be optimized (an increase in the step ratios can be suppressed), which makes it possible to improve the acceleration performance at each shift speed and the shifting feeling. Thus, also with the automatic transmission 20P, the drivability can be improved well along with improving the fuel efficiency of the vehicle by increasing the number of shift speeds.

In addition, by adopting the CR-CR type composite planetary gear mechanism 250 which is constituted by combining the single-pinion type first and second planetary gears 21 and 22 with each other, it is possible to further improve the power transfer efficiency of the automatic transmission 20P by reducing a meshing loss between the rotary elements of the composite planetary gear mechanism 250, and to improve the assemblability while suppressing an increase in the weight of the entire device by reducing the number of components. Also with the automatic transmission 20P, further, as illustrated in FIG. 27, the brake B2 can be disposed around the axis (second shaft) of the output gear 20o. Thus, it is possible to suppress an increase in the physical size around the composite planetary gear mechanism 250 (in an end portion remote from the engine).

FIG. 29 is a diagram illustrating a schematic configuration of a power transfer device 10Q that includes an automatic transmission 20Q according to still another modified aspect of the second embodiment of the present disclosure. In the automatic transmission 20Q illustrated in the drawing, the second drive gear 28 which constitutes the second gear train G2 is always coupled coaxially with the first sun gear 21s of the composite planetary gear mechanism 250 which is a first rotary element of the automatic transmission 20Q. In the example illustrated in FIG. 29, the gear ratio gr2 of the second gear train G2 is determined to be lower than the gear ratio gr1 of the first gear train G1. In the automatic transmission 20Q, in addition, the brake B1 makes the first sun gear 21s (first securable element) of the composite planetary gear mechanism 250 stationary with respect to the transmission case 11 so as to be non-rotatable by connecting the second driven gear 29 of the second gear train G2 to the transmission case 11. Furthermore, the brake B2 is configured to connect the first carrier 21c and the second ring gear 22r (second securable element) of the composite planetary gear mechanism 250 to the transmission case 11. The thus configured automatic transmission 20Q also allows obtaining functions and effects that are similar to those of the automatic transmission 20P discussed above.

FIG. 30 is a diagram illustrating a schematic configuration of a power transfer device 10R that includes an automatic transmission 20R according to another modified aspect of the second embodiment of the present disclosure. In the automatic transmission 20R illustrated in the drawing, the second drive gear 28 which constitutes the second gear train G2 is always coupled coaxially with the second sun gear 22s of the composite planetary gear mechanism 250 which is a fourth rotary element of the automatic transmission 20R. In the example illustrated in FIG. 30, the gear ratio gr2 of the second gear train G2 is determined to be higher than the gear ratio gr1 of the first gear train G1. The thus configured automatic transmission 20R also allows obtaining functions and effects that are similar to those of the automatic transmission 20P discussed above.

FIG. 31 is a diagram illustrating a schematic configuration of a power transfer device 10S that includes an automatic transmission 20S according to a third embodiment of the present disclosure. Constituent elements of the automatic transmission 20S that are identical to the elements of the automatic transmission 20 etc. discussed above are given the same numerals to omit redundant descriptions.

The automatic transmission 20S illustrated in FIG. 31 corresponds to the automatic transmission 20 discussed above, and in the automatic transmission 20P the third planetary gear 23 and the clutch C4 have been omitted. In the automatic transmission 20S, as illustrated in the drawing, the Ravigneaux type planetary gear mechanism 25 is disposed in the transmission case 11 such that the second planetary gear 22 and the first planetary gear 21 are arranged in the order of the second planetary gear 22 and the first planetary gear 21 from the starting device 12 side, that is, the engine side (the right side in FIG. 11). In addition, the first drive gear (externally toothed gear) 26 of the first gear train G1 is always coupled coaxially with the first ring gear 21r of the Ravigneaux type planetary gear mechanism 25. The first ring gear 21r functions as an output element of the Ravigneaux type planetary gear mechanism 25. Furthermore, the second drive gear (externally toothed gear) 28 of the second gear train G2 is always coupled coaxially with the first carrier 21c (second rotary element) of the Ravigneaux type planetary gear mechanism 25. In the example illustrated in FIG. 31, the gear ratio gr2 of the second gear train G2 is determined to be lower than the gear ratio gr1 of the first gear train G1.

In addition, the clutch C1 of the automatic transmission 20S connects and disconnects the input shaft 20i and the second sun gear 22s of the Ravigneaux type planetary gear mechanism 25 to and from each other. The clutch C2 connects and disconnects the input shaft 20i and the first carrier 21c of the Ravigneaux type planetary gear mechanism 25 to and from each other. The clutch C3 connects and disconnects the input shaft 20i and the first sun gear 21s of the Ravigneaux type planetary gear mechanism 25 to and from each other. The brake B1 makes the first sun gear 21s (first securable element) of the Ravigneaux type planetary gear mechanism 25 stationary with respect to (connects the first sun gear 21s to) the transmission case 11 so as to be non-rotatable, and makes the first sun gear 21s non-stationary with respect to the transmission case 11. The brake B2 makes the first carrier 21c (second securable element) of the Ravigneaux type planetary gear mechanism 25 stationary with respect to the transmission case 11 so as to be non-rotatable by making the second driven gear 29 of the second gear train G2 stationary with respect to (connecting the second driven gear 29 to) the transmission case 11 so as to be non-rotatable. The clutch C5 connects and disconnects the second driven gear 29 of the second gear train G2 and the output gear 20o (first driven gear 27) to and from each other.

FIG. 32 is a velocity diagram illustrating the ratio of the rotational speed of each rotary element to the rotational speed of the input shaft 20i (input rotational speed) of the automatic transmission 20S (note that the rotational speed of the input shaft 20i is defined as a value of 1). In addition, FIG. 33 is an operation table illustrating the relationship between each shift speed of the automatic transmission 20S and the respective operating states of the clutches C1 to C3 and C5 and the brakes B1 and B2.

In the automatic transmission 20S, according to the order of arrangement on the velocity diagram illustrated in FIG. 32, the first sun gear 21s of the Ravigneaux type planetary gear mechanism 25 is defined as a first rotary element of the automatic transmission 20S, the first carrier 21c is defined as a second rotary element of the automatic transmission 20S, the first ring gear 21r is defined as a third rotary element of the automatic transmission 20S, and the second sun gear 22s is defined as a fourth rotary element of the automatic transmission 20S. In the automatic transmission 20S, the clutches C1 to C3 and C5 and the brakes B1 and B2 are engaged and disengaged as illustrated in FIG. 33 to change the relationship of connection of the first to fourth rotary elements discussed above, which allows establishing seven power transfer paths in the forward rotational direction and one power transfer path in the reverse rotational direction from the input shaft 20i to the output gear 20o, that is, first to seventh forward speeds and a reverse speed.

Specifically, the first forward speed of the automatic transmission 20S is established by engaging the clutch C1 and the brake B2 and disengaging the remaining clutches C2, C3, and C5 and brake B1. That is, to establish the first forward speed, the input shaft 20i and the second sun gear 22s (fourth rotary element) of the Ravigneaux type planetary gear mechanism 25 are connected to each other by the clutch C1. Furthermore, the first carrier 21c (second rotary element) of the Ravigneaux type planetary gear mechanism 25 is made stationary with respect to the transmission case 11 by the brake B2 so as to be non-rotatable. The second forward speed is established by engaging the clutch C1 and the brake B1 and disengaging the remaining clutches C2, C3, and C5 and brake B2. That is, to establish the second forward speed, the input shaft 20i and the second sun gear 22s of the Ravigneaux type planetary gear mechanism 25 are connected to each other by the clutch C1. Furthermore, the first sun gear 21s (first rotary element) of the Ravigneaux type planetary gear mechanism 25 is made stationary with respect to the transmission case 11 by the brake B1 so as to be non-rotatable.

The third forward speed is established by engaging the clutches C1 and C5 and disengaging the remaining clutches C2 and C3 and brakes B1 and B2. That is, to establish the third forward speed, the input shaft 20i and the second sun gear 22s of the Ravigneaux type planetary gear mechanism 25 are connected to each other by the clutch C1. Furthermore, the second driven gear 29 of the second gear train G2 and the output gear 20o (first driven gear 27) are connected to each other by the clutch C5. The fourth forward speed is established by engaging the clutches C1 and C2 and disengaging the remaining clutches C3 and C5 and brakes B1 and B2. That is, to establish the fourth forward speed, the input shaft 20i and the second sun gear 22s of the Ravigneaux type planetary gear mechanism 25 are connected to each other by the clutch C1. Furthermore, the input shaft 20i and the first carrier 21c (second rotary element) of the Ravigneaux type planetary gear mechanism 25 are connected to each other by the clutch C2.

The fifth forward speed is established by engaging the clutches C2 and C5 and disengaging the remaining clutches C1 and C3 and brakes B1 and B2. That is, to establish the fifth forward speed, the input shaft 20i and the first carrier 21c of the Ravigneaux type planetary gear mechanism 25 are connected to each other by the clutch C2. Furthermore, the second driven gear 29 of the second gear train G2 and the output gear 20o (first driven gear 27) are connected to each other by the clutch C5. The sixth forward speed is established by engaging the clutch C2 and the brake B1 and disengaging the remaining clutches C1, C3, and C5 and brake B2. That is, to establish the sixth forward speed, the input shaft 20i and the first carrier 21c of the Ravigneaux type planetary gear mechanism 25 are connected to each other by the clutch C2. Furthermore, the first sun gear 21s of the Ravigneaux type planetary gear mechanism 25 is made stationary with respect to the transmission case 11 by the brake B1 so as to be non-rotatable.

The seventh forward speed is established by engaging the clutches C3 and C5 and disengaging the remaining clutches C1 and C2 and brakes B1 and B2. That is, to establish the seventh forward speed, the input shaft 20i and the first sun gear 21s (first rotary element) of the Ravigneaux type planetary gear mechanism 25 are connected to each other by the clutch C3. Furthermore, the second driven gear 29 of the second gear train G2 and the output gear 20o (first driven gear 27) are connected to each other by the clutch C5. The reverse speed is established by engaging the clutch C3 and the brake B2 and disengaging the remaining clutches C1, C2, and C5 and brake B1. That is, to establish the reverse speed, the input shaft 20i and the first sun gear 21s of the Ravigneaux type planetary gear mechanism 25 are connected to each other by the clutch C3. Furthermore, the second driven gear 29 of the second gear train G2, that is, the first carrier 21c which is coupled to the second driven gear 29 via the second drive gear 28, is made stationary with respect to the transmission case 11 by the brake B2 so as to be non-rotatable.

As discussed above, with the automatic transmission 20S, the first to seventh forward speeds and the reverse speed can be established by engaging and disengaging the clutches C1 to C3 and C5 and the brakes B1 and B2. With the automatic transmission 20S, one of the clutches C1 to C3 and the clutch C5 are engaged to establish the third, fifth, and seventh forward speeds. When the output gear 20o is rotated with the clutch C5 engaged in this way, the first carrier 21c (one of the rotary elements), which is coupled via the second drive gear 28 to the second driven gear 29 which is rotated together with and in the same direction as the output gear 20o and the first driven gear 27, is rotated with respect to the output gear 20o at a rotational speed that matches the gear ratio gr2 of the second gear train G2. When the output gear 20o is rotated with the clutch C5 engaged, in addition, the first ring gear 21r which is the output element of the Ravigneaux type planetary gear mechanism 25 is rotated with respect to the output gear 20o at a rotational speed that matches the gear ratio gr1 of the first gear train G1. Thus, by engaging one of the clutches C1 to C3 and the clutch C5, a rotational speed difference that matches the gear ratios gr1 and gr2 of the first and second gear trains G1 and G2 can be caused between the first ring gear 21r and the first carrier 21c of the Ravigneaux type planetary gear mechanism 25. Consequently, the automatic transmission 20S also allows establishing shift speeds other than those obtained by selectively engaging two of the clutches C1 to C3 and the brakes B1 and B2.

That is, when the clutch C5 is engaged with torque directly transferred from the input shaft 20i to the second sun gear 22s (fourth rotary element) of the Ravigneaux type planetary gear mechanism 25 through engagement of the clutch C1, the second driven gear 29 is rotated together with and in the same direction as the output gear 20o and the first driven gear 27 so that the speed of the first carrier 21c of the Ravigneaux type planetary gear mechanism 25 can be increased compared to the time when the second forward speed is established and the speed of the first ring gear 21r can be reduced compared to the time when the fourth forward speed is established as illustrated in FIG. 32. Consequently, it is possible to establish the third forward speed with the gear ratio γ3 which is lower than the gear ratio γ2 of the second forward speed and higher than the gear ratio γ4 of the fourth forward speed.

When the clutch C5 is engaged with torque directly transferred from the input shaft 20i to the first carrier 21c (second rotary element) of the Ravigneaux type planetary gear mechanism 25 through engagement of the clutch C2, meanwhile, the second driven gear 29 is rotated together with and in the same direction as the output gear 20o and the first driven gear 27 so that the speed of the first ring gear 21r of the Ravigneaux type planetary gear mechanism 25 can be increased compared to the time when the fourth forward speed is established as illustrated in FIG. 32. Consequently, it is possible to establish the fifth forward speed with the gear ratio γ5 which is lower than the gear ratio γ4 of the fourth forward speed and higher than the gear ratio γ6 of the sixth forward speed.

When the clutch C5 is engaged with torque directly transferred from the input shaft 20i to the first sun gear 21s (first rotary element) of the Ravigneaux type planetary gear mechanism 25 through engagement of the clutch C3, further, the second driven gear 29 is rotated together with and in the same direction as the output gear 20o and the first driven gear 27 so that the speed of the first ring gear 21r of the Ravigneaux type planetary gear mechanism 25 can be increased compared to the time when the sixth forward speed is established as illustrated in FIG. 32. Consequently, it is possible to establish the seventh forward speed with the gear ratio γ7 which is lower than the gear ratio γ6 of the sixth forward speed.

As discussed above, with the automatic transmission 20S in which torque from the input shaft 20i is selectively (sequentially) transferred to the second sun gear 22s, the first carrier 21c, and the first sun gear 21s, not the first ring gear 21r (output element), of the Ravigneaux type planetary gear mechanism 25, three shift speeds (third, fifth, and seventh forward speeds) can be added to the speed change device (see JP 2010-216568 A) to which the first and second gear trains G1 and G2 and the clutch C5 have not been added. As a result, with the automatic transmission 20S, the spread can be further increased by the addition of the seventh forward speed as the highest shift speed to improve the fuel efficiency of the vehicle at a high vehicle speed, in particular. By the addition of intermediate shift speeds (third and fifth forward speeds), further, the step ratios can be optimized (an increase in the step ratios can be suppressed) to improve the shifting feeling. Thus, also with the automatic transmission 20S, it is possible to improve both the fuel efficiency and the drivability of the vehicle well. Also with the automatic transmission 20S, in addition, it is possible to increase the number of shift speeds, while suppressing an increase in the size of the entire device or the number of components, by combining the Ravigneaux type planetary gear mechanism 25, which is a composite planetary gear mechanism with four elements, the first and second gear trains G1 and G2, and the clutch C5 with each other. Also with the automatic transmission 20S, further, as illustrated in FIG. 31, the brake B2 can be disposed around the axis (second shaft) of the output gear 20o. Thus, it is possible to suppress an increase in the physical size around the Ravigneaux type planetary gear mechanism 25.

FIG. 34 is a diagram illustrating a schematic configuration of a power transfer device 10T that includes an automatic transmission 20T according to a modified aspect of the third embodiment of the present disclosure. In the automatic transmission 20T illustrated in the drawing, the Ravigneaux type planetary gear mechanism 25 is disposed in the transmission case 11 such that the first planetary gear 21 and the second planetary gear 22 are arranged in the order of the first planetary gear 21 and the second planetary gear 22 from the starting device 12 side, that is, the engine side (the right side in FIG. 31). In the automatic transmission 20T, in addition, the second drive gear 28 which constitutes the second gear train G2 is always coupled to the first sun gear 21s (first rotary element) in place of the first carrier 21c (second rotary element) of the Ravigneaux type planetary gear mechanism 25. In the example illustrated in FIG. 34, the gear ratio gr2 of the second gear train G2 is determined to be lower than the gear ratio gr1 of the first gear train G1. The thus configured automatic transmission 20T also allows obtaining functions and effects that are similar to those of the automatic transmission 20S discussed above.

FIG. 35 is a diagram illustrating a schematic configuration of a power transfer device 10U that includes an automatic transmission 20U according to another modified aspect of the third embodiment of the present disclosure. The automatic transmission 20U illustrated in the drawing corresponds to the automatic transmission 20J discussed above, and in the automatic transmission 20U the third planetary gear 23 has been omitted. As illustrated in the drawing, the clutch C1 of the automatic transmission 20U connects and disconnects the input shaft 20i and the first sun gear 21s (fourth rotary element) of the composite planetary gear mechanism 250 to and from each other. The thus configured automatic transmission 20U also allows obtaining functions and effects that are similar to those of the automatic transmission 20S discussed above. In addition, by adopting the CR-CR type composite planetary gear mechanism 250 which is constituted by combining the single-pinion type first and second planetary gears 21 and 22 with each other, it is possible to further improve the power transfer efficiency of the automatic transmission 20U by reducing a meshing loss between the rotary elements of the composite planetary gear mechanism 250, and to improve the assemblability while suppressing an increase in the weight of the entire device by reducing the number of components.

FIG. 36 is a diagram illustrating a schematic configuration of a power transfer device 10V that includes an automatic transmission 20V according to still another modified aspect of the third embodiment of the present disclosure. In the automatic transmission 20V illustrated in the drawing, the second drive gear 28 which constitutes the second gear train G2 is always coupled coaxially with the first sun gear 21s of the composite planetary gear mechanism 250 which is a fourth rotary element of the automatic transmission 20V. In the example illustrated in FIG. 36, the gear ratio gr2 of the second gear train G2 is determined to be higher than the gear ratio gr1 of the first gear train G1. In the automatic transmission 20V, in addition, the brake B2 is configured to connect the first ring gear 21r and the second carrier 22c (second securable element) of the composite planetary gear mechanism 250 to the transmission case 11, and disposed around the composite planetary gear mechanism 250. The thus configured automatic transmission 20V also allows obtaining functions and effects that are similar to those of the automatic transmission 20U discussed above.

FIG. 37 is a diagram illustrating a schematic configuration of a power transfer device 10X that includes an automatic transmission 20X according to another modified aspect of the third embodiment of the present disclosure. In the automatic transmission 20X illustrated in the drawing, the second drive gear 28 which constitutes the second gear train G2 is always coupled to the second sun gear 22s of the composite planetary gear mechanism 250 which is a first rotary element of the automatic transmission 20X. In the example illustrated in FIG. 37, the gear ratio gr2 of the second gear train G2 is determined to be lower than the gear ratio gr1 of the first gear train G1. In the automatic transmission 20X, in addition, the brake B1 makes the second sun gear 22s (first securable element) of the composite planetary gear mechanism 250 stationary with respect to the transmission case 11 so as to be non-rotatable by connecting the second driven gear 29 of the second gear train G2 to the transmission case 11. Furthermore, the brake B2 is configured to connect the first ring gear 21r and the second carrier 22c (second securable element) of the composite planetary gear mechanism 250 to the transmission case 11, and disposed around the composite planetary gear mechanism 250. The thus configured automatic transmission 20X also allows obtaining functions and effects that are similar to those of the automatic transmission 20U discussed above.

In the automatic transmissions 20 to 20X discussed above, at least one of the clutches C1 to C5 and the brakes B1 to B3 may be a meshing engagement element such as a dog clutch or a dog brake. In the automatic transmissions 20 to 20X, in addition, the gear ratios λ1 to λ3 of the first to third planetary gears 21, 22, 23, and 230 are not limited to those described above. Furthermore, two winding transmission mechanisms that have different speed ratios may be used in place of the first and second gear trains G1 and G2. In the automatic transmission 20B illustrated in FIG. 7, in addition, the brake B1 makes the first sun gear 21s of the Ravigneaux type planetary gear mechanism 25 stationary with respect to the transmission case 11 so as to be non-rotatable by connecting the second driven gear 29 of the second gear train G2 to the transmission case 11. However, the present subject matter is not limited thereto. That is, as in an automatic transmission 203 illustrated in FIG. 38, the brake B1 may be disposed around the input shaft 20i (first shaft). Consequently, it is possible to secure the torque capacity and the heat capacity of the brake B1 well, while suppressing an increase in the number of friction plates (friction materials), by increasing the outside diameter of the friction plates (area of the friction materials) of the brake B1.

As has been described above, the present disclosure provides a speed change device (20 to 20X) that includes an input member (20i), an output member (20o), a composite planetary gear mechanism (25, 25W, 250) that has at least four rotary elements including an output element (21r, 21c, 21c and 22c, 21c and 22r, 21r and 22c), and at least five engagement elements (B1, B2, C1, C2, C3) that each connect and disconnect one of the rotary elements of the composite planetary gear mechanism (25) and a different one of rotary elements including the input member (20i) or a stationary member (11) to and from each other, the speed change device transferring power, which has been transferred to the input member (20i), to the output member (20o) with a speed of the power changed. The speed change device includes: a first gear train (G1) that includes a first drive gear (26) always coupled to the output element of the composite planetary gear mechanism (25, 25W, 250) and a first driven gear (27) which is always coupled to the output member (20o) and to which power is transferred from the first drive gear (26); a second gear train (G2) that includes a second drive gear (28) always coupled to one of the rotary elements, not the output element, of the composite planetary gear mechanism (25) and a second driven gear (29) that is rotated in the same direction as the first driven gear (27) by power from the second drive gear (28), the second gear train having a gear ratio that is different from that of the first gear train; and an output-side engagement element (C5) that connects and disconnects the second driven gear (29) and the output member (20o) to and from each other.

That is, the speed change device according to the present disclosure corresponds to a transmission which can establish a plurality of shift speeds by selectively engaging at least two of at least five engagement elements, and to which first and second gear trains and an output-side engagement element have been added. The first gear train includes a first drive gear always coupled to the output element of the composite planetary gear mechanism and a first driven gear which is always coupled to the output member and to which power is transferred from the first drive gear. The second gear train includes a second drive gear always coupled to one of the rotary elements, not the output element, of the composite planetary gear mechanism and a second driven gear that is rotated in the same direction as the first driven gear by power from the second drive gear. The second gear train has a gear ratio that is different from that of the first gear train. Further, the output-side engagement element connects and disconnects the second driven gear and the output member to and from each other.

In such a speed change device, when the output member is rotated with the output-side engagement element engaged, one of the rotary elements that is coupled via the second drive gear to the second driven gear which is rotated together with the output member is rotated with respect to the output member at a rotational speed that matches the gear ratio of the second gear train. When the output member is rotated with the output-side engagement element engaged, in addition, the output element of the composite planetary gear mechanism is rotated with respect to the output member at a rotational speed that matches the gear ratio of the first gear train. Thus, a rotational speed difference that matches the gear ratios of the first and second gear trains can be caused between the output element of the composite planetary gear mechanism and one of the rotary elements by engaging one of the at least five engagement elements and the output-side engagement element. Consequently, with the speed change device according to the present disclosure, it is possible to establish shift speeds other than those obtained by selectively engaging at least two of the at least five engagement elements. For example, in the case where power from the input member side is selectively transferred to a rotary element, not the output element, of the composite planetary gear mechanism, at least three shift speeds can be added to the speed change device to which the first and second gear trains and the output-side engagement element have not been added. As a result, with the speed change device according to the present disclosure, it is possible to further improve the fuel efficiency and the drivability of a vehicle by increasing the number of shift speeds.

The composite planetary gear mechanism (25, 25W, 250) may have a first rotary element (21s, 22s, 21s, 22s, 21s), a second rotary element (21c, 21r, 22r, 21r and 22c, 21c and 22r), a third rotary element (21r, 21c, 21c and 22c, 21c and 22r, 21r and 22c), and a fourth rotary element (22s, 21s, 21r and 22s, 21s, 22s) that are arranged sequentially in accordance with a gear ratio; and the output element may be the third rotary element, and the one of the rotary elements may be the first, second, or fourth rotary element. It is possible to increase the number of shift speeds, while suppressing an increase in the size of the entire device or the number of components, by combining the composite planetary gear mechanism with four elements, the first and second gear trains, and the output-side engagement element with each other.

The five engagement elements may include: a first engagement element (B1) that connects the first rotary element to the stationary member (11) to make the first rotary element stationary so as to be non-rotatable, and that disconnects the first rotary element and the stationary member (11) from each other; a second engagement element (B2) that connects the second rotary element to the stationary member (11) to make the second rotary element stationary so as to be non-rotatable, and that disconnects the second rotary element and the stationary member (11) from each other; a third engagement element (C1) that allows and cancels transfer of power from an input member side to the fourth rotary element; a fourth engagement element (C2) that allows and cancels transfer of power from the input member side to the second rotary element; and a fifth engagement element (C3, B3) that allows and cancels transfer of power from the input member side to the first rotary element. Consequently, it is possible to selectively transfer power from the input member side to the first, second, and fourth rotary elements by selectively engaging the third, fourth, and fifth engagement elements.

The speed change device (20, 20B, 20C, 20D, 20E, 20F) may further include a planetary gear (23) that has a fifth rotary element (23s), a sixth rotary element (23r), and a seventh rotary element (23c) arranged sequentially in accordance with a gear ratio, and a sixth engagement element; one of the fifth and seventh rotary elements (23s, 23c) may be always connected to the stationary member (11), and the other may be always coupled to the input member (20i); the third engagement element (C1) may connect and disconnect the fourth rotary element and the sixth rotary element to and from each other; the fourth engagement element (C2) may connect and disconnect the second rotary element and the input member to and from each other; the fifth engagement element (C3) may connect and disconnect the first rotary element and the sixth rotary element to and from each other; and the sixth engagement element (C4) may connect and disconnect the first rotary element and the input member to and from each other. Such a speed change device corresponds to a speed change device which can establish first to eighth forward speeds by selectively engaging two of the first to sixth engagement elements and to which the first and second gear trains and the output-side engagement element have been added. Thus, the speed change device can establish first to twelfth, first to eleventh, first to tenth, or first to ninth forward speeds. Consequently, with the number of shift speeds increased, it is possible to improve both the fuel efficiency and the drivability of the vehicle significantly well.

Specifically, first to twelfth forward speeds and a reverse speed can be established by engaging the first to sixth engagement elements and the output-side engagement element as follows. That is, a first forward speed is established by engaging the second and third engagement elements (B2, C1). A second forward speed is established by engaging the first and third engagement elements (B1, C1). A third forward speed is established by engaging the third engagement element (C1) and the output-side engagement element (C5). A fourth forward speed is established by engaging the third and fifth engagement elements (C1, C3). A fifth forward speed is established by engaging the third and sixth engagement elements (C1, C4). A sixth forward speed is established by engaging the third and fourth engagement elements (C1, C2). A seventh forward speed is established by engaging the fifth engagement element (C3) and the output-side engagement element (C5). An eighth forward speed is established by engaging the fourth and sixth engagement elements (C2, C4). A ninth forward speed is established by engaging the fourth engagement element (C2) and the output-side engagement element (C5). A tenth forward speed is established by engaging the fourth and fifth engagement elements (C2, C3). An eleventh forward speed is established by engaging the first and fourth engagement elements (B1, C2). A twelfth forward speed is established by engaging the sixth engagement element (C4) and the output-side engagement element (C5). A reverse speed is established by engaging the second and fifth engagement elements (B2, C3).

First to eleventh forward speeds and reverse speeds can be established by engaging the first to sixth engagement elements and the output-side engagement element as follows. That is, a first forward speed is established by engaging the second and third engagement elements (B2, C1). A second forward speed is established by engaging the first and third engagement elements (B1, C1). A third forward speed is established by engaging the third engagement element (C1) and the output-side engagement element (C5). A fourth forward speed is established by engaging the third and fifth engagement elements (C1, C3). A fifth forward speed is established by engaging the third and sixth engagement elements (C1, C4). A sixth forward speed is established by engaging the third and fourth engagement elements (C1, C2). A seventh forward speed is established by engaging the fourth and sixth engagement elements (C2, C4). An eighth forward speed is established by engaging the fourth engagement element (C2) and the output-side engagement element (C5). A ninth forward speed is established by engaging the fourth and fifth engagement elements (C2, C3). A tenth forward speed is established by engaging the first and fourth engagement elements (B1, C2). An eleventh forward speed is established by engaging the sixth engagement element (C4) and the output-side engagement element (C5). A first reverse speed is established by engaging the second and fifth engagement elements (B2, C3). A second reverse speed is established by engaging the second and sixth engagement elements (B2, C4).

First to tenth forward speeds and a reverse speed can be established by engaging the first to sixth engagement elements and the output-side engagement element as follows. That is, a first forward speed is established by engaging the second and third engagement elements (B2, C1). A second forward speed is established by engaging the first and third engagement elements. A third forward speed is established by engaging the third and fifth engagement elements (C1, C3). A fourth forward speed is established by engaging the third and sixth engagement elements (C1, C4). A fifth forward speed is established by engaging the third and fourth engagement elements (C1, C2). A sixth forward speed is established by engaging the fourth and sixth engagement elements (C2, C4). A seventh forward speed is established by engaging the fourth engagement element (C2) and the output-side engagement element (C5). An eighth forward speed is established by engaging the fourth and fifth engagement elements (C2, C3). A ninth forward speed is established by engaging the first and fourth engagement elements (B1, C2). A tenth forward speed is established by engaging the sixth engagement element (C4) and the output-side engagement element (C5). A reverse speed is established by engaging the second and fifth engagement elements (B2, C3).

First to ninth forward speeds and a reverse speed can be established by engaging the first to sixth engagement elements and the output-side engagement element as follows. That is, a first forward speed is established by engaging the second and third engagement elements (B2, C1). A second forward speed is established by engaging the first and third engagement elements (B1, C1). A third forward speed is established by engaging the third and fifth engagement elements (C1, C3). A fourth forward speed is established by engaging the third and sixth engagement elements (C1, C4). A fifth forward speed is established by engaging the third and fourth engagement elements (C1, C2). A sixth forward speed is established by engaging the fourth and sixth engagement elements (C2, C4). A seventh forward speed is established by engaging the fourth engagement element (C2) and the fifth engagement element (C3). An eighth forward speed is established by engaging the first and fourth engagement elements (B1, C2). A ninth forward speed is established by engaging the sixth engagement element (C4) and the output-side engagement element (C5). A reverse speed is established by engaging the second and fifth engagement elements (B2, C3).

The planetary gear may be a double-pinion type planetary gear that has a third sun gear (23s), a third ring gear (23r), and a third carrier (23c) that rotatably and revolvably holds a plurality of sets of two pinion gears (23pa, 23pb) meshed with each other, one of the pinion gears being meshed with the third sun gear (23s) and the other being meshed with the third ring gear (23r), the fifth rotary element may be the third sun gear (23s), the sixth rotary element may be the third ring gear (23r), and the seventh rotary element may be the third carrier (23c).

The speed change device (20G, 20H, 20I, 20J, 20K, 20L) may further include a planetary gear (230, 23) that has a fifth rotary element (23s), a sixth rotary element (23c, 23r), and a seventh rotary element (23r, 23c) arranged sequentially in accordance with a gear ratio; one of the fifth and seventh rotary elements may be always connected to the stationary member (11), and the other may be always coupled to the input member (20i); the third engagement element (C1) may connect and disconnect the fourth rotary element and the sixth rotary element to and from each other; the fourth engagement element (C2) may connect and disconnect the second rotary element and the input member to and from each other; and the fifth engagement element (C3) may connect and disconnect the first rotary element and the sixth rotary element to and from each other. Such a speed change device corresponds to a speed change device which can establish first to sixth forward speeds by selectively engaging two of the first to fifth engagement elements and to which the first and second gear trains and the output-side engagement element have been added. Thus, the speed change device can establish the first to ninth forward speeds. Consequently, with the number of shift speeds increased, it is possible to improve both the fuel efficiency and the drivability of the vehicle.

With the speed change device, first to ninth forward speeds and a reverse speed can be established by engaging the first to fifth engagement elements and the output-side engagement element as follows. That is, a first forward speed is established by engaging the second and third engagement elements (B2, C1). A second forward speed is established by engaging the first and third engagement elements (B1, C1). A third forward speed is established by engaging the third engagement element (C1) and the output-side engagement element (C5). A fourth forward speed is established by engaging the third and fifth engagement elements (C1, C3). A fifth forward speed is established by engaging the fifth engagement element (C3) and the output-side engagement element (C5). A sixth forward speed is established by engaging the third and fourth engagement elements (C1, C2). A seventh forward speed is established by engaging the fourth engagement element (C2) and the output-side engagement element (C5). An eighth forward speed is established by engaging the fourth and fifth engagement elements (C2, C3). A ninth forward speed is established by engaging the first and fourth engagement elements (B1, C2). A reverse speed is established by engaging the second and fifth engagement elements (B2, C3).

First to ninth forward speeds and a reverse speed can be established also by engaging the first to fifth engagement elements and the output-side engagement element as follows. That is, a first forward speed is established by engaging the second and third engagement elements (B2, C1). A second forward speed is established by engaging the first and third engagement elements (B1, C1). A third forward speed is established by engaging the third engagement element (C1) and the output-side engagement element (C5). A fourth forward speed is established by engaging the third and fifth engagement elements (C1, C3). A fifth forward speed is established by engaging the third and fourth engagement elements (C1, C2). A sixth forward speed is established by engaging the fourth and fifth engagement elements (C2, C3). A seventh forward speed is established by engaging the fourth engagement element (C2) and the output-side engagement element (C5). An eighth forward speed is established by engaging the first and fourth engagement elements (B1, C2). A ninth forward speed is established by engaging the fifth engagement element (C3) and the output-side engagement element (C5). A reverse speed is established by engaging the second and fifth engagement elements (B2, C3).

The speed change device (20M, 20N, 20P, 20Q, 20R) may further include a planetary gear (23) that has a fifth rotary element (23s), a sixth rotary element (23c), and a seventh rotary element (23r) arranged sequentially in accordance with a gear ratio; the fifth rotary element (23s) may be always coupled to the input member (20i); the third engagement element (C1) may connect and disconnect the fourth rotary element and the input member (20i) to and from each other; the fourth engagement element (C2) may connect and disconnect the second rotary element and the input member (20i) to and from each other; and the fifth engagement element (B3) may connect the seventh rotary element (23r) to the stationary member (11) to make the seventh rotary element stationary so as to be non-rotatable, and disconnect the seventh rotary element and the stationary member from each other. Such a speed change device also corresponds to a speed change device which can establish first to sixth forward speeds by selectively engaging two of the first to fifth engagement elements and to which the first and second gear trains and the output-side engagement element have been added. Thus, the speed change device can establish the first to ninth forward speeds. Consequently, with the number of shift speeds increased, it is possible to improve both the fuel efficiency and the drivability of the vehicle.

With the speed change device, first to ninth forward speeds and a reverse speed can be established by engaging the first to fifth engagement elements and the output-side engagement element as follows. That is, a first forward speed is established by engaging the second and third engagement elements (B2, C1). A second forward speed is established by engaging the first and third engagement elements (B1, C1). A third forward speed is established by engaging the fifth engagement element (B3) and the output-side engagement element (C5). A fourth forward speed is established by engaging the third and fifth engagement elements (C1, B3). A fifth forward speed is established by engaging the third engagement element (C1) and the output-side engagement element (C5). A sixth forward speed is established by engaging the third and fourth engagement elements (C1, C2). A seventh forward speed is established by engaging the fourth engagement element (C2) and the output-side engagement element (C5). An eighth forward speed is established by engaging the fourth and fifth engagement elements (C2, B3). A ninth forward speed is established by engaging the first and fourth engagement elements (B1, C2). A reverse speed is established by engaging the second and fifth engagement elements (B2, B3).

The planetary gear may be a single-pinion type planetary gear that has a third sun gear (23s), a third ring gear (23r), and a third carrier (23c) that rotatably and revolvably holds a plurality of third pinion gears (23p) meshed with the third sun gear (23s) and the third ring gear (23r), the fifth rotary element may be the third sun gear (23s) which is always connected to the stationary member (11), the sixth rotary element may be the third carrier (23c), and the seventh rotary element may be the third ring gear (23r).

The planetary gear may be a double-pinion type planetary gear that has a third sun gear (23s), a third ring gear (23r), and a third carrier (23c) that rotatably and revolvably holds a plurality of sets of two pinion gears (23pa, 23pb) meshed with each other, one of the pinion gears being meshed with the third sun gear (23s) and the other being meshed with the third ring gear (23r), the fifth rotary element may be the third sun gear (23s), the sixth rotary element may be the third ring gear (23r), and the seventh rotary element may be the third carrier (23c) which is always connected to the stationary member (11).

The third engagement element (C1) may connect and disconnect the fourth rotary element and the input member (20i) to and from each other; the fourth engagement element (C2) may connect and disconnect the second rotary element and the input member (20i) to and from each other; and the fifth engagement element (C3) may connect and disconnect the first rotary element and the input member (20i) to and from each other. Such a speed change device (20S, 20T, 20U, 20V, 20X) corresponds to a speed change device which can establish first to fourth forward speeds by selectively engaging two of the first to fifth engagement elements and to which the first and second gear trains and the output-side engagement element have been added. Thus, the speed change device can establish the first to seventh forward speeds. Consequently, with the low-cost speed change device, it is possible to improve the fuel efficiency and the drivability of a vehicle by increasing the number of shift speeds.

With the speed change device, first to seventh forward speeds and a reverse speed can be established by engaging the first to fifth engagement elements and the output-side engagement element as follows. That is, a first forward speed is established by engaging the second and third engagement elements (B2, C1). A second forward speed is established by engaging the first and third engagement elements (B1, C1). A third forward speed is established by engaging the third engagement element (C1) and the output-side engagement element (C5). A fourth forward speed is established by engaging the third and fourth engagement elements (C1, C2). A fifth forward speed is established by engaging the fourth engagement element (C2) and the output-side engagement element (C5). A sixth forward speed is established by engaging the first and fourth engagement elements (B1, C2). A seventh forward speed is established by engaging the fifth engagement element (C3) and the output-side engagement element (C5). A reverse speed is established by engaging the second and fifth engagement elements (B2, C3).

The composite planetary gear mechanism (25) may be a Ravigneaux type planetary gear mechanism that has a first sun gear (21s), a second sun gear (22s), a first pinion gear (21p) meshed with the first sun gear (21s), a second pinion gear (22p) meshed with the second sun gear (22s) and meshed with the first pinion gear (21p), a first carrier (21c) that rotatably and revolvably holds the first and second pinion gears (21p, 22p), and a first ring gear (21r) meshed with the second pinion gear (22p), the first rotary element may be the first sun gear (21s), the second rotary element may be the first carrier (21c), the third rotary element may be the first ring gear (21r), and the fourth rotary element may be the second sun gear (22s). Consequently, by adopting a Ravigneaux type planetary gear mechanism as the composite planetary gear mechanism, it is possible to improve the assemblability while suppressing an increase in the weight of the entire device by reducing the number of components.

The composite planetary gear mechanism (25) may be a Ravigneaux type planetary gear mechanism that has a first sun gear (21s), a second sun gear (22s), a first pinion gear (21p) meshed with the first sun gear (21s), a second pinion gear (22p) meshed with the second sun gear (22s) and meshed with the first pinion gear (21p), a first carrier (21c) that rotatably and revolvably holds the first and second pinion gears (21p, 22p), and a first ring gear (21r) meshed with the second pinion gear (22p); and the first rotary element may be the second sun gear (22s), the second rotary element may be the first ring gear (21r), the third rotary element may be the first carrier (21c), and the fourth rotary element may be the first sun gear (21s).

The composite planetary gear mechanism (25W) may include a single-pinion type first planetary gear (21) that has a first sun gear (21s), a first ring gear (21r), and a first carrier (21c) that rotatably and revolvably holds a plurality of first pinion gears (21p) meshed with the first sun gear (21s) and the first ring gear (21r), and a single-pinion type second planetary gear (22) that has a second sun gear (22s), a second ring gear (22r), and a second carrier (22c) that rotatably and revolvably holds a plurality of second pinion gears (22p) meshed with the second sun gear (22s) and the second ring gear (22r); and the first rotary element may be the first sun gear (21s), the second rotary element may be the second ring gear (22r), the third rotary element may be the first and second carriers (21c, 22c) which are always coupled to each other, and the fourth rotary element may be the first ring gear (21r) and the second sun gear (22s) which are always coupled to each other. Also by adopting such a composite planetary gear mechanism which is constituted by combining the single-pinion type first and second planetary gears with each other, it is possible to further improve the assemblability while suppressing an increase in the weight of the speed change device by reducing the number of components. With such a composite planetary gear mechanism, additionally, the second planetary gear can be disposed so as to surround the first planetary gear. Thus, it is possible to further shorten the axial length of the speed change device.

In this case, the first ring gear (21r) and the second sun gear (22s) may be integrated with each other; and the composite planetary gear mechanism (25W) may be disposed such that the first pinion gears (21p) and the second pinion gears (22p) at least partially overlap each other in an axial direction as seen in a radial direction.

The composite planetary gear mechanism (250) may include a single-pinion type first planetary gear (21) that has a first sun gear (21s), a first ring gear (21r), and a first carrier (21c) that rotatably and revolvably holds a plurality of first pinion gears (21p) meshed with the first sun gear (21s) and the first ring gear (21r), and a single-pinion type second planetary gear (22) that has a second sun gear (22s), a second ring gear (22r), and a second carrier (22c) that rotatably and revolvably holds a plurality of second pinion gears (22p) meshed with the second sun gear (22s) and the second ring gear (22r); and the first rotary element may be the second sun gear (22s), the second rotary element may be the first ring gear (21r) and the second carrier (22c) which are always coupled to each other, the third rotary element may be the first carrier (21c) and the second ring gear (22r) which are always coupled to each other, and the fourth rotary element may be the first sun gear (21s). Also by adopting the so-called CR-CR type composite planetary gear mechanism, which includes two single-pinion type planetary gears, as the composite planetary gear mechanism in this way, it is possible to further improve the power transfer efficiency of the speed change device by reducing a meshing loss between the rotary elements of the composite planetary gear mechanism, and to improve the assemblability while suppressing an increase in the weight of the entire device by reducing the number of components.

The composite planetary gear mechanism (250) may include a single-pinion type first planetary gear (21) that has a first sun gear (21s), a first ring gear (21r), and a first carrier (21c) that rotatably and revolvably holds a plurality of first pinion gears (21p) meshed with the first sun gear (21s) and the first ring gear (21r), and a single-pinion type second planetary gear (22) that has a second sun gear (22s), a second ring gear (22r), and a second carrier (22c) that rotatably and revolvably holds a plurality of second pinion gears (22p) meshed with the second sun gear (22s) and the second ring gear (22r); and the first rotary element may be the first sun gear (21s), the second rotary element may be the first carrier (21c) and the second ring gear (22r) which are always coupled to each other, the third rotary element may be the first ring gear (21r) and the second carrier (22c) which are always coupled to each other, and the fourth rotary element may be the second sun gear (21s).

The first drive gear (26) may be an externally toothed gear that is rotated together with the output element of the composite planetary gear mechanism (25), and the first driven gear (27) may be an externally toothed gear that is meshed with the first drive gear (26) and that is rotated together with the output member (20o); and the second drive gear (28) may be an externally toothed gear that is rotated together with the one of the rotary elements of the composite planetary gear mechanism (25), and the second driven gear (29) may be an externally toothed gear meshed with the second drive gear (28). Consequently, it is possible to couple the output element and one of the rotary elements of the composite planetary gear mechanism to the output member while suppressing an increase in the size of the speed change device.

One of the gear ratio of the first gear train and the gear ratio of the second gear train may be 1.00.

The output member may transfer power to a differential gear coupled to front wheels of a vehicle.

The composite planetary gear mechanism (25, 25W, 250) may include a first planetary gear (21) and a second planetary gear (22) that each have three rotary elements; and one of two rotary elements of the first planetary gear (21) may be always coupled to one of two rotary elements of the second planetary gear (22), and the other of the two rotary elements of the first planetary gear (21) may be always coupled to the other of the two rotary elements of the second planetary gear (22).

The at least five engagement elements (B1, B2, C1, C2, C3, C4) may include a plurality of clutches (C1, C2, C3, C4) that each connect and disconnect one of the rotary elements, not the output element, of the composite planetary gear mechanism (25, 25W, 250) and the different one of the rotary elements including the input member (20i) to and from each other; and the speed change device may establish a plurality of forward speeds and at least one reverse speed by selectively engaging the at least five engagement elements (B1, B2, C1, C2, C3, C4), and establish at least two forward speeds that are different from the plurality of forward speeds by engaging one of the plurality of clutches (C1, C2, C3, C4) and the output-side engagement element (C5).

The plurality of clutches (C1, C2, C3, C4) may each connect and disconnect the one of the rotary elements, not the output element, of the composite planetary gear mechanism (25, 25W, 250) and one of the input member (20i) and the different one of the rotary elements that is rotated at a rotational speed that is lower than that of the input member (20i) to and from each other.

The present disclosure is not limited to the embodiments described above in any way, and it is a matter of course that they may be modified in various ways without departing from the range of the extension of the present disclosure. Furthermore, the embodiments described above are merely specific forms described in the “SUMMARY” section, and does not limit the elements thereof.

### INDUSTRIAL APPLICABILITY

The present disclosure is applicable, for example, to the speed change device manufacturing industry etc.

1. A speed change device that includes an input member, an output member, a composite planetary gear mechanism that has at least four rotary elements including an output element, and at least five engagement elements that each connect and disconnect one of the rotary elements of the composite planetary gear mechanism and a different one of rotary elements including the input member or a stationary member to and from each other, the speed change device transferring power, which has been transferred to the input member, to the output member with a speed of the power changed, the speed change device comprising:
a first gear train that includes a first drive gear always coupled to the output element of the composite planetary gear mechanism and a first driven gear which is always coupled to the output member and to which power is transferred from the first drive gear;
a second gear train that includes a second drive gear always coupled to one of the rotary elements, not the output element, of the composite planetary gear mechanism and a second driven gear that is rotated in the same direction as the first driven gear by power from the second drive gear, the second gear train having a gear ratio that is different from that of the first gear train; and
an output-side engagement element that connects and disconnects the second driven gear and the output member to and from each other.

2. The speed change device according to claim 1, wherein:
the composite planetary gear mechanism has a first rotary element, a second rotary element, a third rotary element, and a fourth rotary element that are arranged sequentially in accordance with a gear ratio; and
the output element is the third rotary element, and the one of the rotary elements is the first, second, or fourth rotary element.

3. The speed change device according to claim 2, wherein
the five engagement elements include:
a first engagement element that connects the first rotary element to the stationary member to make the first rotary element stationary so as to be non-rotatable, and that disconnects the first rotary element and the stationary member from each other;
a second engagement element that connects the second rotary element to the stationary member to make the second rotary element stationary so as to be non-rotatable, and that disconnects the second rotary element and the stationary member from each other;
a third engagement element that allows and cancels transfer of power from an input member side to the fourth rotary element;
a fourth engagement element that allows and cancels transfer of power from the input member side to the second rotary element; and
a fifth engagement element that allows and cancels transfer of power from the input member side to the first rotary element.

4. The speed change device according to claim 3, further comprising:
a planetary gear that has a fifth rotary element, a sixth rotary element, and a seventh rotary element arranged sequentially in accordance with a gear ratio; and
a sixth engagement element, wherein:
one of the fifth and seventh rotary elements is always connected to the stationary member, and the other is always coupled to the input member;
the third engagement element connects and disconnects the fourth rotary element and the sixth rotary element to and from each other;
the fourth engagement element connects and disconnects the second rotary element and the input member to and from each other;
the fifth engagement element connects and disconnects the first rotary element and the sixth rotary element to and from each other; and
the sixth engagement element connects and disconnects the first rotary element and the input member to and from each other.

5. The speed change device according to claim 4, wherein:
a first forward speed is established by engaging the second and third engagement elements;
a second forward speed is established by engaging the first and third engagement elements;
a third forward speed is established by engaging the third engagement element and the output-side engagement element;
a fourth forward speed is established by engaging the third and fifth engagement elements;
a fifth forward speed is established by engaging the third and sixth engagement elements;
a sixth forward speed is established by engaging the third and fourth engagement elements;
a seventh forward speed is established by engaging the fifth engagement element and the output-side engagement element;
an eighth forward speed is established by engaging the fourth and sixth engagement elements;
a ninth forward speed is established by engaging the fourth engagement element and the output-side engagement element;
a tenth forward speed is established by engaging the fourth and fifth engagement elements;
an eleventh forward speed is established by engaging the first and fourth engagement elements;
a twelfth forward speed is established by engaging the sixth engagement element and the output-side engagement element; and
a reverse speed is established by engaging the second and fifth engagement elements.

6. The speed change device according to claim 4, wherein:
a first forward speed is established by engaging the second and third engagement elements;
a second forward speed is established by engaging the first and third engagement elements;
a third forward speed is established by engaging the third engagement element and the output-side engagement element;
a fourth forward speed is established by engaging the third and fifth engagement elements;
a fifth forward speed is established by engaging the third and sixth engagement elements;
a sixth forward speed is established by engaging the third and fourth engagement elements;
a seventh forward speed is established by engaging the fourth and sixth engagement elements;
an eighth forward speed is established by engaging the fourth engagement element and the output-side engagement element;
a ninth forward speed is established by engaging the fourth and fifth engagement elements;
a tenth forward speed is established by engaging the first and fourth engagement elements;
an eleventh forward speed is established by engaging the sixth engagement element and the output-side engagement element;
a first reverse speed is established by engaging the second and fifth engagement elements; and
a second reverse speed is established by engaging the second and sixth engagement elements.

7. The speed change device according to claim 4, wherein:
a first forward speed is established by engaging the second and third engagement elements;
a second forward speed is established by engaging the first and third engagement elements;
a third forward speed is established by engaging the third and fifth engagement elements;
a fourth forward speed is established by engaging the third and sixth engagement elements;
a fifth forward speed is established by engaging the third and fourth engagement elements;
a sixth forward speed is established by engaging the fourth and sixth engagement elements;
a seventh forward speed is established by engaging the fourth engagement element and the output-side engagement element;
an eighth forward speed is established by engaging the fourth and fifth engagement elements;
a ninth forward speed is established by engaging the first and fourth engagement elements;
a tenth forward speed is established by engaging the sixth engagement element and the output-side engagement element; and
a reverse speed is established by engaging the second and fifth engagement elements.

8. The speed change device according to claim 4, wherein:
a first forward speed is established by engaging the second and third engagement elements;
a second forward speed is established by engaging the first and third engagement elements;
a third forward speed is established by engaging the third and fifth engagement elements;
a fourth forward speed is established by engaging the third and sixth engagement elements;
a fifth forward speed is established by engaging the third and fourth engagement elements;
a sixth forward speed is established by engaging the fourth and sixth engagement elements;
a seventh forward speed is established by engaging the fourth engagement element and the fifth engagement element;
an eighth forward speed is established by engaging the first and fourth engagement elements;
a ninth forward speed is established by engaging the sixth engagement element and the output-side engagement element; and
a reverse speed is established by engaging the second and fifth engagement elements.

9. The speed change device according to claim 4, wherein
the planetary gear is a double-pinion type planetary gear that has a third sun gear, a third ring gear, and a third carrier that rotatably and revolvably holds a plurality of sets of two pinion gears meshed with each other, one of the pinion gears being meshed with the third sun gear and the other being meshed with the third ring gear, the fifth rotary element is the third sun gear, the sixth rotary element is the third ring gear, and the seventh rotary element is the third carrier.

10. The speed change device according to claim 3, further comprising:
a planetary gear that has a fifth rotary element, a sixth rotary element, and a seventh rotary element arranged sequentially in accordance with a gear ratio, wherein:
one of the fifth and seventh rotary elements is always connected to the stationary member, and the other is always coupled to the input member;
the third engagement element connects and disconnects the fourth rotary element and the sixth rotary element to and from each other;
the fourth engagement element connects and disconnects the second rotary element and the input member to and from each other; and
the fifth engagement element connects and disconnects the first rotary element and the sixth rotary element to and from each other.

11. The speed change device according to claim 10, wherein:
a first forward speed is established by engaging the second and third engagement elements;
a second forward speed is established by engaging the first and third engagement elements;
a third forward speed is established by engaging the third engagement element and the output-side engagement element;
a fourth forward speed is established by engaging the third engagement element and the fifth engagement element;
a fifth forward speed is established by engaging the fifth engagement element and the output-side engagement element;
a sixth forward speed is established by engaging the third and fourth engagement elements;
a seventh forward speed is established by engaging the fourth engagement element and the output-side engagement element;
an eighth forward speed is established by engaging the fourth and fifth engagement elements;
a ninth forward speed is established by engaging the first and fourth engagement elements; and
a reverse speed is established by engaging the second and fifth engagement elements.

12. The speed change device according to claim 10, wherein:
a first forward speed is established by engaging the second and third engagement elements;
a second forward speed is established by engaging the first and third engagement elements;
a third forward speed is established by engaging the third engagement element and the output-side engagement element;
a fourth forward speed is established by engaging the third and fifth engagement elements;
a fifth forward speed is established by engaging the third and fourth engagement elements;
a sixth forward speed is established by engaging the fourth and fifth engagement elements;
a seventh forward speed is established by engaging the fourth engagement element and the output-side engagement element;
an eighth forward speed is established by engaging the first and fourth engagement elements;
a ninth forward speed is established by engaging the fifth engagement element and the output-side engagement element; and
a reverse speed is established by engaging the second and fifth engagement elements.

13. The speed change device according to claim 3, further comprising:
a planetary gear that has a fifth rotary element, a sixth rotary element, and a seventh rotary element arranged sequentially in accordance with a gear ratio, wherein:
the fifth rotary element is always coupled to the input member;
the third engagement element connects and disconnects the fourth rotary element and the input member to and from each other;
the fourth engagement element connects and disconnects the second rotary element and the input member to and from each other; and
the fifth engagement element connects the seventh rotary element to the stationary member to make the seventh rotary element stationary so as to be non-rotatable, and disconnects the seventh rotary element and the stationary member from each other.

14. The speed change device according to claim 13, wherein:
a first forward speed is established by engaging the second and third engagement elements;
a second forward speed is established by engaging the first and third engagement elements;
a third forward speed is established by engaging the fifth engagement element and the output-side engagement element;
a fourth forward speed is established by engaging the third and fifth engagement elements;
a fifth forward speed is established by engaging the third engagement element and the output-side engagement element;
a sixth forward speed is established by engaging the third and fourth engagement elements;
a seventh forward speed is established by engaging the fourth engagement element and the output-side engagement element;
an eighth forward speed is established by engaging the fourth and fifth engagement elements;
a ninth forward speed is established by engaging the first and fourth engagement elements; and
a reverse speed is established by engaging the second and fifth engagement elements.

15. The speed change device according to claim 10, wherein
the planetary gear is a single-pinion type planetary gear that has a third sun gear, a third ring gear, and a third carrier that rotatably and revolvably holds a plurality of third pinion gears meshed with the third sun gear and the third ring gear, the fifth rotary element is the third sun gear which is always connected to the stationary member, the sixth rotary element is the third carrier, and the seventh rotary element is the third ring gear.

16. The speed change device according to claim 10, wherein
the planetary gear is a double-pinion type planetary gear that has a third sun gear, a third ring gear, and a third carrier that rotatably and revolvably holds a plurality of sets of two pinion gears meshed with each other, one of the pinion gears being meshed with the third sun gear and the other being meshed with the third ring gear, the fifth rotary element is the third sun gear, the sixth rotary element is the third ring gear, and the seventh rotary element is the third carrier which is always connected to the stationary member.

17. The speed change device according to claim 3, wherein:
the third engagement element connects and disconnects the fourth rotary element and the input member to and from each other;
the fourth engagement element connects and disconnects the second rotary element and the input member to and from each other; and
the fifth engagement element connects and disconnects the first rotary element and the input member to and from each other.

18. The speed change device according to claim 17, wherein:
a first forward speed is established by engaging the second and third engagement elements;
a second forward speed is established by engaging the first and third engagement elements;
a third forward speed is established by engaging the third engagement element and the output-side engagement element;
a fourth forward speed is established by engaging the third and fourth engagement elements;
a fifth forward speed is established by engaging the fourth engagement element and the output-side engagement element;
a sixth forward speed is established by engaging the first and fourth engagement elements;
a seventh forward speed is established by engaging the fifth engagement element and the output-side engagement element; and
a reverse speed is established by engaging the second and fifth engagement elements.

19. The speed change device according to claim 4, wherein
the composite planetary gear mechanism is a Ravigneaux type planetary gear mechanism that has a first sun gear, a second sun gear, a first pinion gear meshed with the first sun gear, a second pinion gear meshed with the second sun gear and meshed with the first pinion gear, a first carrier that rotatably and revolvably holds the first and second pinion gears, and a first ring gear meshed with the second pinion gear, the first rotary element is the first sun gear, the second rotary element is the first carrier, the third rotary element is the first ring gear, and the fourth rotary element is the second sun gear.

20. The speed change device according to claim 13, wherein:
the composite planetary gear mechanism is a Ravigneaux type planetary gear mechanism that has a first sun gear, a second sun gear, a first pinion gear meshed with the first sun gear, a second pinion gear meshed with the second sun gear and meshed with the first pinion gear, a first carrier that rotatably and revolvably holds the first and second pinion gears, and a first ring gear meshed with the second pinion gear; and
the first rotary element is the second sun gear, the second rotary element is the first ring gear, the third rotary element is the first carrier, and the fourth rotary element is the first sun gear.

21. The speed change device according to claim 4, wherein:
the composite planetary gear mechanism includes a single-pinion type first planetary gear that has a first sun gear, a first ring gear, and a first carrier that rotatably and revolvably holds a plurality of first pinion gears meshed with the first sun gear and the first ring gear, and a single-pinion type second planetary gear that has a second sun gear, a second ring gear, and a second carrier that rotatably and revolvably holds a plurality of second pinion gears meshed with the second sun gear and the second ring gear; and
the first rotary element is the first sun gear, the second rotary element is the second ring gear, the third rotary element is the first and second carriers which are always coupled to each other, and the fourth rotary element is the first ring gear and the second sun gear which are always coupled to each other.

22. The speed change device according to claim 21, wherein:
the first ring gear and the second sun gear are integrated with each other; and
the composite planetary gear mechanism is disposed such that the first pinion gears and the second pinion gears at least partially overlap each other in an axial direction as seen in a radial direction.

23. The speed change device according to claim 10, wherein:
the composite planetary gear mechanism includes a single-pinion type first planetary gear that has a first sun gear, a first ring gear, and a first carrier that rotatably and revolvably holds a plurality of first pinion gears meshed with the first sun gear and the first ring gear, and a single-pinion type second planetary gear that has a second sun gear, a second ring gear, and a second carrier that rotatably and revolvably holds a plurality of second pinion gears meshed with the second sun gear and the second ring gear; and
the first rotary element is the second sun gear, the second rotary element is the first ring gear and the second carrier which are always coupled to each other, the third rotary element is the first carrier and the second ring gear which are always coupled to each other, and the fourth rotary element is the first sun gear.

24. The speed change device according to claim 13, wherein:
the composite planetary gear mechanism includes a single-pinion type first planetary gear that has a first sun gear, a first ring gear, and a first carrier that rotatably and revolvably holds a plurality of first pinion gears meshed with the first sun gear and the first ring gear, and a single-pinion type second planetary gear that has a second sun gear, a second ring gear, and a second carrier that rotatably and revolvably holds a plurality of second pinion gears meshed with the second sun gear and the second ring gear; and
the first rotary element is the first sun gear, the second rotary element is the first carrier and the second ring gear which are always coupled to each other, the third rotary element is the first ring gear and the second carrier which are always coupled to each other, and the fourth rotary element is the second sun gear.

25. The speed change device according to claim 1, wherein:
the first drive gear is an externally toothed gear that is rotated together with the output element of the composite planetary gear mechanism, and the first driven gear is an externally toothed gear that is meshed with the first drive gear and that is rotated together with the output member; and
the second drive gear is an externally toothed gear that is rotated together with the one of the rotary elements of the composite planetary gear mechanism, and the second driven gear is an externally toothed gear meshed with the second drive gear.

26. The speed change device according to claim 25, wherein
one of the gear ratio of the first gear train and the gear ratio of the second gear train is 1.00.

27. The speed change device according to claim 1, wherein
the output member transfers power to a differential gear coupled to front wheels of a vehicle.

28. The speed change device according to claim 1, wherein:
the composite planetary gear mechanism includes a first planetary gear and a second planetary gear that each have three rotary elements; and
one of two rotary elements of the first planetary gear is always coupled to one of two rotary elements of the second planetary gear, and the other of the two rotary elements of the first planetary gear is always coupled to the other of the two rotary elements of the second planetary gear.

29. The speed change device according to claim 1, wherein:
the at least five engagement elements include a plurality of clutches that each connect and disconnect one of the rotary elements, not the output element, of the composite planetary gear mechanism and the different one of the rotary elements including the input member to and from each other; and
a plurality of forward speeds and at least one reverse speed are established by selectively engaging the at least five engagement elements, and at least two forward speeds that are different from the plurality of forward speeds are established by engaging one of the plurality of clutches and the output-side engagement element.

30. The speed change device according to claim 29, wherein
the plurality of clutches each connect and disconnect the one of the rotary elements, not the output element, of the composite planetary gear mechanism and one of the input member and the different one of the rotary elements that is rotated at a rotational speed that is lower than that of the input member to and from each other.
